(19) United States
(12) Patent Application Publication
(10) Pub. No.: US 2026/0277885 A1
(43) Pub. Date: Sep. 17, 2026

(54) ADVANCED DATA MODELING TO AUTOMATICALLY CREATE METRICS AND PRESERVE SENSITIVE DATA

(71) Applicant: MicroStrategy Incorporated, Vienna, VA (US)

(72) Inventors: Jose Nocedal, Leesburg, VA (US); Zhili Cheng, Dunn Loring, VA (US); Mohamed Diakite Pineda, Oakton, VA (US); Jun Zhu, Potomac, MD (US); Ruiqing Xu, HANGZHOU (CN); Saurabh Abhyankar, McLean, VA (US)

(21) Appl. No.: 19/666,711

(22) Filed: May 4, 2026

Related U.S. Application Data
(63) Continuation-in-part of application No. 19/662,776, filed on Apr. 29, 2026.
(63) Continuation-in-part of application No. 19/193,394, filed on Apr. 29, 2025, now Pat. No. 12,675,497.
(60) Provisional application No. 63/640,149, filed on Apr. 29, 2024.
(60) Provisional application No. 63/797,042, filed on Apr. 29, 2025.
(60) Provisional application No. 63/800,373, filed on May 5, 2025.

(51) Int. Cl. G06F 16/242; G06F 3/04842; G06F 16/23; G06F 16/2455

(52) U.S. Cl. CPC G06F 16/243; G06F 16/23; G06F 16/2455; G06F 3/04842

(57) ABSTRACT

Methods, systems, and apparatus, including computer-readable media, for advanced data modeling. In some implementations, the system accesses a data model for one or more data sets or data sources used in a session of user interaction with a graphical user interface. The system generates a request for one or more artificial intelligence and/or machine learning (AI/ML) models to identify one or more additional data objects that are not specified in the data model. The system obtains output that the one or more AI/ML models generated in response to the request, and based on the output the system provides user interface data to display data identifying a particular additional data object a control that is selectable by the user to initiate creation of the particular additional data object.

### CROSS-REFERENCE TO RELATED APPLICATIONS

This application claims the benefit of priority to U.S. Provisional Patent Application No. 63/800,373, filed on May 5, 2025; this application is a continuation-in-part of U.S. patent application Ser. No. 19/662,776, filed on Apr. 29, 2026, which claims priority to U.S. Provisional Patent Application No. 63/797,042, filed on Apr. 29, 2025; and this application is a continuation-in-part of U.S. patent application Ser. No. 19/193,394, filed on Apr. 29, 2025, which claims priority to U.S. Provisional Patent Application No. 63/640,149, filed on Apr. 29, 2024; and the entire contents of each of the previous applications is incorporated by reference herein.

### BACKGROUND

The present specification relates to data modeling using artificial intelligence and machine learning.

Databases and other data processing systems often use a data model or data schema to interpret the content of data sets and the connections among data sets. In many cases, creating a data model or data schema is a time-consuming process that requires administrators to perform many manual steps.

### SUMMARY

In some implementations, a computer system provides functionality for automated and semi-automated data modeling, powered by artificial intelligence or machine learning (AI/ML) models, such as large language models (LLMs). When a user creates or edits a data model or data schema, the computer system can analyze data set(s) and their metadata to automatically generate recommended actions for, for example, data cleansing, modeling, and data enrichment. The computer system can then indicate the recommended actions as recommendations that the user can apply, edit and then apply, or dismiss. In some cases, when the computer system determines that an action has a high level of confidence of being appropriate for the data set(s) (e.g., a confidence score above a threshold), the computer system can apply the action automatically.

The computer system can be configured to assist a user to generate metrics that are added to a data model, which can then be referenced and used by chatbots, software applications, database systems, and more. A metric can be a measure, e.g., a logical data object representing a quantifiable item that can be assessed across various attributes or dimensions. The computer system can automatically create a metric by generating a formula or definition that explains how the value of the metric will be calculated. The metric can be defined in terms of one or more functions that are recognized by a database system, with reference to types of values (e.g., columns of data, or other data objects such as attributes or metrics) from data sets associated with the data model as the source of data for calculating values of the metric. The computer system can use one or more AI/ML models to infer the meaning of a metric to be created, based on a user prompt and the context of the data sets the user is working with. In some implementations, the context of the data sets is expressed in a data model that is being created or edited, and that information is used by the AI/ML model in generating another metric.

Once the computer system creates a metric, the computer system can provide the user information about the metric, such as the formula, an explanation or description of the item the metric represents, and a more detailed explanation or description of the component data objects and function(s) that make up the metric. Each of these elements can be generated using one or more AI/ML models. The information can be provided to the user for presentation on a user interface that allows the user to make changes, such as to edit the formula for the metric. The computer system can then save the metric in the data model where it can be accessed. In some implementations, the metric can be added to the data model automatically. In other implementations, the metric is added after a user reviews and approves or confirms that the new metric should be saved.

In the process of generating metrics, the computer system can use result-assisted generation (RAG) to find and retrieve information that improves the accuracy and relevance of the metrics that are created. For example, the computer system can store function templates for each of the various functions that can be applied by a database system (e.g., an average function, a sum function, a maximum function, a minimum function, etc.). These function templates can be stored in association with vector embeddings based on the name, description, keywords, or other content representing the function. In addition, or as an alternative, the computer system can store metric examples (e.g., example metric definitions) for various metrics across a wide range of data sets, including data sets beyond those of the current user or the current organization. The metric examples can include information about metrics that have been approved and used for other data sets and other data models, and so can reasonably be expected to be useful and correct. The metric examples can also be stored in association with vector embeddings determined from the name, description, keywords, or other content of the metric example.

Then, as part of the process for creating a new metric, the computer system can generate a query vector embedding from a prompt or request and search for items having stored vector embeddings that are closest to the query vector embedding. For example, the computer system can perform nearest neighbor search or semantic search to assess the proximity of stored director embeddings to the query vector embedding in a high dimensional vector space. The items that have stored vector embeddings closest to the query vector embedding can be selected as relevant for generating the new metric. As an example, the function template with a corresponding vector embedding closest to the query vector embedding can be selected as the function to use generating the metric formula, and the function template can be provided to the LLM to assist the LLM to generate a formula for the new metric. In addition, one or more of the metric examples having vector embeddings closest to the query vector embedding can be selected and provided to the LLM as examples to assist the LLM in generating the formula for the new metric. This information, together with the data model describing the data objects actually available and the names or identifiers for the data objects, can greatly increase the accuracy of the LLM in generating formulas that are syntactically valid and use references to data objects that can correctly resolve to specific columns or data objects.

The computer system can also enhance the process of creating new metrics by generating and providing suggested metric types. The computer system can provide these metric suggestions in the form of proposed names for potential new metrics, e.g., descriptive names that with a phrase or a few words express in natural language the type of information to be provided (e.g., “sales by quarter,” “cost per employee,” “units sold,” etc.). The computer system uses an AI/ML model and the current data context to generate the suggested metrics. The computer system can guide the AI/ML model to propose metrics that are relevant to the current data context and for which the source data to generate the metric would be available. For example, the computer system can send a request to the LLM to generate a list of names of proposed metrics that would be relevant for a group of data sets and would each be able to be derived from the values in the data sets. The request can be provided with a data model for the data sets (including potentially content of the current data model being created or edited) and/or with information describing the structure or metadata of the data sets (e.g., table names and descriptions, column names and descriptions, data types for columns, etc.). In response, the LLM can provide a list of proposed metrics that are inferred to be most related to or most likely for the data set(s) currently open or being operated on by the user.

The processing of the LLM to generate proposed metrics to suggest to the user can be enhanced using RAG. For example, the computer system can use information about the current data context (e.g., the data model, or table and column names and descriptions) to generate a variety of query vector embeddings. The computer system can then perform a semantic search using the vector database to retrieve metric examples that are relevant to the various attributes, metrics, columns, tables, and other items of the current data context. This search can produce results of various different types, which the computer system can provide to the LLM with the request to generate new proposed metric names. For example, with the data model or other data object information together with the metric examples, the LLM can identify which of the metric examples involve types of data present in the current data sets and so would be good candidates to create. Similarly, the LLM can use patterns from the examples to fit the examples to the data that is present. For example, there may be a retrieved example of “average revenue,” where the current data set has no revenue metric but does have a sales metric, and so the LLM can suggest “average sales” as an appropriate metric for the current data set.

In some implementations, to enhance the retrieval and process of generating suggestions, the vector database can store metric examples with information that describes the data contexts of the metric examples. For example, a metric “average revenue” can be stored with information about the table (e.g., named “store performance”) or other associated tables, and other columns present (e.g., “year,” “country,” “customer,” “product,” etc.). As a result, the search process can generate vector embeddings of the current data context and compare to vector embeddings based at least in part on the respective data contexts where the metric examples occurred. As a result, the semantic search retrieval process can leverage the similarities of the current data context to the other data contexts to find metric examples from similar data contexts. If some metrics are more likely to occur with customer data, or with store location data, or with another type of data, this type of search that accounts for the similarities of the data context can help ensure that retrieved examples are relevant.

In some implementations, the computer system generates different sets of suggested metrics for each of multiple different tasks or portions of the data set(s) in the data context. This can provide different sets of metrics for different topics or purposes. For example, the computer system may use the LLM to generate a first set of suggested metrics for a first table of data, a second set of suggested metrics for a second table of data, and so on. As another example, the computer system may use the LLM to generate different sets of suggested metrics for different topics or types of analysis. Given a data set with sales data and information about many different attributes and metrics, the LLM may provide a different set of suggested metrics for different topics such as customer sales trends, customer demographics, order performance, location trends, inventory trends, marketing performance, etc. In some implementations, the computer system may instruct the LLM to (1) generate the topics (e.g., types or categories of analysis), by inferring which topics are most likely or most relevant from the data model or other information about the data set(s), then (2) generate a set of suggested metrics for each topic generated. In other implementations, the computer system may provide the topics or retrieve a set of topics (e.g., from a vector database, based on similarity of data context) and instruct the LLM to generate a set of suggested metrics for each topic provided.

In some implementations, the computer system uses the AI/ML models to generate the suggested metrics without the user having to specifically request them. For example, if a user clicks a user interface option to be shown a metric creation page or area, the computer system can automatically generate and provide as a set of suggested metrics for presentation. Each of the selected metrics can be provided as an interactive user interface element that, if a user interacts with it (e.g., clicking, tapping, etc.) triggers the system to use an AI/ML model to generate the corresponding metric formula, along with a description, explanation, and other content. To use processing power efficiently, the suggested metrics can be generated as simply metric names or short descriptions, without incurring the processing needed to generate the full metric definition (e.g., search for the proper functions, generation of the metric formula, etc.), until the user clicks the user interface element and initiates a request for that particular metric to be generated. In addition, the computer system can be configured with a stored system prompt or system instruction that is configured to be used for the metric creation interface, so that the user does not need to provide a detailed prompt to request a metric. For example, the system prompt can include the instruction to generate a metric formula, with a corresponding explanation and description, based on the user prompt, which may be no more than the text of a suggested metric name or title, such as “total profit” or “average cost.” The system prompt, together with the user prompt (e.g., the selected metric name the user selects), are then provided to the LLM with (1) the data model for the data set(s) of the current data context and (2) function templates and/or metric examples retrieved from the vector database based on the user prompt. The LLM then generates the metric formula and the corresponding descriptive and explanatory content.

The computer system can use the AI/ML models to detect various different scenarios. For example, the computer system can instruct an LLM to determine likely types of analysis needed given the data model or other data set information. If the metrics that are present are items describing products, customers, and revenue, the LLM can detect that types of analysis such as overall performance analytics or customer demographics are relevant to the current data context. The computer system instructs the LLM to suggest metrics for each of these types of analysis, and the request can be made as a separate interaction or the same interaction requesting the analysis types. Often the types of metrics needed are common or standard in an industry. The LLM may have information about these from its training, e.g., with the information incorporated into the training state of the LLM. In some implementations, reference material indicating the most common metrics for different scenarios or types of analysis can be provided to the LLM for reference. At each step of processing, the LLM has access to the data model or data set characteristics which allows the set of suggested metrics to be customized for the user's industry, location, or other parameters. This customization can often be performed automatically based on the content of the data set(s) in the data context, e.g., by the sets of attributes and metrics present.

When the LLM generates suggested queries, the LLM already has the data context (e.g., data model or other data set description). The instructions or system prompt can also instruct the LLM to limit the suggestions to those that use the particular data objects that are known to be available. Consequently, the suggestions are for metrics that can be actually created with actual data available in the relevant data sets. The instructions can similarly request for the functions applied to the data to be selected from a set of functions that are defined and known to be available in the target data processing system.

In some implementations, the computer system can be configured to incorporate information about the privacy or sensitivity of different data objects into a data model. The data object can be, for example, a column of data, an attribute, a metric calculated using a column or attribute, etc. Based on analysis of information about a data object, such as the name and description, the computer system can use an AI/ML model to classify an object as one of multiple categories of sensitivity, e.g., high, medium, or low. Once the sensitivity level is detected, the computer system can save the sensitivity setting for that data object in a data model, or provide a recommendation for the user to assign the sensitivity status. The computer system can also apply a masking format to apply for the data object, such as to replace particular characters with a replacement character (e.g., replace all but the last four digits with asterisks, to replace all characters with the number sign, etc.). Then, when the data object is accessed in the future by a software application or by a chatbot system, the data processing system can use the information in the data model to detect that a sensitive value is involved, and the data processing system provides the masked version of the data to avoid providing the sensitive data. In at least some cases, including for chatbot processing, this can be applied even when the user has the appropriate permissions or access control level to be able to view the data, to avoid sensitive data being improperly shared or viewed.

For example, when data is imported or a data model is created, the computer system can be configured to detect the level of sensitivity of each data object (e.g., each column of data or other data object). The computer system can use a variety of semantic information for a data object, such as, the name, description, data type, data format, and other available information, to make a classification. In some implementation, the computer system takes this information and provides it to an AI/ML model, such as an LLM, and instructs the LLM to classify the data object as one of multiple sensitivity classes. In some implementations, there are three or more classes, e.g., high, medium, and low sensitivity. As another example, the computer system can use the information about a data object to look up information in a vector database that stores examples of data objects with known sensitivity levels. The computer system can look up examples that are relevant or similar to a given data object (e.g., are close in the vector space), and then determine the sensitivity classification applied to the retrieved examples. In some implementations, the computer system provides the retrieved examples from the vector database to the AI/ML model to aid in the AI/ML model assigning the sensitivity classification. In some implementations, the computer system uses other processing such as examining the formatting of the data, the type of data (e.g., whether the data meets the format for a phone number (e.g., 10 digits, in groups of 3, 3, and 4), a social security number (e.g., 9 digits with dashes between, in groups of 3, 2, and 4), or other known data formats. In some implementations, the computer system provides the data format information to the AI/ML model to assist it in determining the sensitivity classification.

Once a sensitivity classification is determined, for example, when a data object is detected to contain sensitive data, the computer system applies a setting (e.g., a flag or other value) that marks the data object as sensitive. The setting can indicate one of the various different sensitivity levels (e.g., high, medium, or low sensitivity). The sensitivity setting in the data model can apply at the level of the data model and associated data sets, for all users and groups. This can be different from other techniques, such as user permissions and access control lists, that apply to specific users or user groups. The sensitivity setting in the data model, by contrast is not user dependent and can apply to all users, and so flows through to all chatbots or applications that uses the data model.

The presence of a sensitivity setting in a data model affects how the database backend processes requests and returns results. For example, when a request or query is sent, and the database backend determines that the data object is marked as sensitive in the data model, the database provides a masked pattern instead of the actual value. The particular masked pattern to use for each data object marked sensitive can also be specified in the data model. For example, if a request to a database from a chatbot system asked for a set of credit card numbers, the database system would detect that the data model marks the credit card number data object as a high-sensitivity data object. This triggers the database system to apply the masking pattern defined in the data model for this data object, which can be to replace all digits except the last four digits with an asterisk. In response to the query, the database system returns only the masked credit card numbers, which keeps the chatbot system and ultimately any chatbot responses from having the full values of the sensitive data object. Due to the flag in the data model, sensitive values are not provided to the AI/ML model, they are not shared outside of the database system in this case. Even if the user interacting with the chatbot has permissions to access the full credit card data, and access is not blocked by permissions or access control lists, the sensitivity setting nevertheless blocks the use of the values of the data object marked sensitive, at least by default.

In general, the computer system can use the AI/ML models to identify, assess, and/or implement changes to data sets and/or their corresponding data models or data schemas. At each stage, the computer system can analyze the output of the AI/ML models to apply additional policies or supplement the output. For example, the recommendations for cleaning or enriching a data set or for modeling a data set can be based on a combination of (i) items generated by AI/ML models as well as (ii) rule, policies, criteria, user preferences, statistical processing, or other processing by the computer system. The computer system can edit or alter items proposed by the AI/ML models to make them more appropriate for a particular data set or data model. As another example, the computer system can filter or select from among the items proposed by the AI/ML models to ensure that changes to data sets or data models meet standards for relevance or appropriateness before being recommended or applied.

The system can provide information about a data set to an AI/ML model and request that the AI/ML model identify types of changes that are most appropriate for the data set. In this process, the system can provide the AI/ML model metadata for the dataset, data labels (e.g., column names, descriptions, identifiers, etc.), sample data or synthetic data of a similar type, an existing data model or data schema, or other information about the data set. The system can also provide the AI/ML model information about a set of operations or types of operations (e.g., transformations, edits, functions, etc.) to consider. The system can also provide the AI/ML model information about previous data models or data sets, including historical information about other data sets and corresponding changes that were made (e.g., data processing or data modeling recommendations that were accepted and the data contexts in which they were accepted). With information about the types of previous changes that were accepted or applied by users, and the contexts in which they were applied, the AI/ML models can more accurately select changes that are appropriate and are likely to be accepted by users. In some ways, the information about accepted recommendations or changes provides a form of learning over time for the system as a whole, so that even an AI/ML model that is not retrained based on the data can still have the accuracy of its selections improve over time as more history data is gathered.

The computer system can use AI/ML models to assess whether any of various types of actions are appropriate for one or more data sets or their data models. The system can instruct the AI/ML models to generate scores or rankings of proposed changes (whether identified by the AI/ML models, the computer system, or a combination of both) to indicate the relevance or appropriateness for the particular data set(s) of interest to the user. For example, the computer system can instruct the AI/ML models to generate confidence scores for each change, or to group proposed changes into categories that specify the priority or likelihood that the changes should be applied. The computer system may additionally or alternatively generate its own scores or measures of the relevance, confidence, or appropriateness of different changes. The computer system can then use scores that it determined and/or the AI/ML model determined to select a subset to recommend to a user.

The computer system can use AI/ML models to implement changes to data sets or data models or data schemas. For example, for each change to a data set or data model that the computer system selects (e.g., from among changes proposed by an AI/ML model for one or more data sets) to be recommended or applied, the computer system can instruct the AI/ML model to generate interpretable or executable code to perform the change. For example, when a data enrichment action is identified, the computer system can instruct the AI/ML model to generate Python code to perform the data enrichment action. The computer system stores the code that the AI/ML model generates so the data enrichment action can be applied when the user approves. In addition, the code can be viewed or edited by the user, if desired. To assist the AI/ML model in generating accurate and effective code that carries out the desired action, the computer system 110 can provide a set of information that specifies the names or identifiers of data objects (e.g., columns, tables, etc.) and the semantic meanings for and relationships among those data objects. In addition, the computer system 110 can provide the AI/ML model information about rules, policies, or standards to be applied, as well as the functional characteristics (e.g., syntax, functions available, operations supported, etc.) of the data processing system that will run the code. As a result, the computer system 110 can guide AI/ML models to generate highly accurate codes segments to implement the various changes for data modeling or data adjustment.

After a user has approved or applied recommended actions, the computer system can store the list of indicated changes to be applied at a future time, such as when publishing the data model or providing access to another system. This improves efficiency by limiting the number of times that data set and data model need to be altered. For example, the computer system accumulates changes to a data set as the user accepts some recommendations and rejects others. If the user desires to add additional changes, or remove previously accepted changes, this can be done by simply adjusting the list of tasks or changes, with minimal delay. The actual changes to the data set (e.g., filling in empty fields, removing whitespace, etc.) can be performed together as a group, by performing the operations of the code segments corresponding to those changes in the process of publishing or providing access to the data model or data sets.

The computer system can be configured to recommend and carry out many different types of actions for data modeling. These include, for example, defining data objects (e.g., attributes, attribute forms, metrics, facts) from data sets (e.g., tables, columns, etc.), setting relationships among data objects, grouping or merging data objects, creating multi-form attributes (e.g., detecting that are multiple columns that can be associated together as an attribute form), validating relationships among data objects, creating new relationships among data objects, generating names or labels or other metadata for data objects, and so on.

The computer system can also be configured to perform data adjustment actions, such as data enrichment, data wrangling, data cleansing, data transformation, etc. To assist in identifying these actions, the computer system can determine characteristics of data sets and their data objects, including by performing statistical analysis of values in the data set and comparing with reference data (e.g., previous data sets analyzed, data representative of various known types of data, etc.). The computer system can then provide the data characteristics, along with descriptions and other metadata, to the AI/ML models so that the AI/ML models can more accurately determine data adjustment actions that are appropriate.

For example, data enrichment actions can include supplementing a data set (e.g., filling in missing data), verifying or validating data, or merging or associating data from different sources into an integrated data set. In some cases, data enrichment includes combining a customer's own data (e.g., from internal or customer-provided sources) with additional data from other sources, including potentially external or third-party data sources. In some implementations, the system is configured to expand or enhance attributes for a dimension (e.g., time, geography, category, product, etc.).

For example, if a data set has a column in a table that stores time values (e.g., timestamps), the computer system can be configured to generate a time hierarchy with multiple different attribute data objects that represent the time dimension at different levels of granularity or specificity. For example, from the timestamps, the computer system can automatically create and populate additional new attributes that were not present in the original data set for other measures of time, such as day, month, quarter, year, etc. Creating this time hierarchy in the data model allows users and data processing systems to more easily search, filter, aggregate, and otherwise process data according to any of these additional measures of time, and often do so with greater computational efficiency than without these attributes.

As another example, the computer system can automatically create or expand the attribute hierarchy for geographical dimensions. For example, if a data set includes a column that specifies a city, the computer system can automatically create and populate additional attributes for county, state, country, and so on. Where information is available about other regions, such as sales regions or service areas, the computer system can apply those region definitions to populate further attributes. To populate the information, the computer system can leverage AI/ML models to determine the appropriate values, and/or the computer system can access third-party databases or public data to look up the appropriate values.

Other types of attribute hierarchies can be created based on the context of the data. For example, a data set may include different product names or product feature descriptions. The computer system and the AI/ML models can analyze the information to identify commonalities in product names or product features, to create groupings of products that share certain terms or features. For example, the computer system can create product categories or subcategories based on commonalities in the description of different items.

For the creation or expansion of dimension hierarchies, the computer system can often add attributes that are specified at a more general or less-specific level than the stored data. For example, if a date is known, then the month, quarter, and year can be directly derived or extracted from the date. As another example, if a city is known, the county, state, or country can be determined using another data source that specifies the relationships (e.g., which county, state, and country different cities are located in).

Other types of data adjustment, such as data wrangling and data cleansing can include standardizing data, removing duplicates, detecting and correcting inconsistency and errors, identifying and handling missing values, and so on.

In some implementations, the computer system and the AI/ML models are used to perform data discovery, to find relevant or related data at the early stages of data modeling. For example, in addition to or instead of having users manually select data sources or data sets, the computer system can analyze and characterize data sets available and can identify data sets that are appropriate for a user's topic or task. For example, the computer system can be configured to gather information about various data sets, such as names of data sources, tables, and data objects, as well as data characterizing the types of content in the data sets. The computer system can then store the information in a vector database, such as by generating a vector in a high-dimensional space representing the semantic interpretation (and potentially structure and other characteristics) of each data set or for smaller portions of each data set. Then, the computer system can provide an interface for users to specify keywords or topics of interest, and the computer system can use the vector database to identify a set of tables or other data sets that are relevant. For example, the computer system can determine a query vector representation of the keywords or topics of interest, and compare to the vector representations for data tables to determine which are closest to the query vector representation. In some implementations, the computer system uses AI/ML models in this process, with the results from the vector database being provided to an AI/ML model for further processing and assessment. In this case, the system can use result-assisted generation (RAG) for data discovery to identify data sets relevant to a user's keywords or topics, such as a query like “sales last year.” The data tables with the closest vector representations can be selected and presented to the user, along with data indicating known or inferred relationships among them. Then, the user can approve the selected data tables or select a subset, which can begin the process of generating recommendations for data modeling and data adjustment actions.

In one general aspect, a method performed by one or more computers includes: during a session of user interaction with a graphical user interface, accessing, by the one or more computers, a data model for one or more data sets or data sources used in a session of user interaction with a graphical user interface, where the data model (i) indicates data objects that are defined for the one or more data sets or data models and (ii) includes names or descriptions for the respective data objects that are defined for the one or more data sets or data sources; generating, by the one or more computers, a request for one or more artificial intelligence and/or machine learning (AI/ML) models to identify one or more additional data objects that are not specified in the data model and that measure data of the one or more data sets or data sources, where the request is configured to cause the output to be generated based on content of the data model; obtaining, by the one or more computers, output that the one or more AI/ML models generated in response to the request, where the output indicates one or more additional data objects that are not specified in the data model and are derivable from the data objects that are specified in the data model; and based on the output generated by the one or more AI/ML models, providing, by the one or more computers and during the session, user interface data for presentation in the graphical user interface, where the user interface data is configured to cause display of (i) data identifying a particular additional data object indicated by the output of the one or more AI/ML models and (ii) a control corresponding to the particular additional data object that is selectable by the user to initiate creation of the particular additional data object.

In some implementations, the method includes: after providing the user interface data, receiving, by the one or more computers, user input data indicating user interaction with the interactive control corresponding to the particular additional data object; and in response to receiving the user input data: creating, by the one or more computers, a definition for the particular additional data object that applies a function to one or more data objects specified in the data model; and updating, by the one or more computers, the data model to include the particular additional data object, where the particular additional data object is created to include the application of one or more functions to one or more of the data objects in the data model.

In some implementations, creating the definition for the particular additional data object includes: accessing data indicating a set of data manipulation functions that are recognized by a database system; selecting one or more of the functions; selecting one or more data objects specified in the data model; and generating the definition to specify application of the selected one or more functions to the selected one or more data objects.

In some implementations, accessing the data indicating the set of data manipulation functions includes accessing a vector database storing function templates for the respective data manipulation functions in association with corresponding vector embeddings; and selecting one or more of the functions includes selecting one or more of the function templates based on similarity or distance between a query vector embedding for the particular additional data object and the vector embeddings for the function templates.

In some implementations, the method includes using the one or more AI/ML models to select the one or more data objects based on (i) the output of the one or more AI/ML models that indicates the particular additional data object and (ii) the content of the data model.

In some implementations, the output of the one or more AI/ML models includes a natural language name or a natural language description for the particular additional data object that is not specified in the data model.

In some implementations, the method includes identifying a type or category of data analysis performed using the types of data objects specified in the data model; and identifying multiple additional data objects corresponding to the identified type or category of data analysis that are not specified in the data model. The generated user interface data is configured to cause display of (i) an indication of the identified type or category of data analysis and (ii) an interactive control for each of the multiple additional data objects, each of the interactive controls being configured to initiate creation of the corresponding additional data object in response to user interaction.

In another general aspect, a method performed by one or more computers includes: providing, by the one or more computer, data for a user interface to create or edit a data model; receiving, by the one or more computers, user input through the user interface that indicates one or more data sets; in response to receiving the user input indicating the data set, generating, by the one or more computers, a set of recommendations for data modeling, data preparation, or data enrichment for the one or more data sets, wherein at least one recommendation in the set of recommendations is generated using one or more artificial intelligence and/or machine learning (AI/ML) models; providing, by the one or more computers, the set of recommendations for display in the user interface in association with one or more interactive controls to accept or dismiss the recommendations; in response to receiving user input accepting one or more of the recommendations in the set of recommendations, updating, by the one or more computers, the data model or the one or more data sets to apply an update corresponding to the accepted recommendation; and providing, by the one or more computers, the updated data set or updated data model to a chatbot or other application.

In some implementations, the one or more AI/ML models comprises a large language model (LLM).

In some implementations, the method includes repeatedly providing additional recommendations for display in the user interface as the data model is being created.

In some implementations, the method includes prioritizing recommendations for presentation in the user interface based on user acceptance or user dismissal of previous recommendations.

In some implementations, the method includes learning from user input that accepts or dismisses recommendations for data modeling, data preparation, or data enrichment, to alter which recommendation are presented for creation or editing of future data models.

In some implementations, the method includes searching through existing data repositories using to find data sets and models; and providing a recommendation that indicates a data source to add to the data model.

In some implementations, the method includes storing information about attributes and metrics from data sets in a vector database.

In some implementations, the method includes using the one or more AI/ML models and the vector database to determine whether portions of the one or more data sets represent attributes or metrics.

In some implementations, the method includes providing a list of column names to the one or more AI/ML models along with a description of metrics and attributes; and receiving, from the one or more AI/ML models, an indication of column names with a respective classification.

In some implementations, the method includes determining a vector representation for each of one or more columns of data of the one or more data sets; calculating the distance between the vector representations of the one or more columns and vector representations from the vector database; and based on the calculated distances, determining, for each of the one or more columns of data, at least one of: a type of data object corresponding to the column, a category or dimension represented by the column, or a semantic meaning of data in the column.

In some implementations, the method includes using the vector database to infer hierarchy relationships among columns or data objects of the one or more data sets, based on similarity to other data sets described by the vector database.

In some implementations, the method includes using the one or more AI/ML models to infer one or more relationships between columns of data in the one or more data sets.

In some implementations, the method includes, based on how columns with known properties and labels are grouped in the vector space of a vector database, using the similarity of vector representations of columns in the one or more data sets to the groupings in the vector space to infer properties of the columns of the one or more data sets.

In some implementations, generating the set of recommendations comprises determining one or more data preparation recommendations based on a set of stored data preparation rules that specify criteria for generating data preparation recommendations.

In some implementations, the method includes obtaining, from the one or more AI/ML models, inferred information for a portion of the one or more data sets including, for example, a semantic role, a data type, a data format, a delimiter used, or default action to perform when data is missing.

In some implementations, the set of recommendations comprises one or more recommended data preparation actions inferred to be appropriate for the one or more data sets, including at least one of: duplicate row removal, standardizing a temporal data format, enriching data by expanding an abbreviation, normalizing data, standardizing data, or filling in one or more missing values.

In some implementations, the set of recommendations comprises a recommendation for an aggregation level for data summarization determined based on characteristics of the one or more data sets.

In some implementations, the method includes performing automatic relationship detection and automatic relationship validation for relationships among data objects in the one or more data sets.

In some implementations, the set of recommendations comprises a data modelling recommendation comprising at least one of: creating a hierarchy or link between multiple data sets, creating a new relationship between multiple data objects, or associating data from the one or more data sets with an attribute or metric.

In one general aspect, a method performed by one or more computers includes: receiving, by the one or more computers, user input indicating one or more data sets; in response to receiving the user input indicating the data set, providing, by the one or more computers, a request that includes (i) data describing the data set to one or more artificial intelligence or machine learning (AI/ML) models and (ii) an instruction to identify or evaluate potential changes to the data set or a data model for the data set; identifying, by the one or more computers, one or more operations for updating the data set or the data model based on output of the one or more AI/ML models; updating, by the one or more computers, the data set or the data model by applying the identified one or more operations; and providing, by the one or more computers, the updated data set or updated data model to a chatbot, a published data set, a database system, or an application.

In some implementations, the one or more computers provide the data model to a visualization generator to generate a visualization of data, potentially for a visualization that uses data from multiple data sets.

In some implementations, the one or more computers provide at least portions of the data model to an AI/ML model to use in interpreting or processing a request from a user.

In some implementations, the one or more computers use the data model to detect ambiguities in a query or user prompt.

In some implementations, the one or more computers use the data model to determine mapping between terms of a query or user prompt to data elements in the data model.

In some implementations, the one or more computers use the data model to generate a data cube or to process SQL queries.

In some implementations, providing the data describing the data set comprises providing at least one of a portion of the data set, metadata for the data set, values describing characteristics of the data set, or labels or identifiers for data object in the data set.

In some implementations, the one or more AI/ML models comprise a large language model (LLM).

In some implementations, the user input is a user prompt to a chatbot.

In some implementations, the user input comprises selection of the data set on a user interface.

In some implementations, the method comprises using the one or more AI/ML models to generate executable or interpretable code that is configured to perform the identified one or more operations.

In some implementations, generating the executable or interpretable code comprises generating the executable or interpretable using the one or more AI/ML models.

In some implementations, the one or more computers provide data for a user interface to display the generated code and is interactive to enable the user to edit the generated code.

In some implementations, the one or more computers determine confidence scores for each of multiple operations, wherein operations that satisfy a first threshold are performed automatically and operations that satisfy a second threshold but not the first threshold are indicated as recommendations on a user interface with interactive controls that are selectable to cause the operations to be performed.

In some implementations, the one or more computers use the one or more AI/ML models to determine which functions or changes to apply, where the one or more operations comprise at least one of: identifying relationships among data elements in the data set or relationships between the data set and another data set; validating relationships; creating metrics; creating attributes; generating levels of aggregation stored in the data model; generating filter conditions; cleansing data (e.g., standardizing data, removing duplicates); generating names or labels for data objects; or enriching data by adding data elements to the data hierarchy and populating values for the added data elements.

In some implementations, the one or more computers determine that a data element in the data set that represents a measurement of time, and in response, automatically add or recommend to add data elements that represent other measures of time to complete a hierarchy of data elements representing units or increments of time.

As a result, the time dimension is indicated at multiple or additional levels of detail or levels of granularity. The data can be enriched to provide values for the additional time attributes, especially expanding to show broader measures that can be determined from narrower or more specific measures from the original data.

In some implementations, the one or more computers are configured to determine that a data element in the data set that represents a geographical dimension and then expand a geographical hierarchy.

In some implementations, to create a metric, the one or more computers can be configured to provide, to the one or more AI/ML models, data that (i) identifies operations that are supported and (ii) syntax for applying the operations. The one or more computers can be configured to: store function descriptions in a vector database; identify one or more metrics to be created based on a user prompt; evaluate which functions are needed using the one or more AI/ML models; select one or more functions from the vector database; provide retrieved function specifications from the vector database with the user request to the one or more AI/ML models; and receive from the one or more AI/ML models a formula for the metric.

In some implementations, the one or more computers can be configured to wait until the data is published to apply the set of operations or set of changes. For example, the one or more computers can be configured to: accumulate changes to the data set or data model for the data set over time, without applying the changes to the data set or data model for the data set; receive input indicating an instruction to publish the data set; in response to receiving the input indicating an instruction to publish the data, apply the accumulated changes and publishing the data with the accumulated set of changes applied.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a diagram showing an example of a system for data modeling and data adjustment using artificial intelligence or machine learning.

FIGS. 1B-1J are diagrams showing examples of processes that can be used by the system to perform data modeling and data adjustment.

FIGS. 2A-2K are diagrams showing examples of user interfaces for data modeling and data adjustment using artificial intelligence or machine learning.

FIGS. 3A-3E are diagrams showing examples of user interfaces that indicate automated recommendations for data modeling and data adjustment determined using artificial intelligence or machine learning.

FIGS. 4A-4D are diagrams showing examples of user interfaces that indicate actions for data modeling and data adjustment determined performed using interactions with a chatbot based on artificial intelligence or machine learning.

FIGS. 5A-5G are diagrams showing examples of techniques for creating metrics using AI/ML models, including by user interaction through a chatbot interface.

FIGS. 6A-6E are diagrams showing examples of techniques for detecting and protecting sensitive information.

Like reference numbers and designations in the various drawings indicate like elements.

### DETAILED DESCRIPTION

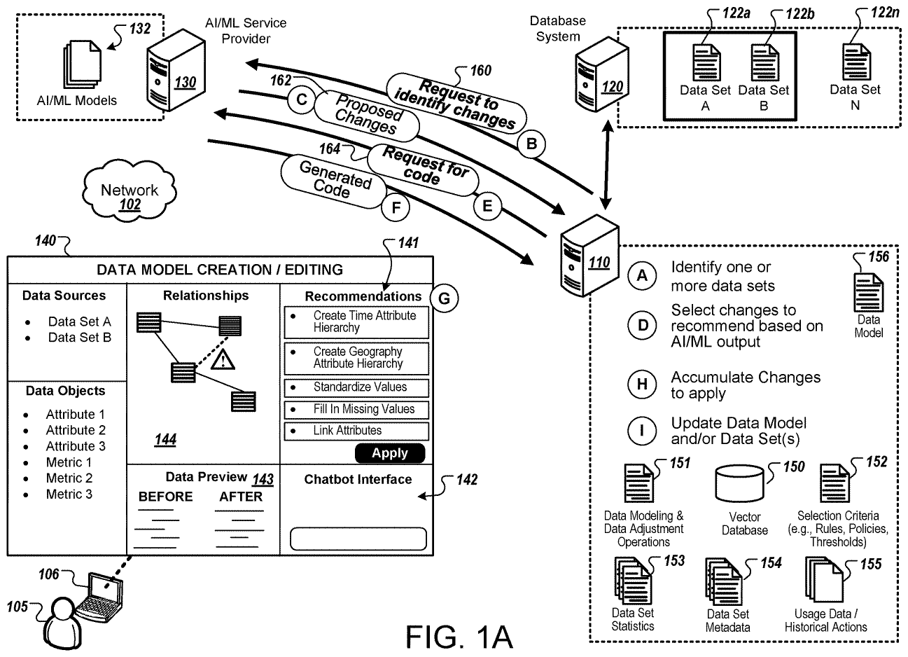

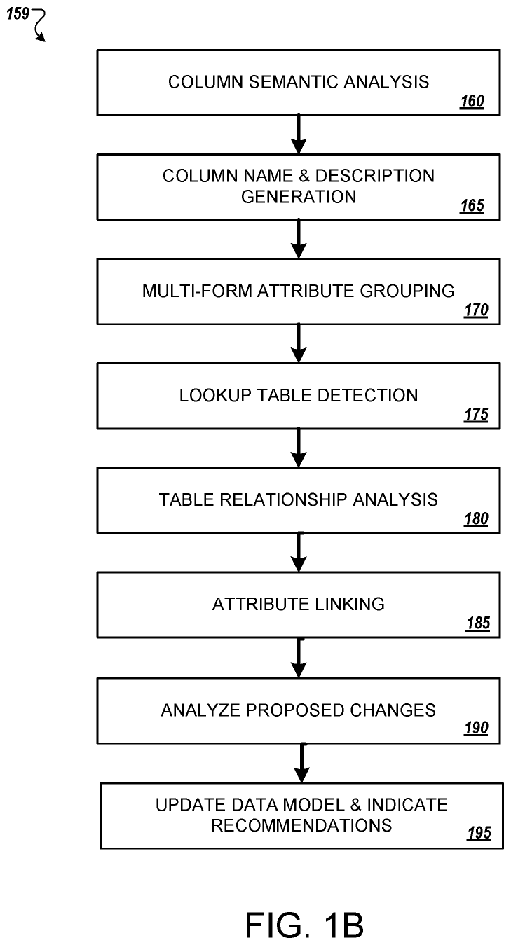

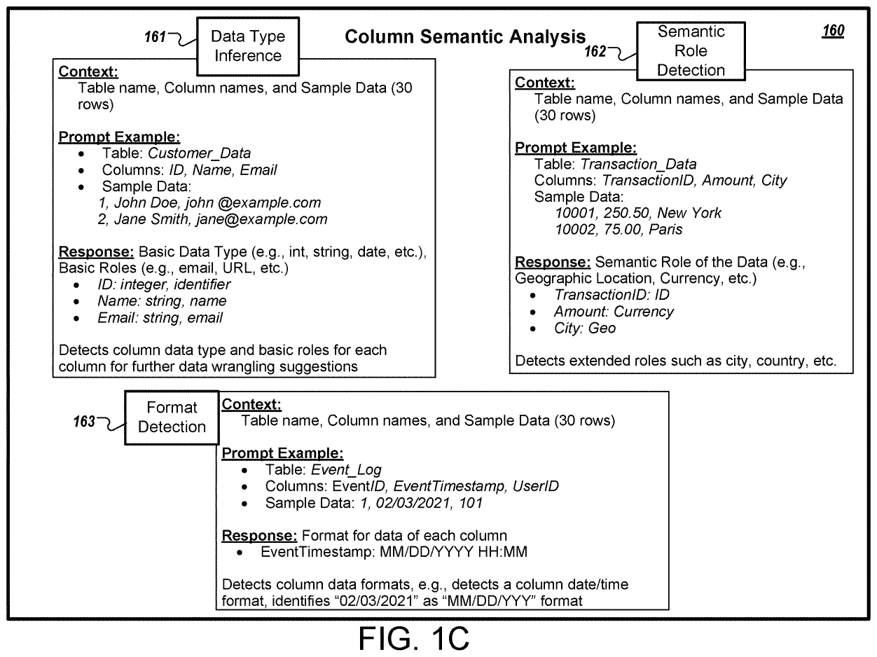

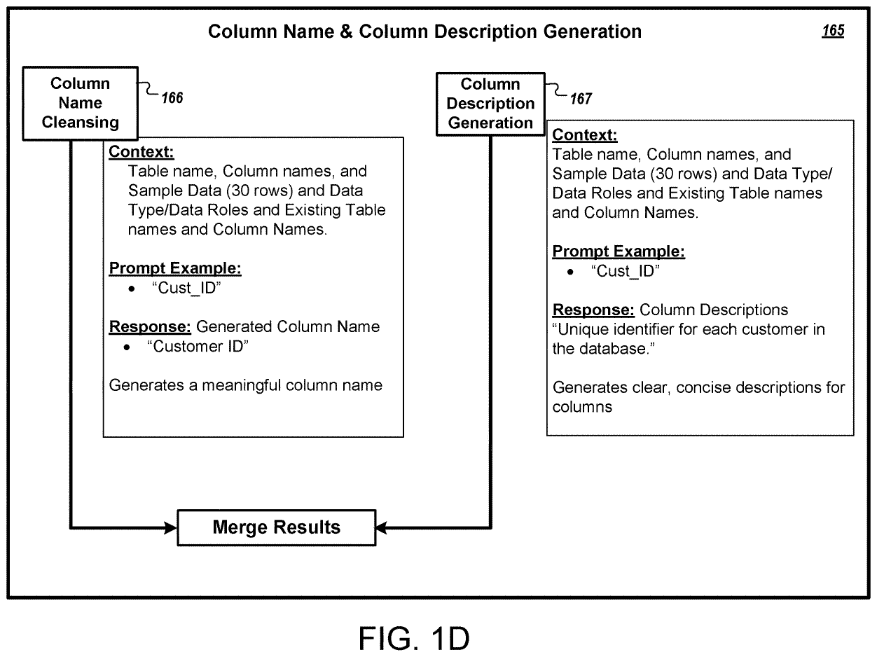

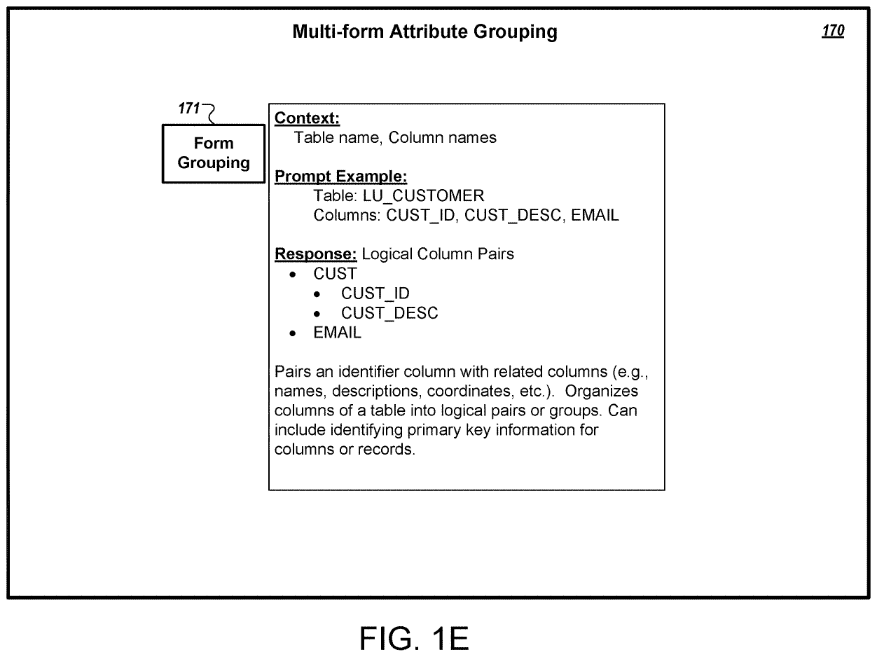

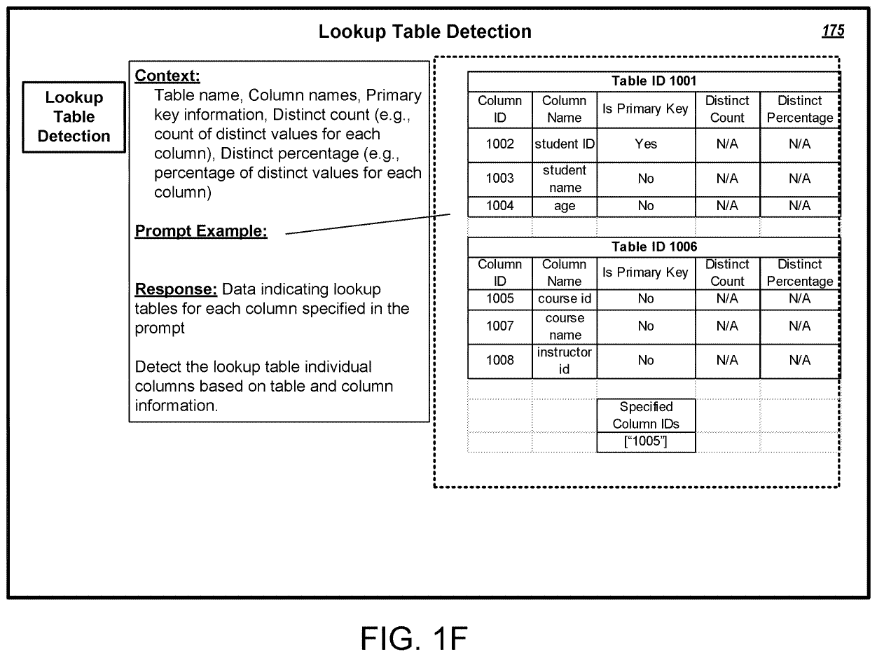

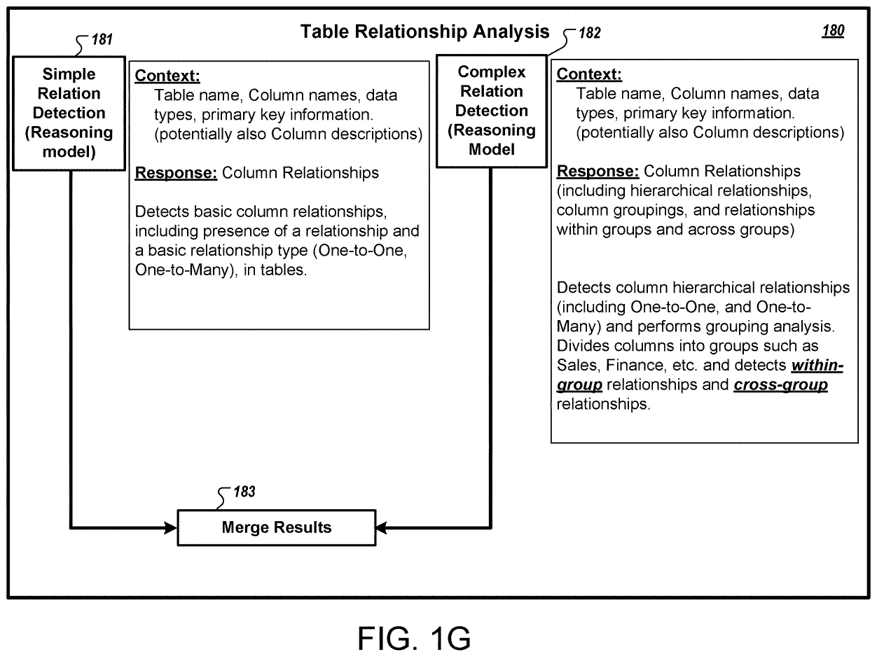

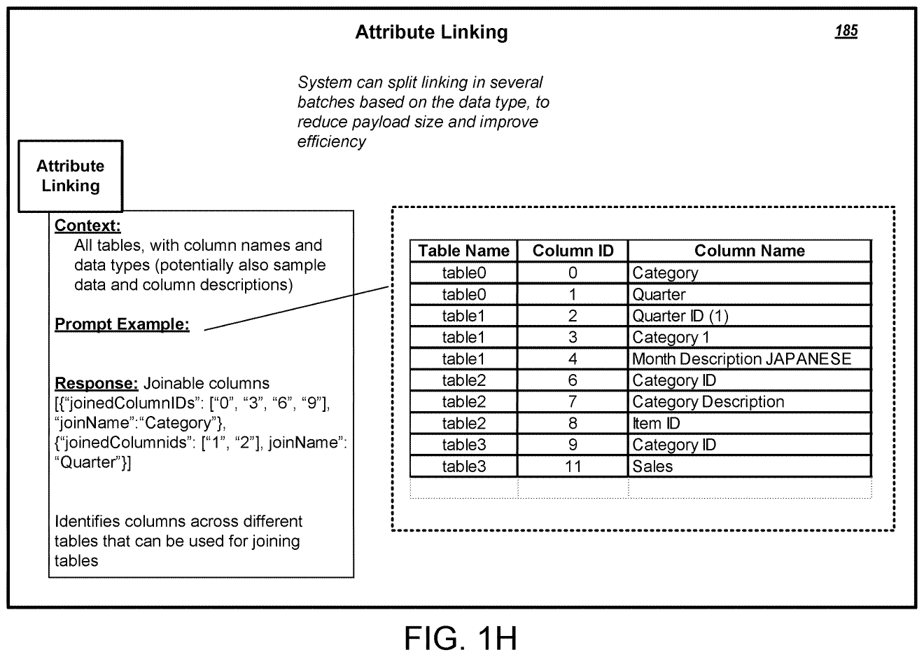

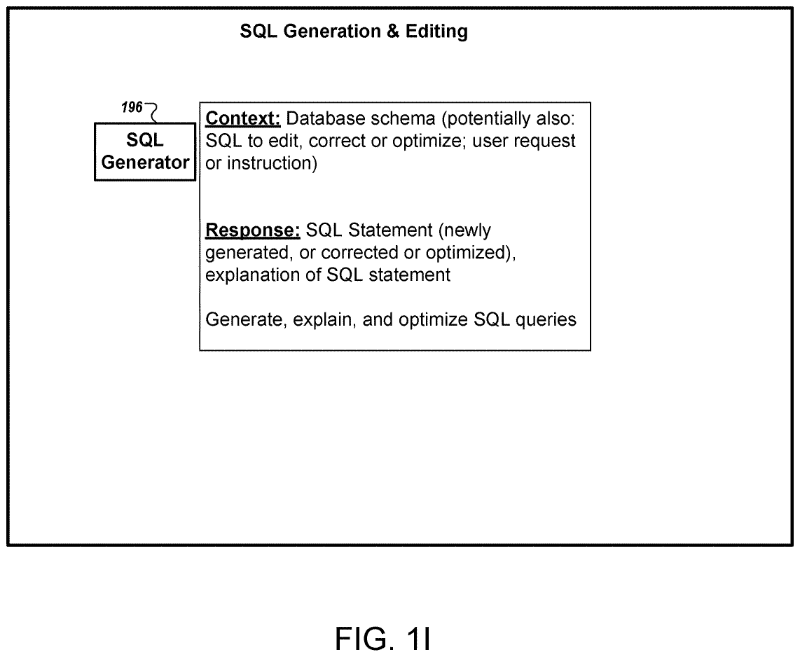

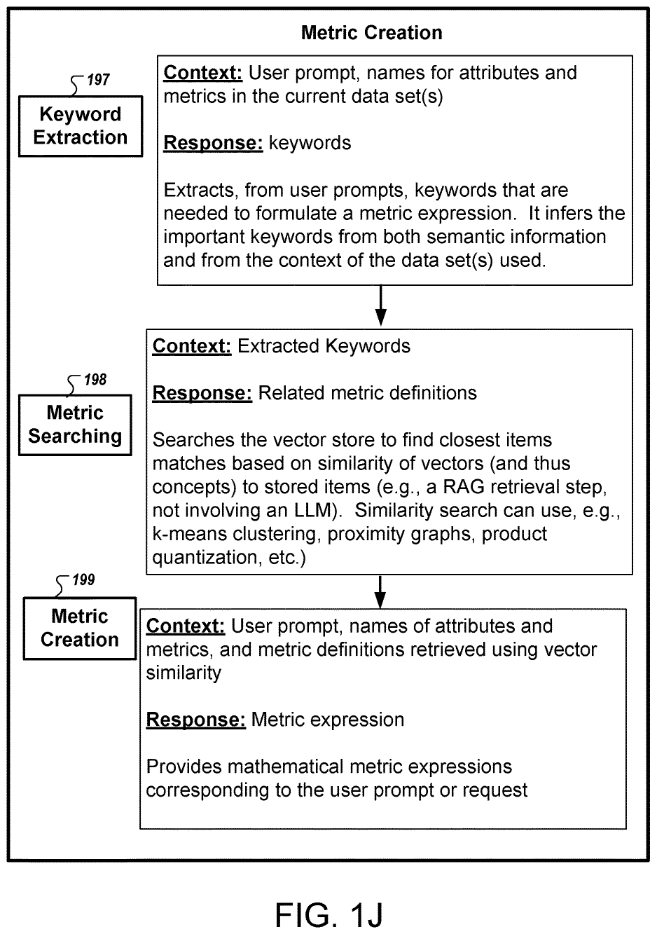

FIG. 1 is a diagram showing an example of a system 100 for data modeling and data adjustment using artificial intelligence or machine learning. The system 100 includes a computer system 110, a database system 120, and an AI/ML service provider 130. The system also includes a user device 106 of a user 105. The elements of the system 100 communicate over a network 102, such as the Internet. The computer system 110 that uses AI/ML models 132 to automatically select actions for data modeling and data adjustment, as well as implement those actions so they can be carried out to create or edit a data model and to improve and enhance data sets. The computer system 110 can provide data for a user interface 140 for data preparation and data modeling, such as a web page, a web application, data shown in a native application, etc. For example, in the example of FIG. 1, a user 105 has a user device 106, which displays a user interface 140 based on data received from the computer system 110 over a network 108.

Workers in businesses often spend significant time and resources to perform data wrangling, including steps such as discovering the data sets that are relevant for a task, structuring data in an appropriate way (including determining appropriate data models and data schemas), cleaning the data, enriching the data, and validating the data, before the data can be published and used by servers, applications, users, and more. By leveraging AI/ML models 132 in some or all of the steps of data wrangling, including in generating and adjusting data models, the system 100 can streamline the process of making data sets accessible and usable by many different systems and software applications. The use of the AI/ML models 132 and automated selection of data modeling and data adjustment actions increases productivity and makes data analytics tools more accessible to a broader range of users.

The system 100 can perform automatic modeling and data adjustment to streamline data preparation and modeling, for analysis, chatbot integration, and other uses. The system improves user interaction with data across all levels, from novice to expert, by automating much of the data cleaning, transformation, and enrichment processes. This efficiency reduces manual input and expertise requirements for users, freeing users to focus on analysis and insights, which speeds up decision-making and deployment. The system 100 can align the capabilities of multi-table data import (MTDI) systems with data processing platforms, paving the way for a seamless modeling experience.

The system 100 can assist users with automated data cleaning. In many cases, a business user wants the system 100 to automatically detect and correct errors and inconsistencies in the data, to ensure accuracy in my analyses without manual intervention. The system 100 allows this process to occur through automated workflows and conversation-based experiences rather than clicking buttons to search for or create changes to data sets and data models. The system 100 can also enable users to perform data transformation with minimal effort. Business users often need to convert data into a format suitable for analysis, without needing detailed technical knowledge of database structure and operation. The system 110 provides a guided experience where the system proactively identifies and prompts the about the next actions to prepare a dataset or data model.

Referring to FIG. 1, the computer system 110 initially communicates with the user device 106 to provide information for the user interface 140 over the network 102. For example, the user interface 140 can be configured to assist and guide the user 105 through data preparation and data modeling. In some implementations, the user 105 can use the user interface 140 to prepare a data set, potentially combining data from multiple data sources or data sets, that can be used as the source of data for an AI/ML chatbot. In other cases, the user uses the user interface 140 for data preparation for other purposes, such as publishing a data cube, providing data to be used by an application, making data available to a third-party system, and so on. The user interface can be part of a software-as-a-service (SaaS) platform, which assists users to prepare data and generate data models, even if the data resides on premises, on cloud computing platforms, or a combination of multiple locations. The user 105 authenticates to the computer system 110, so that the user's identity is determined and the user's permissions can be determined.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. The computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 stores or has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

In the example, a series of operations and data flows are shown as stages labeled (A) through (I). The operations can be performed in the order indicated or in another order. These stages represent operations for an example as discussed below, but the same operations can be repeated or supplemented in various combinations and sub-combinations also.

In stage (A), the computer system 110 identifies one or more data sets to be used for data modeling or data preparation. Identifying a data set is typically one of the first steps performed. For example, the user 105 may use the user interface 140 to select data files to upload or import, or the user 105 may select data sets or data sources that have already been registered with the computer system 110. For example, the user 105 may specify one of the data sets 122a-122n that is available from the database system 120. As another example, the user 105 may specify a data set available from a third-party system, which makes data available through an application programming interface (API), cloud computing platform, or other access mechanism. The user 105 can identify or add a data set in various ways, such as by dragging and dropping a file, selecting an icon in the user interface 140, selecting data sets from a list, and so on. In the example, the user 105 selected two data sources, Data Set A 122a and Data Set B 122b.

In some implementations, the computer system 110 performs data discovery to find and suggest to the user 105 data sets to use. The computer system 110 can use the AI/ML models 132 to perform data discovery, to find relevant or related data at the early stages of data modeling or data preparation. For example, in addition to or instead of the user 105 manually selecting data sources or data sets, the computer system 110 can analyze and characterize data sets 122a-122n available and can identify one or more data sets that are appropriate for a user's topic or task.

For example, to prepare to perform data discovery, in advance of a user's task, the computer system 110 can gather information about various data sets 122a-122n, information such as names of data sources, tables, and data objects, as well as data characterizing the types of content in the data sets 122a-122n. The computer system 110 can then store the information in a vector database 150, such as by generating a vector in a high-dimensional space representing the semantic interpretation (and potentially structure and other characteristics) of each data set or for smaller portions of each data set.

Once the vector database 150 has been populated, the computer system 110 can provide an interface for the user 105 to specify keywords or topics of interest, and the computer system 110 can use the vector database 150 to identify a set of tables or other data sets that are relevant. For example, after receiving a query from the user 105, the computer system 110 can determine a query vector representation of the keywords or topics of interest, and compare the query vector representation with the vector representations for data tables to determine which are closest to the query vector representation. In some implementations, the computer system 110 uses the AI/ML models 132 in this process, with the results from the vector database 150 being provided to an AI/ML model 150 for further processing and assessment. In this case, the computer system 150 can use result-assisted generation (RAG) for data discovery to identify data sets relevant to a user's keywords or topics, such as a query like “sales last year.” The computer system 110 selects the data tables with the vector representations closest to the query vector representation, and can present these to the user 105, along with data indicating known or inferred relationships among the selected data tables. In other cases, information about the results from the vector database are provided to the AI/ML models 132 processing first, and data tables that the AI/ML models 132 indicate to be most relevant to the query (in view of the vector database results) are then provided to the user. The user can approve the selected data tables, or select a subset of the data tables to use, which can begin the process of generating recommendations for data modeling and data adjustment actions.

In stage (B), the computer system 110 uses information about the identified one or more data sets to request that the AI/ML models 132 determine data modeling or data preparation actions. The computer system 110 initiate the process of analyzing data sets and identifying recommended data modeling and data preparation actions, to automatically surface recommendations to the user 105.

The computer system 110 can identify appropriate actions in various different ways. In some cases, the computer system 110 analyzes the data sets 122a, 122b and determines data set statistics 153 for the different data sets and their components. These statistics 153 and other data can characterize the selected data sets 122a, 122b, indicating information that describes the structure, meaning, and content of the data sets 122a, 122b. The computer system 110 can also apply selection criteria 152, which specify rules, policies, thresholds, and other criteria for different types of actions. For example, the selection criteria 152 can indicate standardization rules or preferred formats for different types of data (e.g., addresses, names, email addresses, phone numbers, etc.), and the computer system 110 can apply these rules to detect when data of a particular type deviates from the preferred format or uses inconsistent formats. The computer system 110 can also store a set of operations 151 to evaluate. For example, the set of operations 151 can include a list of data modeling actions and data preparation actions, along with a criteria for determining when each is appropriate. For some types actions, the computer system 110 can determine that an action is appropriate without using the AI/ML models.

The computer system 110 can also use the AI/ML models 132 to identify data modeling and data processing actions. For example, the computer system 110 can generate and send a request 160 for the AI/ML models 132 to determine changes to a data model or data set. The computer system 110 can include in the request 160 a prompt or instruction for the AI/ML models 132 to consider each of a set of different possible actions, and to determine whether each is appropriate for the current data set. The computer system 110 can include in the request 160 information about the data sets 122a, 122b, such as the column names, table names, metadata, sample data (e.g., a few rows or synthetic data representative of the data content), and so on. This information can provide the AI/ML models 132 the ability to refer to components of the data sets 122a, 122b with identifiers or names that are consistent with those used by the computer system 110, as well as give the AI/ML models 132 information to infer data types and the interpretation of different portions of the data.

In addition, the computer system 110 can include in the request 160 the data set statistics 153 and data set metadata 154, which can further give the AI/ML models 132 the ability to detect anomalies and infer the overall characteristics of the data sets 122a, 122b, even when the content of the data sets 122a, 122b is not provided. This improves privacy and saves time and network bandwidth because the data sets 122a, 122b do not need to be transferred to the AI/ML service provider 130. In addition, providing characterization data or measures derived from the data sets 122a, 122b speeds the processing of the AI/ML models 132 and reduces the computational complexity and cost, because the AI/ML models 132 do not need to process the content of the data sets 122a, 122b.

The computer system 110 can include other information in the request 160 to assist the AI/ML models 132 in making an accurate identification of data modeling and data processing actions. For example, the computer system 110 can provide the set of operations 151, so the AI/ML models 132 has a defined set of actions or changes to consider, and so the AI/ML models 132 can consider each of the possible changes. In addition, the computer system 110 can provide the selection criteria 152, so the AI/ML model 132 can apply the rules, policies, thresholds, or other criteria in generating its output. Optionally, the computer system 110 can also provide examples of the various different types of possible actions or changes. For example, this can include, for each type of action to be considered, (1) one or more example patterns, data set characteristics, or data contexts when the action is appropriate, and (2) one or more example patterns, data set characteristics, or contexts when the action is not appropriate. These examples can guide the AI/ML models 132 by giving reference examples for detecting when the different types of actions are appropriate. In addition, the computer system 110 can further examples through usage data or historical actions 155. The data 155 can provide records or statistics for examples where data modeling or data preparation actions were recommended to users, together with the result whether the user accepted or dismissed the recommendation. More generally, examples of properly-formed reference data models or data schemas can be provided, labeled as needing particular actions or not. This can guide the AI/ML models 132 to determine when the data set or data model being assessed is similar to those that previously needed a particular type of change (so that change should be recommended), or if the data set has characteristics that are more similar to data sets or data models that did not need that type of change (so that change should not be recommended).

In stage (C), the computer system 110 receives output 162 that the AI/ML models 132 generated in response to the request 160. The output 162 indicates a set of changes that one or more AI/ML models 132 indicated to be appropriate for the data model being edited or for preparing the data sets 122a, 122b. For example, the output 162 can indicate a subset of the set of operations 151 that were provided to the AI/ML model 162 to consider. As discussed above, the request 160 can provide the selection criteria 152 for determining whether each type of change is appropriate. The request 160 can also include instructions to select or indicate only changes or actions that are most relevant or have a minimum level of confidence or likelihood of being appropriate for the current data.

In some implementations, the computer system 110 includes in the request 160 an instruction to provide a ranking of the appropriateness of the different actions or changes. In addition, or as an alternative, the computer system can instruct the AI/ML models 132 to provide a score for each action or change selected, such as a confidence score or relevance score. In some cases, the score for a type of change can be a measure of how well the AI/ML models 132 estimates that information about the current data model or data sets 122a, 122b matches or is similar to other examples in which that particular change was performed. As a result, the output 162 from the AI/ML models 132 can include indications of the appropriateness of different changes, whether relative to each other (e.g., a ranking) or on an absolute or non-relative scale.

In stage (D), the computer system 110 analyzes the output 160 from the AI/ML models 132 and select changes or actions to perform. The output 160 can indicate a subset of potential changes that the AI/ML models 132 are most likely to be appropriate for the current data sets 122a, 122b. The computer system 110 can further assess the appropriateness of these changes, by verifying the appropriateness according to the selection criteria 152 and by generating its own set of scores for the relevance or appropriateness of the selected changes. The computer system 110 can thus further limit or filter the changes suggested by the AI/ML models 132 based on its own analysis, to ensure accuracy and ensure that the recommendations made to the user 105 will be useful. In addition, the computer system 110 can supplement the set of proposed changes from the AI/ML models 132 with items that the computer system 110 determined from its own analysis of the data sets 122a, 122b.

In stage (E), the computer system 110 requests for the AI/ML models 132 to generate interpretable or executable code to carry out the set of changes that the computer system 110 has selected. For example, the computer system 110 generates a second request 162 for code to carry out each of the changes that the computer system 110 has selected based on its own analysis and its review of the output 162 from the AI/ML models 132. As an example, the computer system 110 can request for the AI/ML models 132 to generate code for functions in the Python programming language or in another programming language. To facilitate the processing by the AI/ML models 132, the computer system 110 can provide with the request 164 a list of the changes that the computer system 110 has selected to be recommended to the user 105. If needed, the computer system 110 can again provide descriptions of the types of changes to be made as well as characteristics of the data sets 122a, 122b. Nevertheless, in many cases, the AI/ML models 132 will retain this information from the context of the session, as long as the amount of data that has not exceeded the context window for the AI/ML model 132. When appropriate, the computer system 110 can provide additional context about the changes to be made, so that the generated code appropriately references the particular tables, columns, data objects, rows, fields, and other items that need to be changed. In other cases, the computer system 110 can fill in values for parameters in the code to make these references after receiving the generated code.

In addition, new code may not need to be generated for every change period for example, many standardized functions such as removing leading or trailing whitespace may be already stored by an available to the computer system 110, so they do not need to be generated again.

In stage (F), the computer system 110 receives generated code 166 that the AI/ML models 132 provide in response to the second request 164. The computer system 110 you can perform validation and testing operations on the generated code 166, to verify that each function or type of change that the code implements can be executed properly. If there are errors or inconsistencies, the computer system 110 can make edits or perform iterative requests to the AI/ML models 132 to correct the code. In addition, the computer system 110 can update fields or values in the code to specify particular portions of the data sets that should be operated on. For example, for code configured to operate on particular fields or particular values, the computer system 110 can identify or verify that the code operates on the fields or values that the function should operate on.

In stage (G), the computer system 110 provides data indicating the selected changes to the user device 106 over the network 102. The user device 106 updates the user interface 140 to show the various recommended items. In the example, the user interface is 140 populates a recommendations area 141 to indicate recommendations including creating a time attribute hierarchy, creating a geography attribute hierarchy, standardizing values, filling in missing values, and linking together certain attributes. Beyond indicating a type or category of change to make, the various items can indicate specifically which data objects, tables, types of values, or other specific items would be changed. The items in the recommendation area 141 are selectable so that the user 105 can interact with them one by one to instruct individual recommended changes to be made. Similarly, the recommendation area 141 can include one or more controls to apply all recommended changes. The recommended changes can include items that prepare the data, and thus alter or adjust the data sets 122a, 122b. Other recommended changes can include items that build or alter a data model for the data sets 122a, 122b.

The user interface 140 includes other areas that can facilitate changes to data models and data sets. For example, the user interface 140 can include a chatbot interface 142 with a text field, in which the user 105 can enter text prompts or instructions to a chatbot. The chatbot is provided the context of the current data model being generated and the data sets 122a, 122b, so the user 105 can refer to items on screen or in the data sets 122a, 122b when requesting changes.

The user interface 140 also shows a data preview area 143 that can be used to illustrate the effect of one or more proposed changes. For example, if the user selects one of the items in the recommendation area 141, the user interface 140 is updated to show example records with the values before making the change and the resulting values that would occur after making the change. As a result, the user 105 can see the effect of a recommended change even before accepting or applying that change.

The user interface 140 shows another area 144 that illustrates connections among data objects. For example, the area 144 can show tables and the relationships among them, or data objects and relationships among them. In some cases, the recommended changes determined by the computer system 110 include changes to add, alter, or remove relationships in the data model. For example, the area 144 shows a warning that a relationship represented by a dotted line does not meet validation rules, and so needs to be removed or changed. This type of recommended change can be determined by the computer system 110 using its own processing of rules and/or based on analysis and output generated by the AI/ML models 132.

As the user 105 accepts or applies recommended changes from the recommendation area 141, and makes requests in the chatbot interface 142, and edits relationships in the area 144, the data model represented in the user interface 140 is also updated. Areas of the user interface 140 that indicate the attributes, metrics, and other data objects in the data model are also updated.

In stage (H), the computer system 110 accumulates changes to make based on the interactions of the user 105 with the user interface 140. As the user 105 applies recommended changes or makes manual edits, the computer system 110 maintains a list of these items, and during the session builds the list of changes to later apply. In many cases, changes that would affect the data sets 122a, 122b are not applied immediately, which gives time for the user 105 to review and consider the full set of changes before incurring the processing and delay of applying the changes.

In stage (I), the computer system 110 applies the accumulated changes to update the data model and or data sets 122a, 122b. As noted above, many changes to the data model can be performed over the course of the users interactions, especially so those changes are reflected in the user interface 140 and in the data model records. Nevertheless, other accumulated changes corresponding to recommended items that the user accepts or applies can be deferred until a publishing event triggers application. For example, the user 105 finalizes the data model and selects to publish the data to an application, a chatbot, or another system. In response, the computer system 110 performs the functions (e.g., generated code) for the recommend items that the user 105 has applied, as part of finalizing and publishing the data. The computer system 110 also stores the data model 156 and can make it available to other systems to be able to access and interpret the data in the data sets 122a, 122b.

FIG. 1B-1J are diagrams showing examples of processes that can be used by the system to perform data modeling and data adjustment. The example of FIG. 1A shows stages (B) and (C), in which the computer system 110 sends information to be processed by the AI/ML models 132 and receives proposed changes or recommendations in response. These steps can be performed in a series of multiple interactions that address different aspects of data modeling. In some implementations, a series of interactions can be performed to incrementally build understanding about the characteristics and content of data sets 122a-122b to be described by a data model 156. In some cases, depending on the item to be assessed, the computer system 110 can generate requests to the AI/ML models 132 for each table or for each column of each table of data. In addition, or as an alternative, the computer system 110 may send requests for the AI/ML models 132 to perform analysis for a set of multiple tables (e.g., for some or all of the data in the data sets to be described by the data model 156).

FIG. 1B shows an example of a process that the computer system 110 can use to perform a series of interactions with the AI/ML models 132 to generate recommendations. The various steps or stages can be performed in the order shown, or many can be performed separately to achieve specific analysis results. In some implementations, one or more of the steps or stages illustrated can build on the results of the previous step. For example, the output of one step may be provided as input or context to the next step.

FIG. 1B shows a process 159 that includes:
column semantic analysis 160 to determine data types, semantic data roles, and data formats;
column name and description generation 165 to generate a meaningful natural-language column name and a description of each column;
multi-form attribute grouping 170 to group related columns or data objects;
lookup table detection 175 to determine a lookup table for each individual column (e.g., specifying a data set, table, and column where each attribute, metric, or other data object can be found);
table relationship analysis 180 to determine column relationships (e.g., detecting the presence of a relationship, a type of relationship (e.g., one-to-one or one-to-many), hierarchical relationships, grouping of columns and detection of relationships between columns within groups and across groups);
attribute linking 185 to identify columns that can be used for joining tables;
analyzing proposed changes 190; and
updating the data model 156 and indicating recommendations 195.

Each of the steps or stages shown in FIG. 1B can have multiple components and each can make use of an AI/ML model 132 or a retrieval using a vector store or a vector similarity search. FIGS. 1C-1H illustrate steps 160, 165, 170, 175, 180, and 185 in further detail. For each of these steps, and for sub-components of them, the computer system 110 can store predetermined instructions that are tailored or targeted to specific functions or operations. Each request to the AI/ML models 132 can include a particular set of context for one or more columns or tables, along with one of the predetermined instructions corresponding to the particular type of analysis or generation needed.

FIG. 1C shows additional detail about operations that the computer system 110 can perform to perform column semantic analysis. These include data type inference 161, semantic role detection 162, and format detection 163. Each of these operations can include a different type of request to an AI/ML model 132, and type of request can be performed for each table of data of the data sets 122a-122b selected to be described by the data model 156. For example, if there are 5 tables, the data type inference 161, semantic role detection 162, and format detection 163 would be performed for each of the 5 tables.

For data type inference 161, the computer system 110 provides the AI/ML model 132 context that includes a table name, column names for the columns of the table, and a set of sample data from the table for each column (e.g., 30 rows of data from the table). The computer system 110 provides an instruction for the AI/ML model 132 to determine, for each column in a table, a data type of the data in the column and a basic semantic role for the column. For example, the data type can indicate whether the data is an integer, a string, a date, geographical location, and so on. Similarly, the basic semantic role for the data can indicate the meaning or content of the data, such as, e-mail, a URL, a street address, a zip code, and so on. As an example, the table Customer_Data is indicated in the prompt, along with column names “ID,” “Name,” and

“Email,” and several columns of example data. Based on the instruction in the prompt, and the context provided with the prompt (e.g., including the metadata for the table name and column names and the sample data), the AI/ML model 132 generates a response that specifies the data type and basic semantic role for each column. For example, the response can indicate that: column ID has a data type of integer and the semantic role is as an identifier; column Name has a data type of string and a semantic role of name (e.g., name of a person); and column Email has a data type of string and a semantic role of email address. By sending a request and response like this for each table in the data sets 122a-122b to be analyzed and described by the data model 156, the computer system can detect the column data types and semantic roles for each column of data.

The computer system 110 then uses the detected data types and semantic roles to apply appropriate validation and data wrangling rules for each data type. For example, based on the data types, the computer system 110 checks whether the data in the Email column all meet the required syntax for email addresses and can create recommendations to correct entries that do not. Similarly, the computer system 110 can examine values in the ID column to identify fields that are missing, null, or have values that are not an integer, and so represent outliers or invalid identifiers, and the computer system 110 recommends corrections. The data types and data roles can also be provided to the AI/ML models 132 for further AI/ML processing and validation later on.

For the semantic role detection 162, the computer system 110 provides the AI/ML model 132 context that includes a table name, column names for the columns of the table, and a set of sample data from the table for each column (e.g., 30 rows of data from the table). The computer system 110 provides an instruction for the AI/ML model 132 to determine, for each column in a table, extended semantic roles. For example, rather than just determining that a value represents geographical information, the semantic role detection can determine more specifically that a column of data represents a city, a country, etc. The example shows sample data for a table named “Transaction_Data” and three columns named “TransactionID,” “Amount,” and “City.” Based on the instruction from the computer system 110 to determine the semantic roles, and the information about the data provided, the AI/ML models 132 provide data indicating that column TransactionID represents an identifier, that column Amount represents currency (e.g., monetary values), and that City represents a geographical location or more specifically a city.

For format detection 163, the computer system provides the AI/ML model 132 context that includes a table name, column names for the columns of the table, and a set of sample data from the table for each column (e.g., 30 rows of data from the table). The computer system 110 provides an instruction for the AI/ML model 132 to determine, for each column in a table, the data format for the column. The example shows sample data for a table named “Event_Log” with three columns named “EventID,” “EventTimestamp,” and “UserID.” After being instructed by the system to determine the data formats for the columns of this table, the AI/ML model 132 provides a response that indicates that the EventTimestamp column MM/DD/YYYY HH: MM (e.g., two digit month, a slash, two digit day, a slash, a four-digit year, a space, two digit hour, a colon, and a two digit amount of minutes). The other two columns can be detected to simply have integer data formats. From the data formats determined by the AI/ML models 132, the computer system 110 can perform analysis on the data in the tables to identify cases where the data formats are not followed correctly, and the computer system 110 can provide recommendations that specify changes for specific records or fields to follow the determined data formats. The formats that are detected allow the computer system 110 to effectively parse data, detect incorrectly formatted data, and perform other operations.

The computer system 110 can save the information determined by data type inference 161, semantic role detection 162, and format detection 163 in the data model 156. For example, the computer system 110 can automatically update the data model 156 to indicate, for each column the data types, data roles, and data formats determined for each column. This information can also be used to generate or describe the various logical data objects that will be shown to the user as attributes, metrics, etc.

FIG. 1D shows column name and column description generation 165 performed using the one or more AI/ML models 132. Based on semantic information, the computer system 110 can obtain a name and description for columns. This includes column name cleansing 166 and column description generation 167. In some implementations, to enable the AI/ML models 132 to benefit from the context of all of the tables and relationships that may be present, the column name cleansing 166 and column description generation 167 each performed once, with the full context information for all tables. This can improve accuracy by, for example, providing additional context to allow more accurate column names, and also to show relationships that allow more accurate descriptions.

For column name cleansing 166, the computer system 110 provides the AI/ML model 132 with a table name, column names for the columns in the table, and sample data from the table (e.g., 30 rows), as well as the data types and data roles determined through the column semantic analysis 160. The computer system 110 also provides the AI/ML model 132 any existing table name or label for the table and existing column names or labels (e.g., metadata or natural language names other than the formal identifiers). With this context, the computer system 110 provides an instruction for the AI/ML model 132 to generate a natural language column name for each of the columns in the table. The instruction can include criteria specifying desired criteria for the names, e.g., length, descriptiveness, etc. The instruction can include examples of column references and natural language names as well. The AI/ML model 132 provides a response that includes a generated column name for each of the columns of the table described in the context. For example, if the table has a column named “Cust_ID” the AI/ML model 132 can provide a new name of “Customer ID” to be used. In this way, new names can be determined for some or all of the columns in a table, and the process is performed for each of the tables.

For column description generation 167, the computer system 110 provides the AI/ML model 132 with a table name, column names for the columns in the table, and sample data from the table (e.g., 30 rows), as well as the data types and data roles determined through the column semantic analysis 160. The computer system 110 also provides the AI/ML model 132 any existing table name or label for the table and existing column names or labels (e.g., metadata or natural language names other than the formal identifiers). With this context, the computer system 110 provides an instruction for the AI/ML model 132 to generate a concise description of each column. The computer system 110 can provide the AI/ML model 132 criteria for generating the description (e.g., one sentence or one line, etc.) and can give examples of inputs and appropriate outputs. The AI/ML model 132 provides output that includes a column description generated based on the table and column information provided in the context. For example, for a table that includes a column named “Cust_ID,” the AI/ML model is given the column name and the data type (e.g., integer), and data role (e.g., identifier), and other information about this and other columns in the table. The AI/ML model 132 generates a column description of “unique identifier for each customer in the database” for the “Cust_ID” column.

The computer system 110 merges the results from the column name cleansing 166 and column description generation 167 to save in the data model 156 the generated column name and column description for each of the columns of each of the tables. In some implementations, the same techniques used to generate names and descriptions for columns can also be used to generate names and descriptions for tables, data sets, or other items.

FIG. 1D shows processing for multi-form attribute grouping 170 performed using the one or more AI/ML models 132. In many cases, there may be multiple columns that describe an entity, such as a first name and last name that both relate to the same person. The AI/ML model 132 can be used to identify related types of data that can be associated to form a single logical attribute form that has multiple fields. This process involves form grouping 171 processing that uses a request to an AI/ML model 132, which can be performed for each table of the data sets 122a-122b corresponding to the data model 156. The context provided to the AI/ML model 132 includes the table name and the names of each of the columns of the table. The column names can be column names that an AI/ML model 132 generated, such as through the column name generation processing of step 165. In some implementations, the column descriptions are also provided as context to the AI/ML model 132. The original column names and/or descriptions can optionally be provided to the AI/ML model 132 also.

The computer system 110 sends the table and column information (e.g., all for the same table) to the AI/ML model 132 with an instruction (e.g., a prompt from the system 110) to identify related columns, e.g., columns that all describe properties of the same entity. For example, if the table “LU_CUSTOMER” and column names “CUST_ID,” “CUST_DESC,” and “EMAIL” are provided, the AI/ML model 132 provides logical column pairs or groups. For example, for the three columns, the AI/ML model 132 provides output indicating that two of the three columns, “CUST_ID” and “CUST_DESC,” relate to the same entity (e.g., customer or “CUST”), and so should be grouped together in a multi-attribute form. In general, the multi-form attribute grouping can pairs or associate an identifier column with one or more related columns (e.g., names, descriptions, coordinates, etc.). This can organizes columns of a table into logical pairs or groups. In addition, the AI/ML model 132 can be instructed to select or determine identifying primary key information for columns or records. The groupings that the AI/ML model 132 determines can be saved and provided as data modeling recommendations to be presented to the user.

FIG. 1F shows an example of lookup table detection 175 performed using the one or more AI/ML models 132. The lookup table detection is configured to optimize query generation by finding a lookup table that can connect to the source table for the information in a given field or column. In general, logical data objects such as attributes, metrics, attribute forms, etc. are abstractions, and the data model 156 generally should provide a link or connection to the source table that is the source of the values for the data objects. Thus, a lookup table in this context can be an identification of the table from which values of a data object can be sourced or accessed. The lookup table detection 175 can map the relationships of tables to data objects. Most of the time, attribute fields or columns come from the same table where the column is stored. A data table or schema can show if there is a join needed or available for a data object.

In the example, lookup table detection 175 is performed with a request to an AI/ML model 132 for each table of the data sets 122a-122b corresponding to the data model 156. The context provided with the request can include the table name of the current table, column names for the table, primary key information (e.g., an identification of the primary key column or data object), a distinct count of values for the columns (e.g., for each column, what is the count of distinct values in the column), and a distinct percentage of values for the columns (e.g., for each column, what percentage of values in the column are distinct). In some implementations, the request to the AI/ML model 132 includes information about multiple tables or all tables in the data sets 122a-122b, so that possible joins can be determined. With this information the computer system 110 provides a instruction for the AI/ML model 132 to identify the lookup table, or source table, for each of a designated set of columns. In the illustrated example, a single specified column ID of “1005” is provided, to request the lookup table information for that particular column. Other types of requests can be made with lists of multiple columns or all columns of a table to request lookup table information for some or all columns. The response from the AI/ML model 132 provides data indicating lookup tables for each column specified in the prompt. This allows the process to detect the lookup table individual columns based on table and column information. The computer system 110 updates the data model 156 with the lookup table information, and notifies the user with an error or a recommendation if there is a non-standard situation, such as a failure to find a lookup table, conflicting information, etc.

FIG. 1F shows an example of table relationship analysis 180 performed using the one or more AI/ML models 132. This involves simple relation detection 181 and complex relation detection 182, with the results being merged 183 afterward. This process can be performed for each table of the data sets 122a-122b, e.g., with simple relation detection 181 and complex relation detection 182 being done for each table. The simple relation detection 181 and complex relation detection 182 can be performed using requests to a reasoning model, e.g., an LLM that is configured to break down problems into smaller, logical steps, often referred to as “chain-of-thought” reasoning.

Table relationship analysis can be configured to determine the hierarchy of tables, and can involve collecting information for primary and foreign keys. If the information is not available, the computer system 110 asks the AI/ML model 132 to infer the keys. The request to the AI/ML model 132 can be for a set or sequence of operations, which makes the reasoning model an effective type of model to use. For example, the table relationship analysis can involve asking the model 132 to determine a set of columns related to a key, then identify in each group that are related, then determine what are the relationships across groups, and then repeat all of these steps again for additional levels of connections or associations. The results from the AI/ML model 132 can effectively build relationships table to table, and group to group, until an overall hierarchy is built.

For the simple relation detection 181, the AI/ML model 132 is asked to identify relationships between columns in a table. The computer system 110 provides the AI/ML model 132 the instruction with context including a table name, column names for the columns in the table, data types for the columns, and primary key information, and potentially also column descriptions. The output of the AI/ML model 132 are column relationships, including where a relationship is present, a type of relationship. This detects basic column relationships, including presence of a relationship and a basic relationship type (e.g., one-to-one, one-to-many), within a table.

For the complex relation detection 182, the AI/ML model 132 is asked to identify more complex relationships, including hierarchical relationships, column groupings, and relationships within groups and across groups. The computer system 110 provides the AI/ML model 132 the instruction with context including a table name, column names for the columns in the table, data types for the columns, and primary key information, and potentially also column descriptions. In addition, to facilitate the determination of relationships across groups, information about column groups in a table can be provided if known, otherwise the AI/ML model 132 can generate the group information and infer additional relationships between the groups. As a result, the AI/ML model 132 can be used to detect column hierarchical relationships (including one-to-one, and one-to-many) and performs grouping analysis. The output can indicate a hierarchy of columns, and can divides columns into groups (such as Sales, Finance, etc.) by topic, entity, dimension, or other criteria, and detects within-group relationships and cross-group relationships.

After relationships are identified using the simple relation detection 181 and complex relation detection 182, the computer system 110 validates the results. The two processes should provide consistent results, even if the simple relation detection 181 does not provide as many or all of the types of relationships that are determined through the complex relation detection 182. When the computer system 110 detects a mismatch or inconsistency among the outputs, the computer system 110 can provide the information to the AI/ML model 182 and ask it to resolve the discrepancy if possible, or the computer system 110 can flag the issue for the user as an error or a recommendation for a change to be made.

In some implementations, the grouping and relationships among groups can be performed for multiple levels to determine a hierarchy, which may include instructing the AI/ML model 132 to perform the analysis for multiple levels of groups, or may include iteratively sending additional prompts to request information about additional levels. In some implementations, the computer system 110 and the AI/ML model 132 use semantic information at each analysis step. For example, when determining whether to create an attribute or to group attributes, the system 110 can use the AI/ML model 132 to (1) evaluate whether another attribute with similar name, description, and/or data type has been created, (2) compare how close the existing attribute or group is to the new candidate attribute or group, and (3) determine relationships based on the similarity.

FIG. 1H shows an example of table attribute linking 185 performed using the one or more AI/ML models 132. The attribute linking can be performed across all of the tables of the data sets 122a-122b rather than for a single table at a time. Nevertheless, to increase efficiency and reduce the amount of context the AI/ML model 132 needs to process in a single request, the computer system 110 can split the task into several batches based on the data type of the columns. As context, the computer system 110 provides the AI/ML model information about all tables, including column names and data types (e.g., integer, string, etc.). The computer system 110 provides an instruction for the AI/ML model 132 to identify attributes that can be linked or joined. For example, the AI/ML model can provide output that indicates joinable columns (e.g., a list of column identifiers to be joined, and a name for the join). In general, the attribute linking can be used to identify columns across different tables that can be used for joining tables together. In the processing, the AI/ML model 132 can rely on the generated column names and generated column descriptions from step 165.

In the processing for steps 160, 165, 170, 175, 180, and 185, the requests to the AI/ML models 132 can be considered separate requests, which do not maintain context from one request to another. In other words, the full input, context, and output of one request or step is not maintained and propagated for requests for other tables or for other steps. Nevertheless, the information generated during the processing by the AI/ML model 132 is often used in later steps. For example, the semantic roles, data types, and data formats determined in step 160 can be provided to assist in generating column names and column descriptions in step 165. In addition, the generated column names and column descriptions (as well as potentially semantic roles, data types, and data formats) can be used to perform attribute grouping 170, table relationship analysis 180, and attribute linking 185. These processes of incrementally building the data model 156 through a series of different types of requests to the AI/ML models 132 helps ensure accuracy and reveal errors and inconsistencies where they can be corrected or brought to the attention of the user. For each of the steps, 160, 165, 170, 175, 180, and 185, the computer system 110 can use a different instruction or set of instructions to the AI/ML models 132. As a result, the computer system 110 selects the appropriate predetermined instruction appropriate for each stage of processing.

Referring again to FIG. 1B, after performing the other steps, the computer system analyzes the proposed changes 190 to the data model 156. Many types of changes, such as the generation of column names and the detection of data types and data formats can be applied automatically where there is high confidence or high consistency among the data set 122a-122b. The computer system 110 can validate relationships, attributes, attribute forms, inferred keys, and other outputs to determine whether they meet predetermined criteria for that type of modeling output.

The computer system 110 then updates the data model 156 and indicates recommendations 195. In some implementations, changes that have at least a minimum level of confidence or that satisfy corresponding rules or criteria can be applied automatically. Items that have lower confidence, or have inconsistencies, can be provided as recommendations, for the user to approve or adjust. In some cases, the data modeling changes made using the process 159 lead to other recommendations. For example, the detection of a data type and data format in the process 159 can lead to the computer system 110 attempting to standardize a column's data or to identify outliers or missing values. The data modeling information generated in the process 159 using the AI/ML models 132 can thus lead to additional data cleansing and data enrichment recommendations (e.g., to change the format of certain rows that do not follow the identified format for the column, to fill rows identified to be missing data, to identify outlier values or values that do not fit the data type for the column, and so on.

The various steps of the process 159 result in the automatic creation of relationships, hierarchies, attributes, attribute forms, metrics, etc., including related information such as primary keys, lookup table identification and more. The computer system can translate this data into recommendations based on the confidence level of different relationships, attributes, or other data. One way that the computer system 110 can do this is by using vector similarity to compare to other characteristics of other data sets. For example, the computer system 110 can store vector embeddings that represent well-formed properties of data sets, and the computer system 110 can use vector search functionality to determine whether there are other similar attributes, relationships, or other items or properties. The greater the similarity to data set characteristics known to be correct, even if for other data sets or contexts, the higher the confidence can be. The computer system 110 can use rules as well. For example, most multi-form attributes do not have more than two fields or related columns. The computer system 110 can have a rule to automatically create attribute forms of two fields, but if an attribute form with more than two is indicated, then add this as a recommendation for the user to see and accept before adding it to the data model 156.

In general, the computer system 110 generates and provides recommendations after a user adds new tables. To avoid showing disconcerting changes to a data model 156, the computer system 110 can avoid making changes after a user has saved it, unless the user initiates an update cycle or adds a new table. The computer system 110 can show generating new recommendations or refreshing recommendations as an option that the user can initiate. In general, actions such as identifying attributes and metrics and setting names and descriptions are done automatically, without requiring a user to view and accept a recommendation. For relationships (e.g., between tables or columns), the system 110 can provide a user-selectable setting whether to automatically create attribute relationships or not. If automatic creation is enabled, then the computer system 110 can apply a threshold, such as a minimum 90% confidence or more, for automatic creation of attributes, and candidates with lower confidence are suggested as recommendations.

FIG. 1L shows interactions that the computer system 110 can use to perform generation and editing of SQL statements. For example, when a user asks for a metric to be created or edited, or if a user discusses a SQL query to be generated or edited, the computer system 110 can interact with the AI/ML models 132 to request the generated SQL or edited SQL. For example, the computer system 110 can have an SQL generator module that manages requests to an AI/ML model 132. The computer system 110 provides context to the AI/ML model including a database schema or existing content of a data model. A user's request or instructions, such as a question or request from the user, can be provided, along with potentially existing SQL statements to edit, correct, optimize, or explain. The computer system 110 can also provide a system instruction that explains the function the model 132 should perform. The AI/ML model 132 then generates and outputs the SQL statement or natural language explanation of a SQL statement, as requested by the user or the system.

The SQL generator 196 can be used to implement changes or carry out requests a user makes through a chatbot interface for the purpose of data cleansing, data modeling and data enrichment. As an example, in the context of importing a data set or generating a data model, the user may provide a user prompt in a chatbot interface, “union these tables.” The user did not request to create a SQL statement, and simply entered the request in the chatbot assistant for data modeling. Nevertheless, the computer system 110 uses the SQL generator 156 to generate the SQL statement to carry out the request. The computer system 110 uses the state of the user interface (e.g., data from the client device, provided over the network 102, indicating the user selections or state of the user interface) to determine the appropriate context for the request. In this example, the user has selected two tables or has two table open for editing or data modeling. The computer system 110 provides the user prompt with the information about the applicable tables and the information about the content of the tables (e.g., data schemas, or existing data model content), and instructs the AI/ML model 132 to generate a SQL statement that will carry out the join. In response the AI/ML model 132 outputs the SQL statement that will perform the join of the applicable tables. The computer system 110 saves the resulting union in the data model 156, and the joined tables become accessible as a table in the data model 156.

FIG. 1J shows examples of techniques that the computer system 110 can use to automatically perform metric creation using AI/ML models 132. Metric creation can be used to generate new logical data objects in the data model 156 from one or more columns of data. Metrics can be data objects that represent various types of operations on data (e.g., mathematical operations sum, mean, maximum, minimum, etc.), as well as filtering, aggregation, sorting, and more. The created metrics can then be provided as logical data objects in the data model 156 that can be re-used, e.g., shown on user interfaces for users to select, provided for chatbots to access, and so on.

In general, the metric creation process can enable a user to simply type a request, e.g., “create a metric for monthly sales” and the computer system 110 uses the AI/ML models 132 to generate the metric definition automatically. Through multiple interactions or operations, the computer system 110 can identify (1) the columns or data objects to be operated on (e.g., a column of sales data and a column with date information), and (2) the function to apply (e.g., aggregate), and then combine the elements to define the metric (e.g., a formula that aggregates values in the sales data column by month using data in a date column).

Metric creation can include three main steps or stages, keyword extraction 197, metric searching 198, and metric creation 199.

The keyword extraction 197 can involve the computer system 110 making a request to the AI/ML model 132 that includes the user prompt and names for attributes and metrics in the current data set(s). The computer system 110 provides an instruction for the AI/ML model 132 to identify keywords in the prompt, such as items to be represented or to be components or results of the metric. The keyword extraction can be used to identify words representing functions to be performed as well as the data objects to be operated on and parameters to apply. The AI/ML model 132 provides output of keywords, extracted from the user prompts. The AI/ML model 132 infers the important keywords from both semantic information and from the context of the data set(s) used.

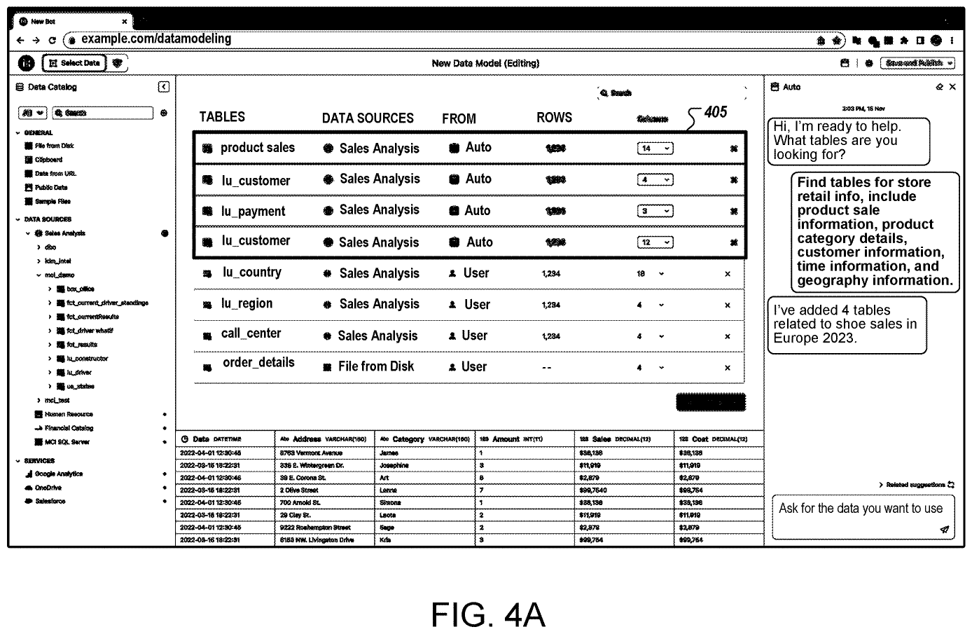

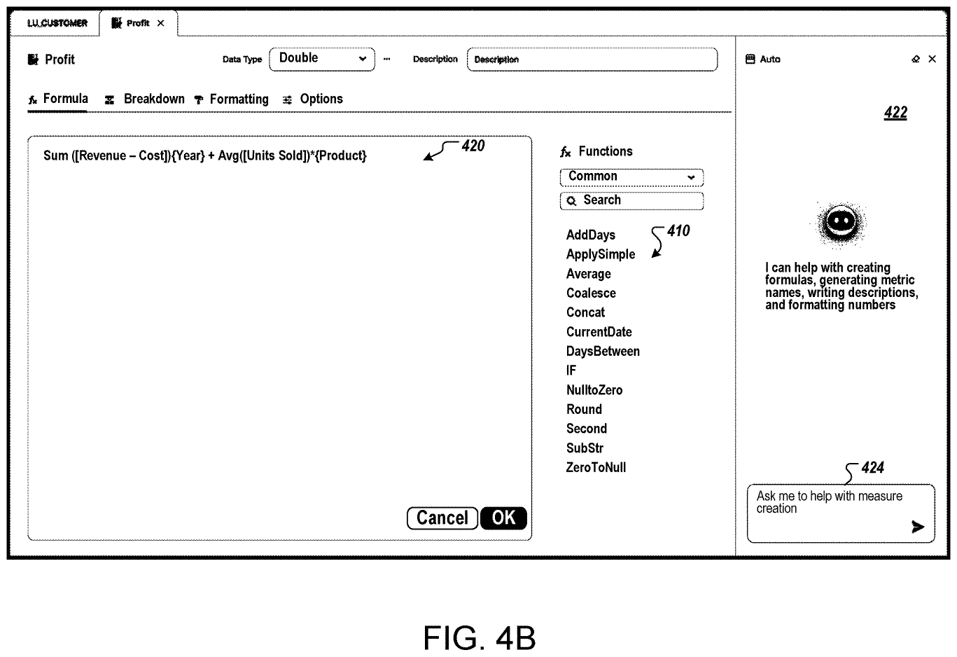

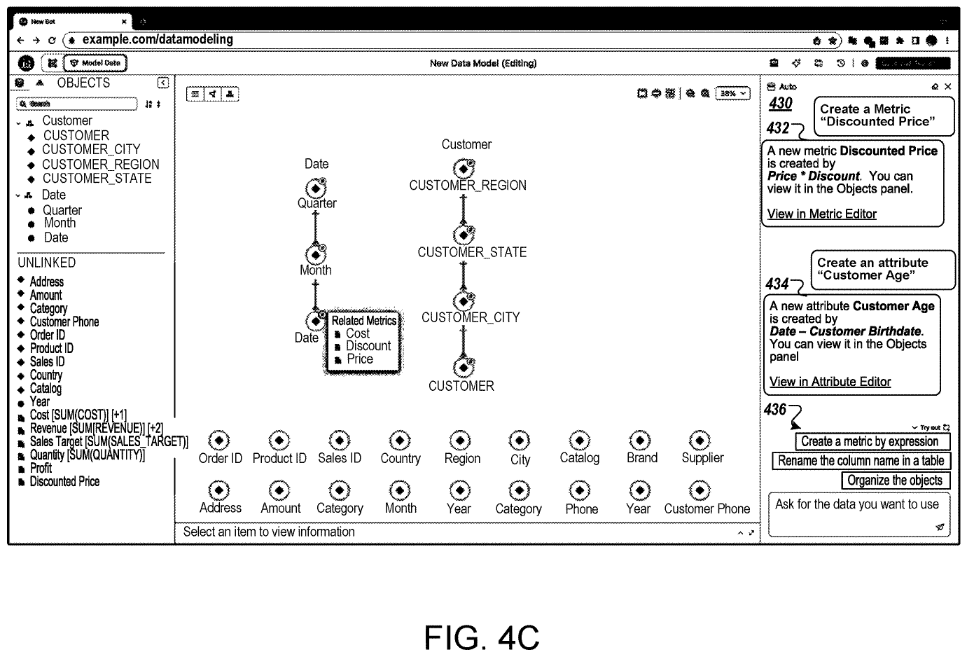

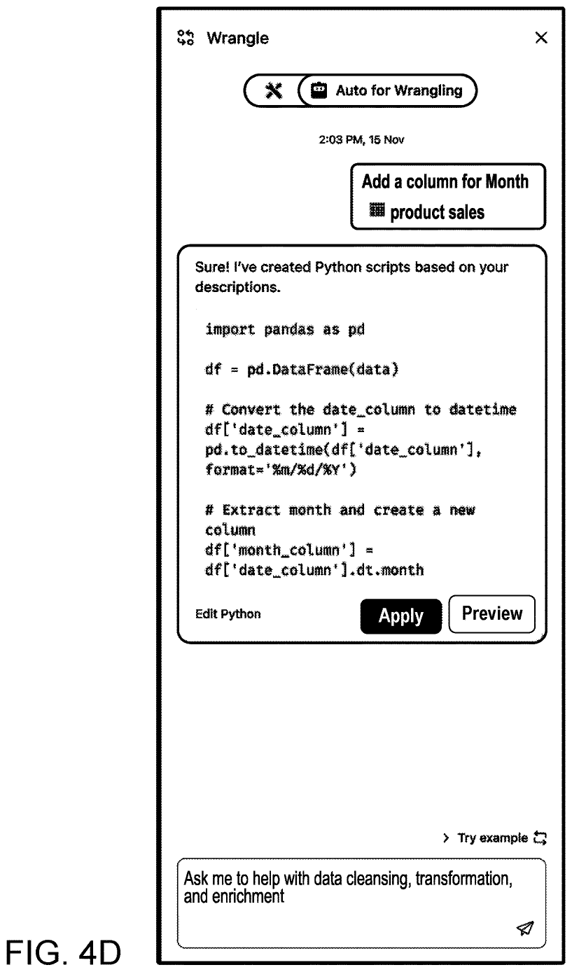

The metric searching 198 involves searching an index or database for functions to be applied in the metric being created. In general, this does not involve an LLM, but instead can include using semantic search techniques, such as searching content of a vector database 150. In some implementations, the computer system 110 has a vector store of function definitions, each representing a different function (see FIG. 4B, listing a few example functions 410). The computer system 110 uses semantic searching, e.g., vector similarity or vector distance searches, to identify the functions that are closest semantically to the extracted keywords. For example, the computer system 110 can generate vector embeddings from the extracted keywords, and compares them with stored vector embeddings for the function definitions of various functions. The function that is closest in the vector space can be selected as the function to use for the new metric.

In some implementations, the computer system 110 additionally or alternatively searches for example metrics, not only the particular function to apply. For example, the computer system 110 can store in a vector database 150 or other vector store vector embeddings for various metrics that have been created for various data sets. The computer system 110 can use vector embeddings for extracted keywords to retrieve the semantically closest example metrics or metric templates, which can provide more detail than a function definition alone. In general, the metric searching 198 can searches the vector store to find closest items matches based on similarity of vectors (and thus concepts) to stored items (e.g., a RAG retrieval step, not involving an LLM). Similarity search can use any of various techniques, such as nearest neighbor search, k-means clustering, proximity graphs, product quantization, etc.

Metric creation 199 involves the computer system 110 sending to the AI/ML model 132 the user prompt, the names of attributes and metrics, and the function definitions and/or metric definitions retrieved using vector similarity. The computer system 110 instructs the AI/ML model 132 to create a metric expression based on the user prompt, using the attributes and metrics available from the data sets. The provided function definitions or metric definitions provide the most like functions or templates that will meet the user's needs. The AI/ML model 132 outputs a metric expression that references the attributes and metrics of the data sets. The computer system 110 shows the formula to the user (see FIG. 4B) and/or saves it in the data model 156.

The computer system 110 can instruct the AI/ML model 132 to also provide a natural language text description to accompany it. In some implementations, this is performed as a separate interaction with the AI/ML model 132 that provides the metric formula and information about the data sets (e.g., the names and descriptions of the attributes and metrics), and instructs for an explanation to be generated.

In some cases, a user interface for metric creation can be provided, and from the context of this interface, the intent to create a new metric is already known. For example, if a user enters text in a particular field, or in a chatbot field while on a page or tab for creating a metric, the user may simply enter “monthly sales” and the computer system 110 automatically invokes the automatic metric creation, without requiring the user to enter a user prompt that specifically requests metric creation. Similarly, the computer system 110 can provide suggested queries that specify different types of metrics, and user selection of one of the suggested queries (which simply include a type of data such as “West region profit” or “average revenue”) causes the automatic metric creation to be invoked so the metric is created, with a formula and natural language description, and then shown to the user and/or saved in the data model 156.

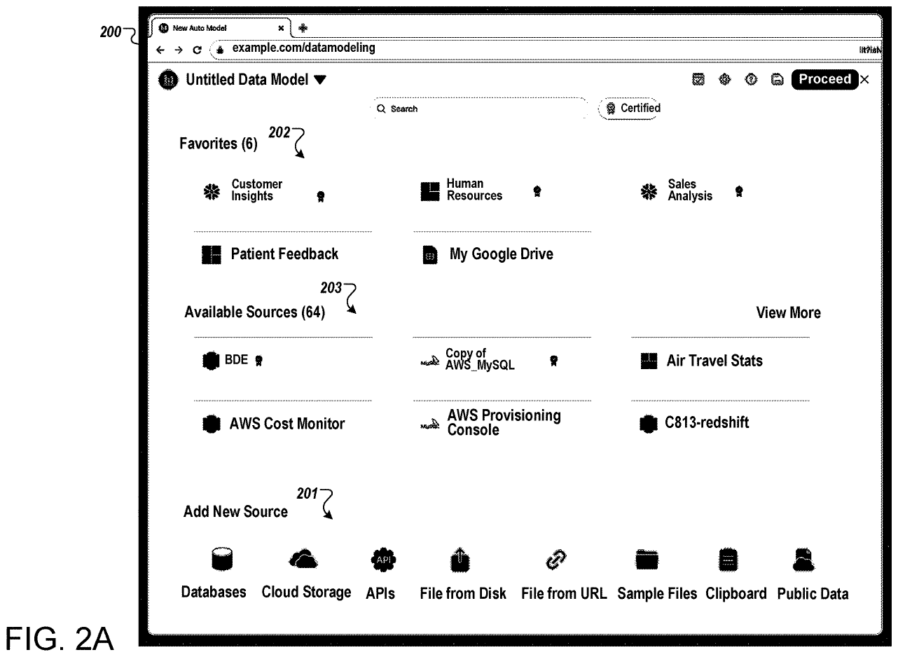

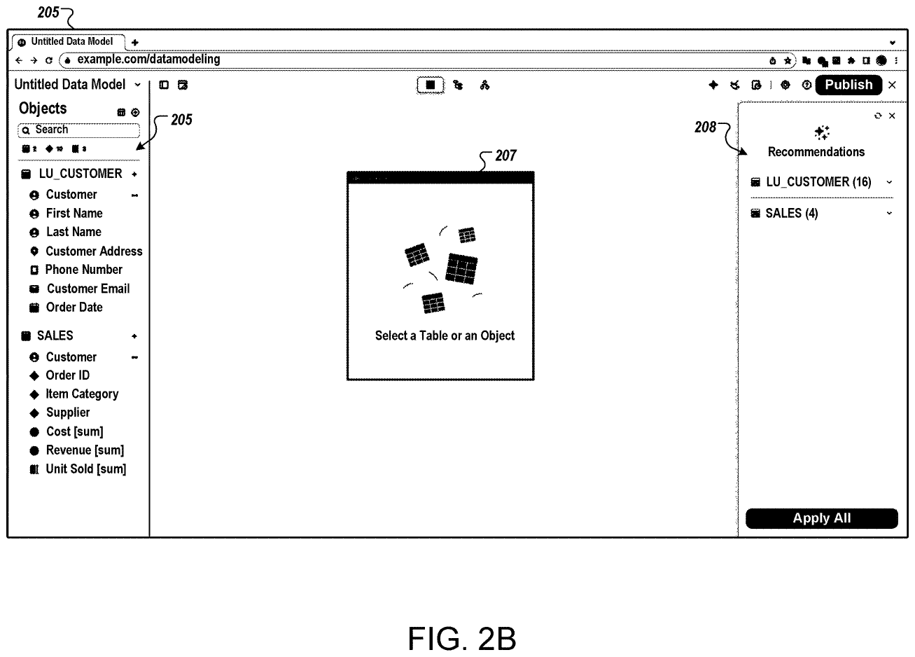

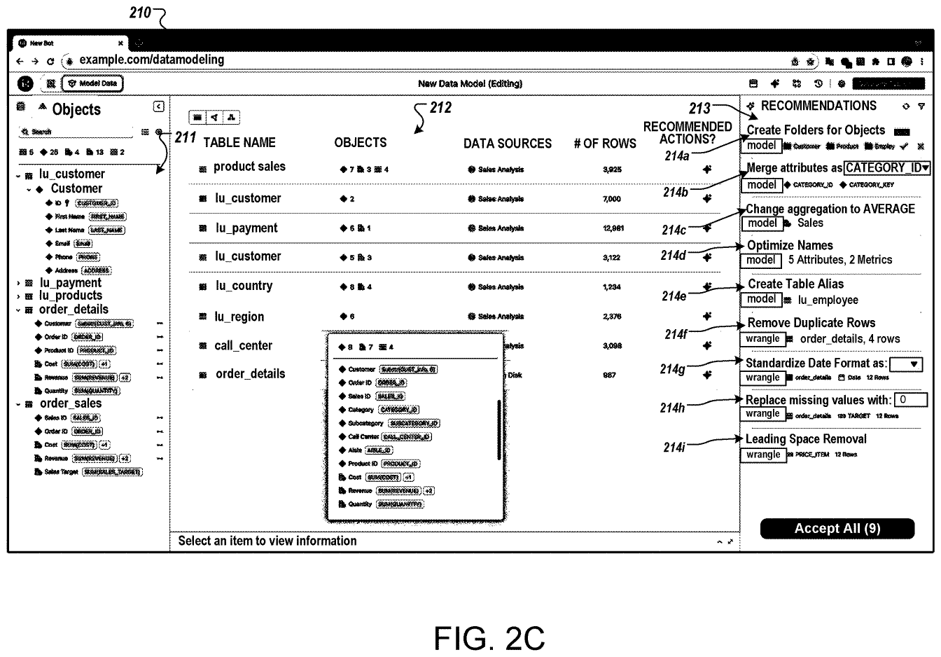

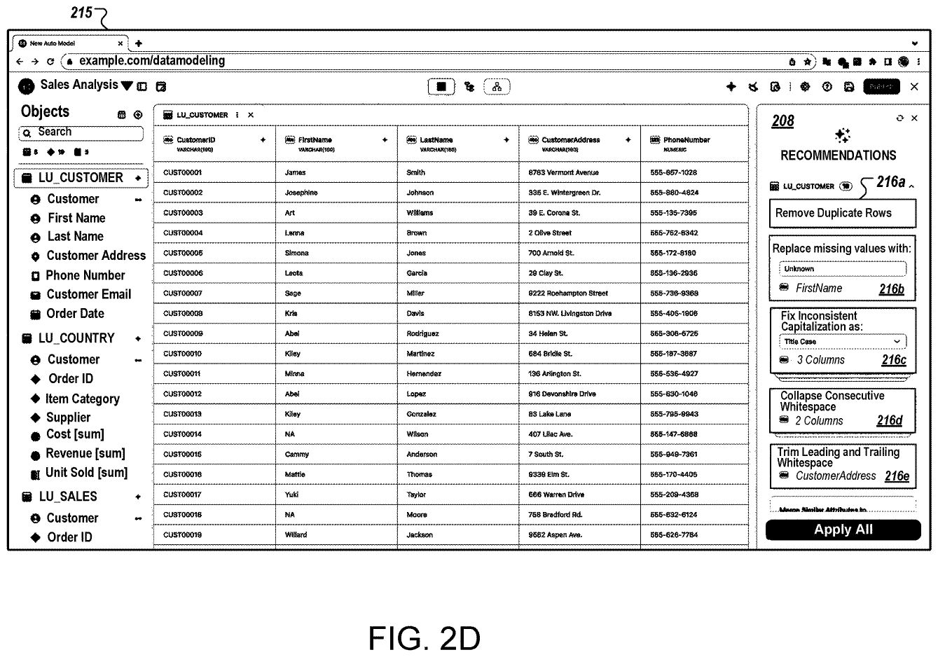

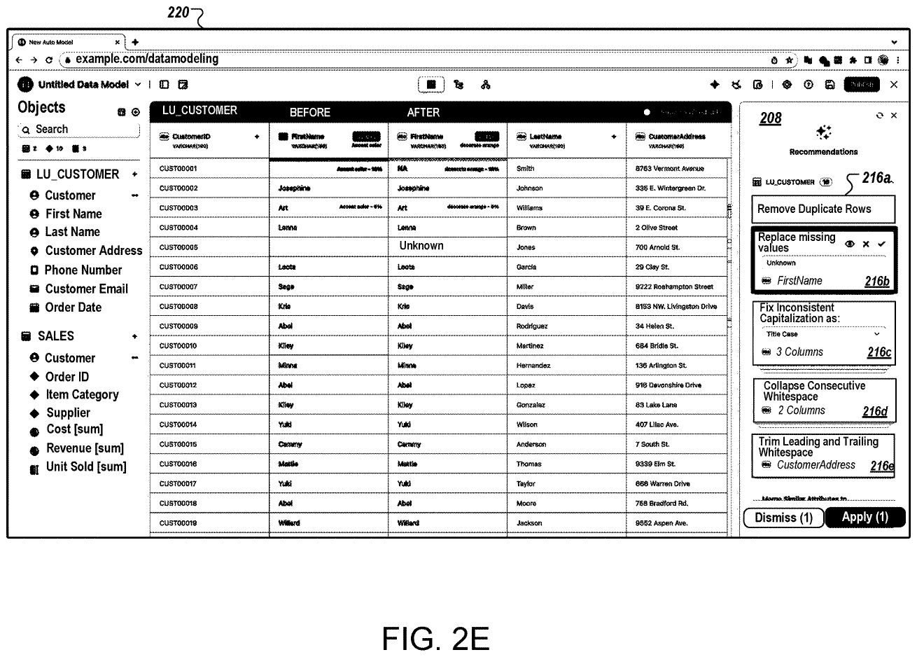

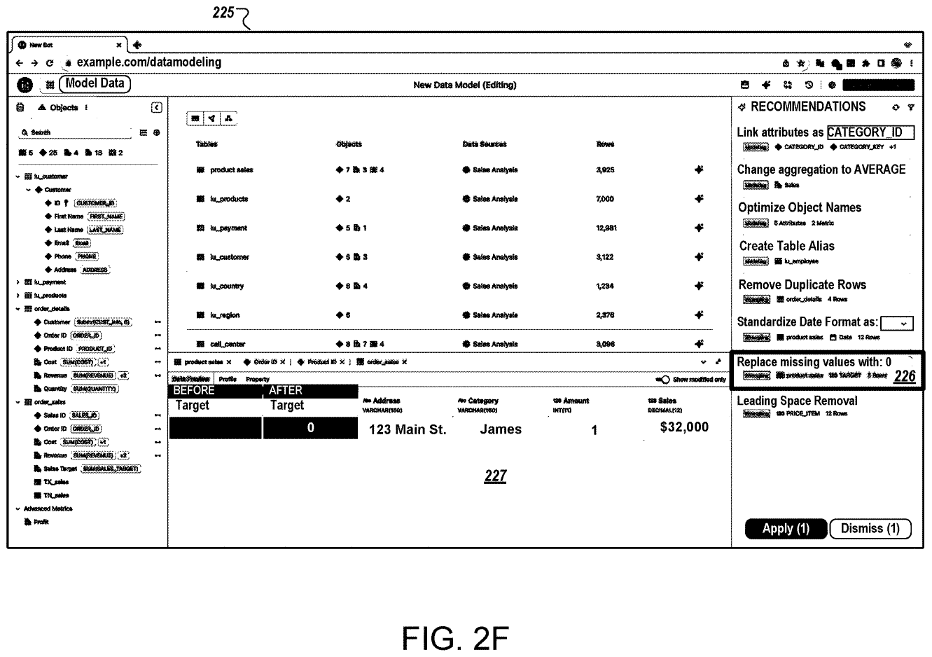

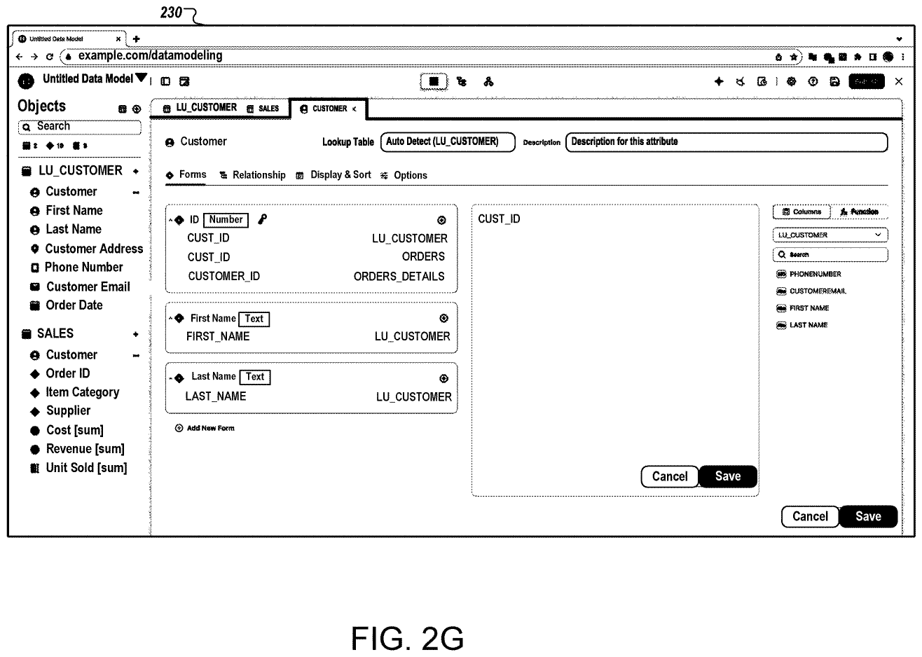

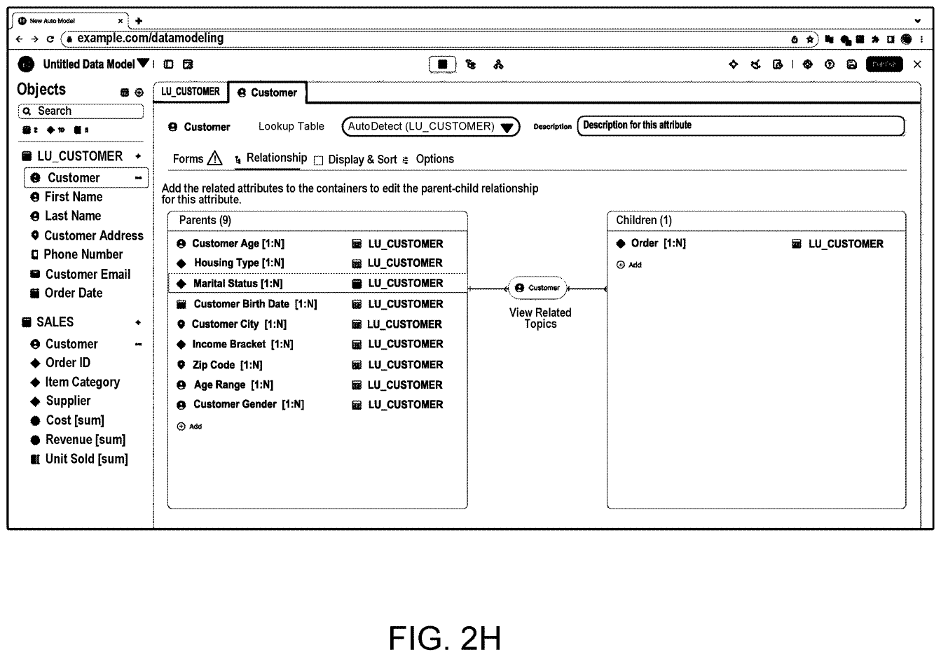

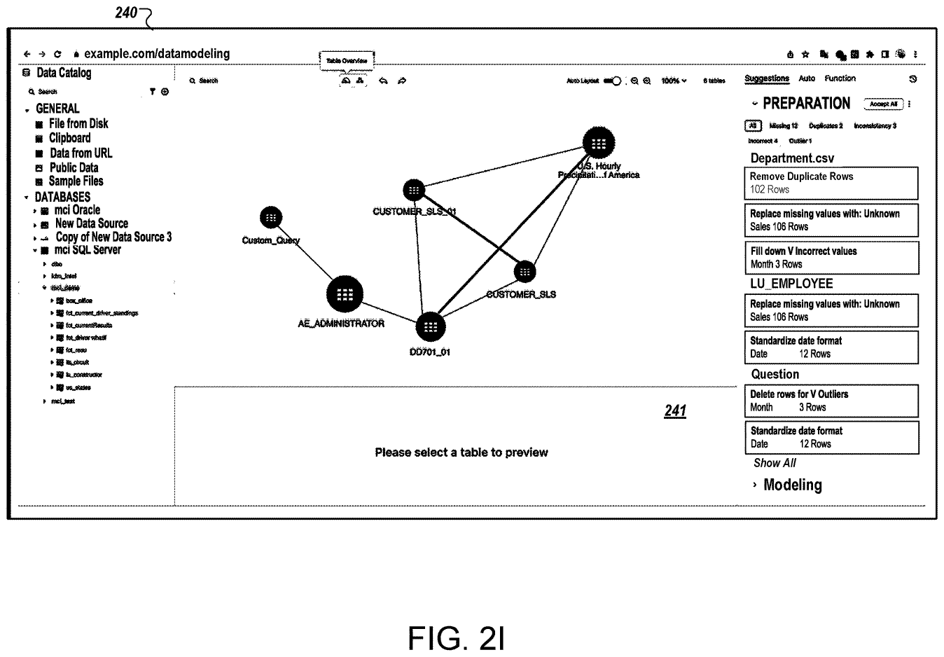

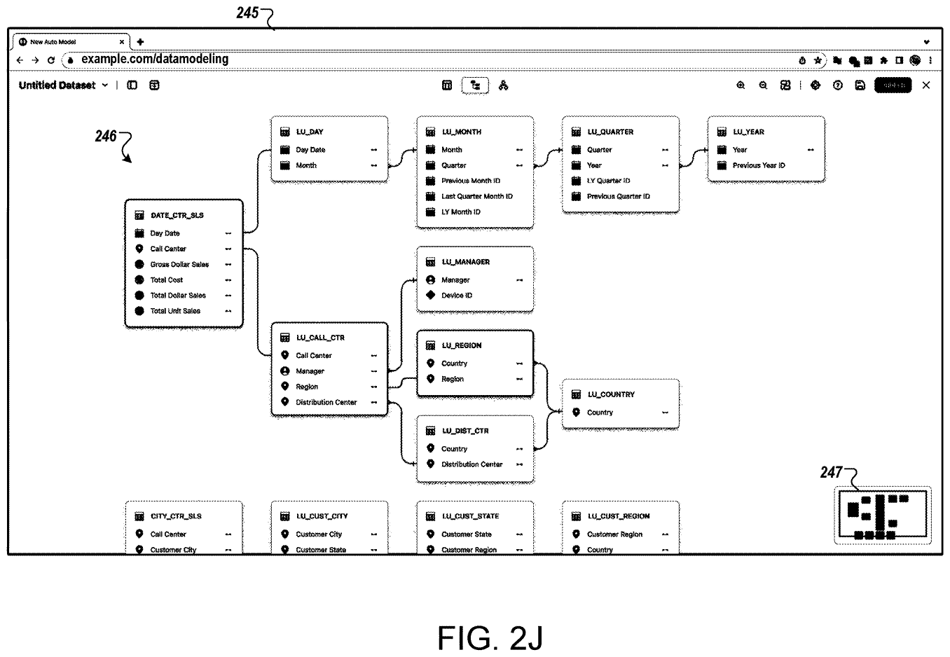

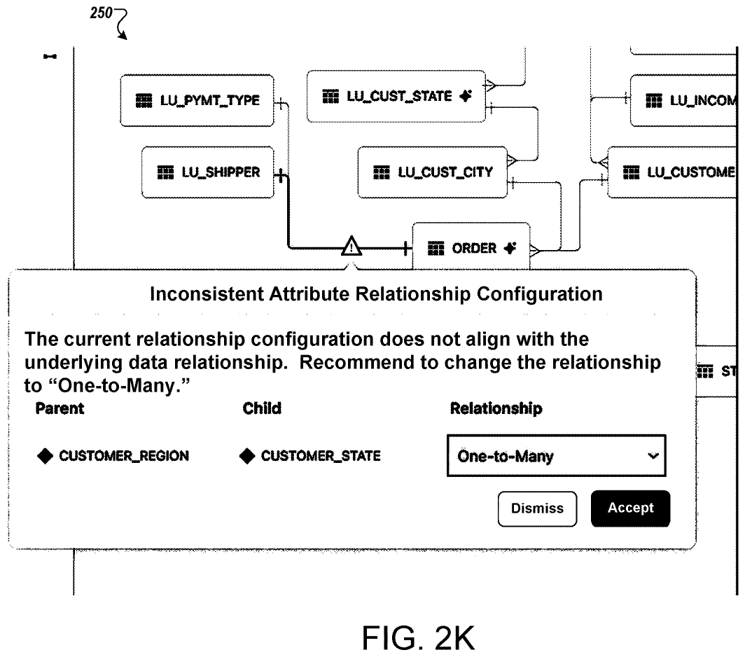

FIGS. 2A-2K are diagrams showing examples of user interfaces for data modeling and data adjustment using artificial intelligence or machine learning. The user interfaces in the examples are shown in a web browser of a client device of a user, such as the a web browser of the user device 106 of the user 105. The computer system 110 sends data over the network 108, including recommended actions for data modeling and data adjustment, for presentation in the user interfaces. In some implementations, the data modeling interface can be provided as a web page, a web application, content of a native application executing on a client device, and so on.

The computer system 110 can also use the techniques described in Appendix A to create data models, enrich data, cleanse data, and perform other operations.

FIG. 2A shows a user interface 200 for selecting data sources to describe in a data model. The user interface 200 can be shown in a process or interface for creating or editing a data model. The user interface 200 allows a user to select from many different sources 201, such as databases, cloud storage, data available from application programming interfaces (APIs), files from disk, files from a URL (e.g., accessed over a network), samples files, data from the clipboard, or public data. Other data sources that are frequently or recently used by the user or the user's organization can be shown also, e.g., data sources 202 showing databases or data sets Customer Insights, Human Resources, Sales Analysis, Patient Feedback, or Google Drive. Similarly, other available data sources 203 known to the system include spreadsheets, a MySQL database, data sets available from cloud computing sources such as Amazon Web Services (AWS), and so on.

The system can be configured so that, in response to the user selecting one or more data sets or data sources, the computer system 110 begins to analyze the selected data and characteristics of the data (e.g., columns, labels, data object relationships, etc.) to identify, assess, and generate code for data modeling actions or data adjustments (e.g., data cleansing, data wrangling, data enrichment, etc.).

FIG. 2B is a diagram showing another user interface 205 for selecting data sources for a data model. The user interface 205 shows a state after a user has selected two databases, labeled LU_CUSTOMER and SALES, to be described in the data model. The user interface 205 shows an object region 206 showing the data objects (e.g., attributes, metrics, facts, etc.) identified from the data sources. The user interface 205 includes a central region 207 that includes one or more interactive controls for a user to select additional data sources or data sets. The central region 207 can include a drop target for a user to drag and drop items (e.g., files, links, references, etc.) to add them to the data model being created or edited.

The user interface 205 includes a recommendation area 208 that shows set of recommendations that the computer system 110 determined using output of the AI/ML models 132. The recommendations are shown grouped according to the data source or data set that they correspond to, and in the current view, are collapsed to show the total number for each data source. For example, there are 16 recommended data modeling or data adjustment actions for the LU_CUSTOMER database or table, and 4 recommended data modeling or data adjustment actions for the SALES database or table. The recommendation area can include one or more interactive controls, such as buttons or selection controls, that enable a user to accept or apply recommended actions as a group, in subgroups, or individually. In some implementations, the recommendation area 208 can include what are more controls to dismiss or ignore recommended actions. In addition, the recommendation area 208 can include a control to initiate analysis to refresh or obtain new recommended actions. The recommendation area 208 can be provided as a panel or pane of the user interface, and the recommendation area 208 can be hidden or displayed based on interactions of the user (e.g., buttons or icons that trigger the recommendation area 208 to be shown or hidden).

FIG. 2C is another example user interface 210 for creating or editing a data model. The user interface 210 shows a workspace where the user 105 can view characteristics of the data set(s) selected and the data objects and relationships of the data model. The user interface 210 shows an object region 211 that shows a hierarchy of different data sources or data sets, and the different data objects (e.g., attributes, attribute forms, metrics, facts, etc.) that have been identified or defined in the data model for the data. In this example, there are various different tables, labeled lu_customer, lu_payment, lu_products, order_details, order_sales, and so on. Each of these items can be expanded to show data objects that are included in or are derived from the corresponding table. For example, the lu_customer table has an attribute form labeled “Customer,” and there are several grouped attributes (e.g., ID, First Name, Last Name, Email, Phone, and Address) that are grouped together in the attribute form. Each data object can be represented with, for example, an icon indicating the type of data object, a label (e.g., a natural language or human-readable name), and an identifier (e.g., a column name or identifier in the table).

The user interface 210 includes a central region 212 that shows additional information about a portion of the data set or data model that the user 105 has selected to view or edit. In this case, the central region 212 shows information about various tables being described in the data model, including columns that respectively indicate the table names, number and type of objects (e.g., number of attributes, number of metrics, etc.), the data sources the tables were obtained from, the number of rows in each table, and an icon indicating whether there are recommended actions for the table. The elements in the central region 212 are interactive to bring up for display more detailed information. In the example, the user 105 has clicked or hovered over an element for the object types for the call_center table, which triggers display of a detail pane listing, for example, the 8 attributes and 7 metrics that are defined or available for that table.

The user interface 210 includes a recommendation area 213 that shows a set of recommended actions for data modeling and data adjustment that the computer system 110 has determined. As discussed above, the computer system 110 can automatically select and recommend changes to a data set (e.g., for data wrangling, data cleansing, data enrichment, etc.) and/or to a data model. The computer system 110 can initiate the processing to identify, assess, and implement these changes automatically and in the background, without requiring the user to request changes or recommendations. In some implementations, an icon or symbol is shown when recommended actions are available, and the user 105 can interact with the icon to cause the recommendation area 213 to be displayed.

The recommendation area 213 shows various different proposed changes to the data model or the corresponding data set(s). Each recommendation item includes a brief statement of the type of change to be made, an indication of the data objects that would be affected, a category of the change (e.g., data modeling or data wrangling). In some cases, the recommendation item includes one or more interactive items, such a text field or drop-down box, so a user can enter or select parameters for making a change.

The first recommended item 214a is to create folders for objects, and the item lists objects (e.g., Customer, Product, Employee) for which folder creation is recommended. The recommended item also includes a check symbol that the user 105 can interact with to apply that specific change, or an “x” symbol that the user 105 can interact with to dismiss the recommendation. The computer system 110 can identify that this proposed change is appropriate based on policies or knowledge base data that specify best practices for folder structure. This information can be provided to the AI/ML models 132 with a request to identify and/or assess potential changes, and the AI/ML models 132 can indicate that changes would be needed for the folder structure to align with the standards or policies provided to the AI/ML models 132.

The second recommended item 214b is to merge multiple attributes as a specific attribute or attribute form. Here, the computer system 110 has provided information to the AI/ML models 132 describing the data objects available, and the AI/ML models 132 generated output indicating that the attribute CATEGORY_ID and CATEGORY_KEY appear to include same or similar type of data, or serve a similar function, and so should be merged. The computer system 110 can additionally perform a statistical analysis of the values for the two columns, to determine whether there are shared values, a shared data format, a shared data type, and so on. The computer system 110 can use this information to validate and assess the appropriateness of the recommendation from the AI/ML models 132. As another example, the computer system 110 can provide the statistical analysis results as input to the AI/ML models 132, which the AI/ML models 132 can use to more accurately generate its indication of changes to be made.

The third recommended item 214c is to change the aggregation function used for a particular metric, labeled “Sales,” to average. The computer system 110 can support various different types of aggregation, such as maximum, minimum, average, and so on. The computer system 110 can provide information describing these functions and circumstances for which the different functions are best suited in input to the AI/ML models 132. In addition, the computer system 110 can provide the AI/ML models 132 information about historical recommendations that were accepted by users and/or data models that were created and the aggregation functions selected for different types of data objects. With this information, the AI/ML models 132 can apply the historical data to determine which aggregation function would be appropriate for a particular data object, taking into account the data format or data type and the semantic meaning of the data indicated by the labels and context. Similarly, the computer system 110 can identify metrics that do not have an aggregation function specified and can select, based on rules and policies and/or output of the AI/ML models 132, which aggregation function should be used. In the recommendation item, the aggregation function can be shown as a drop-down box having a list of aggregation functions, so the user can change the aggregation function to a different option if desired.

The fourth recommended item 214d is to optimize names of various attributes and metrics. The recommended item indicates that there are 5 attributes and two metrics that are proposed to be changed. For example, this can include providing a plain language or human readable name or label instead of a column identifier from the data set. The AI/ML models 132 can identify when an appropriate name or label is missing and then generate names from the information about the data set that is provided to the AI/ML models 132. For example, metadata and description information for data sets can be provided to the AI/ML models 132, along with historical data or statistical data indicating other datasets, their data objects, and the appropriate titles or labels for their data objects. The AI/ML models 132 can use the previous records, along with any rules or policies provided by the computer system 110, to infer appropriate names for data objects.

The fifth recommended item 214e is to create a table alias for a particular table, e.g., lu_employee. For example, this item 214e can be a name or label for a table, inferred by the AI/ML models 132 in a similar manner that names or labels are inferred for other data objects.

The sixth recommended item 214f is to remove duplicate rows in the table labeled order_details. The computer system 110 can provide information that describes conditions or data characteristics for the AI/ML models 132 to detect and identify. The presence of duplicate rows can be one of those conditions or characteristics. In some implementations, the computer system 110 can itself apply rules and policies to detect conditions such as duplicate rows, and can then specify a change to remove the duplicates as a recommended item. In the example, the recommended item 214 F shows the name of the affected table as well as the number of rows identified as duplicates to be removed (e.g., 4 rows).

The seventh recommended item 214g is a recommendation to standardize the date format used in a date attribute of the order details table. The recommended item 214g indicates that 12 rows have values that would be updated by this action. The computer system 110 can detect the need for standardization based on its own analysis and processing of the data sets identified for this data model. As another example, the computer system can generate statistical information and characterization data describing the formatting and types of data in the data set, and can provide that information to the AI ML models 132, so the AI/ML models 132 identify and infer the need for standardization and the type of standardization to perform. In general it is not efficient or desirable for the AI/ML models to access large amounts of underlying data. As a result, it is more efficient and preserves the privacy of the customers data if the computer system 110 analyzes the data and provides statistics or characteristics to the AI/ML models 132, without the need to reveal the actual data content to the AI/ML models 132 and without the need to transfer data sets to the AI/ML service provider 130 over the network 108.

The eighth recommended item 214h is to fill in empty fields for a data object, labeled “target,” in the order_details table. The recommended item 214h indicates that 12 rows are affected and have missing values for the “target” data object. The recommended item 214h has a text field where the user 105 can view and edit the value to be populated in the empty fields. The computer system 110 can apply rules and policies to determine when information is missing for data object and what the replacement data should be. The computer system 110 can also provide information to the AI/ML models 132 and leverage the AI/ML models 132 to identify or infer which values should be populated in empty fields. For this information, the computer system 110 can provide the AI/ML model records of previous contexts in which empty fields were identified and filled, along with metadata and data object characteristics the assist the AI/ML models 132 to accurately determine appropriate changes.

The ninth recommended item 214i is to remove leading whitespace from values of a particular data objects labeled PRICE_ITEM. As with other data wrangling and data cleansing operations, the computer system 110 can analyze the data set to identify conditions, such as leading or trailing white space, and then apply rules or policies to surface corrective actions as recommended items. In addition, the computer system 110 can use the A/ML models to confirm or assess the appropriateness of the changes, based on the characteristics and statistics that the computer system 110 generates.

For any and all of the recommended items 214a-214i shown in the recommendation area 213, or for other recommendations, the processing to generate the recommendations and/or to carry out the recommended actions can be performed as combination of processing of the computer system 110 and processing of AI/ML models 132. As discussed above, the AI/ML models 132 can be used in many instances to identify when a change or other action is appropriate. In other cases, the computer system 110 may be able to more directly identify when a certain type of change is appropriate, such as for missing values or non-standard data formats. For all of these cases, however, the computer system 110 can leverage the AI/ML models 132 to generate interpretable or executable code to carry out the recommended action. For example, even if the computer system 110 can determine by its own processing that missing values are present in a data set, the computer system 110 may still interact with the AI/ML models 132 to select appropriate value(s) to fill in those empty fields, and the determination may be made row by row based on other context, as a group (so all empty fields are populated with the same new value), or in another manner. In addition, the computer system 110 can instruct the A/ML models 132 to generate code for a function that will find and fill empty fields with the appropriate values.

FIG. 2D is another example of a user interface 215 that shows another example of recommended actions for data modeling or data preparation. The example shows the recommendation area 208 from FIG. 2B, but with the set of recommendations for the LU_CUSTOMER table expanded to show individual items. This view shows a recommendation 216a to remove duplicate rows, a recommendation 216b to replace missing values in the FirstName column with a particular value (e.g., “Unknown”), a recommendation 216c to fix inconsistent capitalization to title case for three columns, a recommendation 216d to collapse consecutive whitespace for two columns, and a recommendation 216e to trim leading and trailing whitespace for values in the CustomerAddress attribute. Other recommendations for the table are not shown but can be accessed by scrolling the recommendation area 208.

Alongside the recommendations, the user interface 215 also shows a view of data from the table, which provides context for the recommendations. In some implementations, selecting one of the recommendations 216a-216e causes the user interface 215 to show a preview area or a more detailed overlay providing more information about the recommended change and slash or the effects on the data model or data sets.

FIG. 2E shows another example user interface 220 showing the result of these are one of five interacting with a specific recommendation 216b. This causes the user interface to 20 to be updated in a few ways. First, compared to the user interface 215 in FIG. 2D, the center portion of the user interface 220 now shows a before and after comparison for the first name column, showing how an empty field would be replaced with a value. The controls at the bottom of the recommendation area 208 are also updated, so the user can apply or dismiss the specific selected recommendation 216b individually. The user interface presentation of the recommendation 216b is also updated to include controls for the user to dismiss (an “x” icon) or accept (a check icon) the recommendation. Other controls can be provided, such as to view the generated code or other operations that would be performed by accepting the recommendation 216b.

FIG. 2F is an example user interface 225 showing that when the user 105 selects a particular recommendation 226, a preview area 227 can be updated to show the results of the recommended change. In this case, a setting is applied to limit the preview to modified records only, which helps make isolate the changes that will occur. In this case, the selected recommendation 226 is a change to replace missing values of the “target” data object with the value zero.

FIG. 2G is an example user interface 230 showing a visualization of a customer attribute form, and the grouping of different related attributes in it. For example, an attribute labeled “ID” is formed by merging three different attributes, the attribute CUST_ID from the table LU_CUSTOMER, attribute CUST_ID from the table ORDERS, and the attribute CUSTOMER_ID from the table ORDERS_DETAILS. Other attributes in the attribute form include a First Name and Last Name. The user interface 230 provides the user 105 controls to edit the attribute form and relationships, including to merge or separate data from different sources. The information shown can also be used to illustrate a recommended change to the user 105, which the user 105 can then choose to accept or reject.

FIG. 2H is an example user interface 235 showing another view of the Customer attribute form in relation to other data objects. For example, the interface 235 shows parent data objects for the Customer attribute form and child data objects for the Customer attribute form. The relationships are specified as either one-to-one (1:1) or one-to-many (1:N). In many cases, the computer system 110 automatically determines proposed relationships among data objects. For example, the relationship of attributes as a parent or child to another attribute, and whether the relationship is one-to-one or not, can be inferred by the computer system 110 which may rely on output of the AI/ML models 132. The computer system 110 can provide the AI/ML models 132 examples of collections of data set characteristics and resulting relationships, as well as criteria for forming relationships among data objects, to guide the AI/ML models 132 in determining relationships to propose to include in a data model.

FIG. 2I is an example user interface 240 showing an example of relationships among various tables. The example shows tables as nodes or icons, with lines between them showing the presence of relationships among the tables. The tables are selectable, and when selected the user interface 240 populates a preview area 241 with data for the selected table. Similarly, the lines or connections between tables are selectable to trigger display of information providing more detail about the type of connection that is present, as well as to allow editing by the user 105 and for the user to accept or dismiss any recommendations the computer system 110 makes for the connection.

FIG. 2J is an example user interface 245 showing connections among tables, but with the table elements represented with larger units showing the data objects contained within. The connections can be determined using the table relationship analysis 180 discussed in FIG. 1G.

FIG. 2K is an example user interface 250 showing a view in which the computer system 110 has identified an inconsistent attribute relationship, and proposes a change to correct the relationship. The system specifies that the current relationship in the data model does not align with the underlying relationship in the data, and recommends to change the relationship to “one-to-many.” For example, the computer system 110 can use information from the table relationship analysis 180 to compare to the current content of the data model 156, and differences from what the table relationship analysis determines can be listed as recommendations or noted as errors to be corrected, as shown in FIG. 2K.

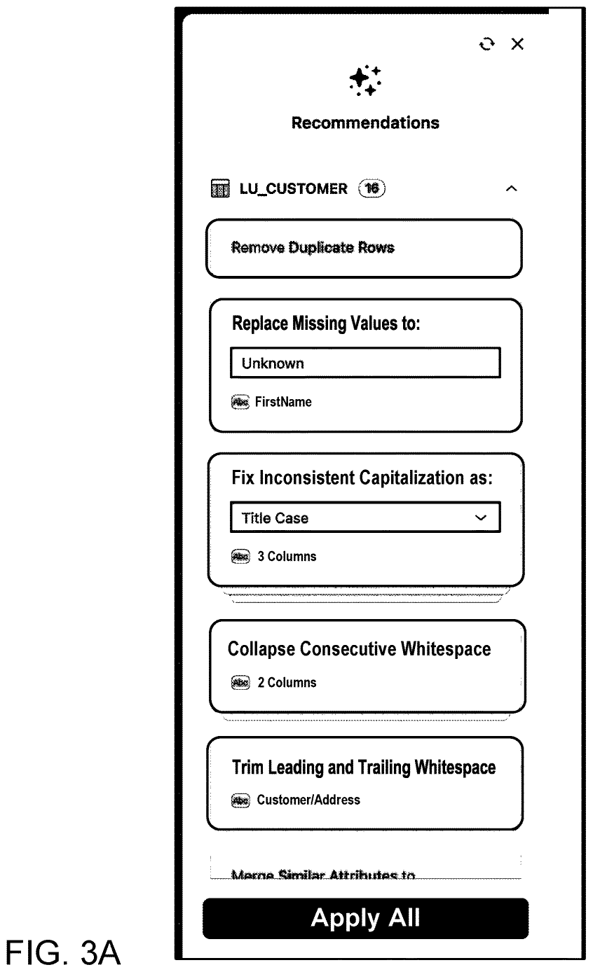

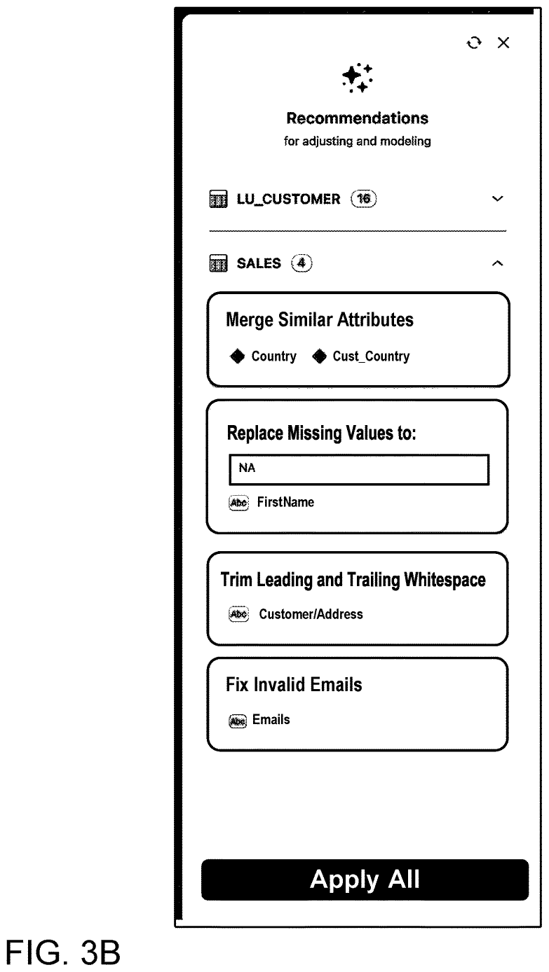

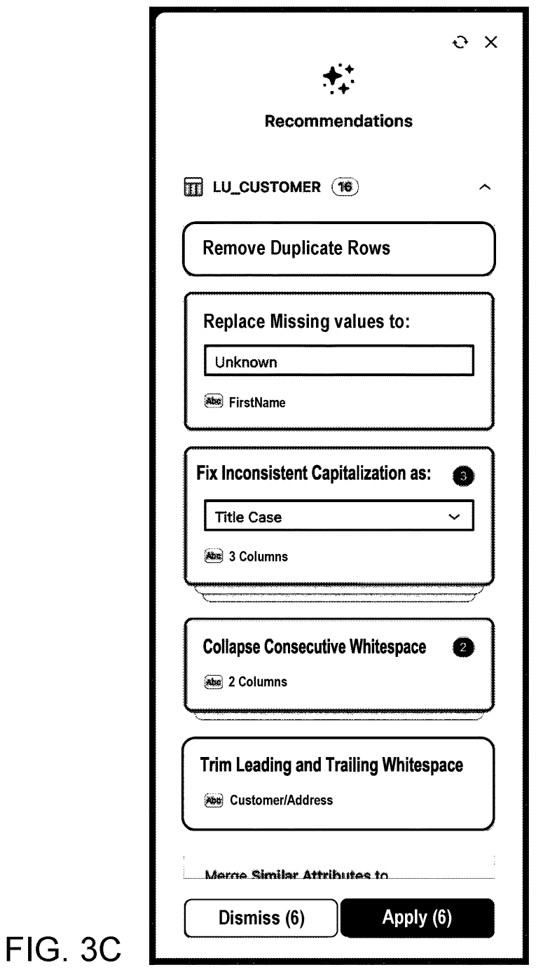

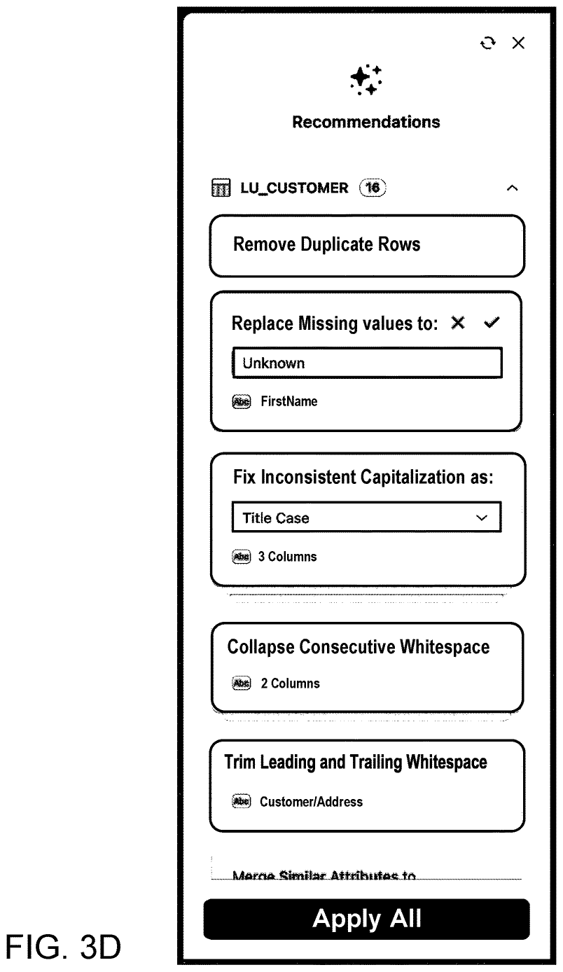

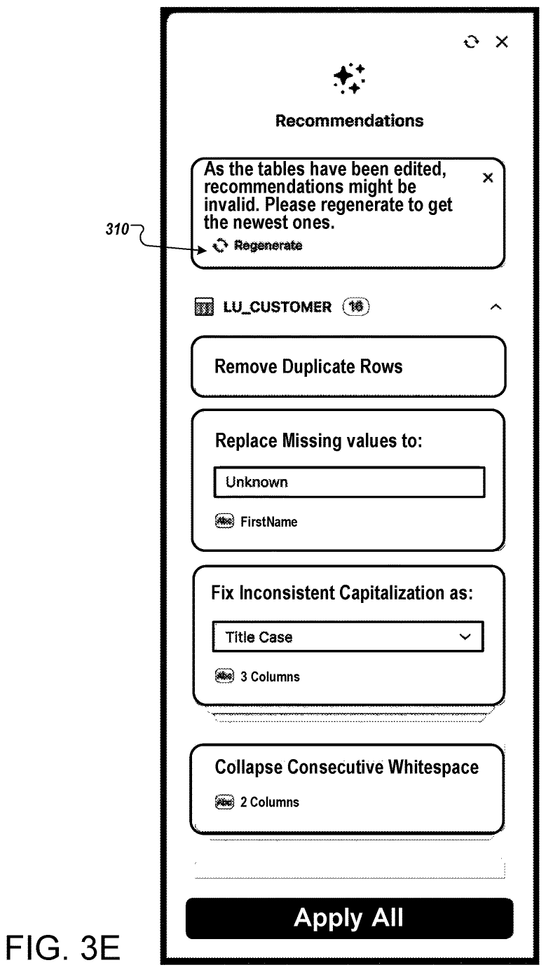

FIG. 3A-3E are diagrams showing examples of user interfaces that indicate automated recommendations for data modeling and data adjustment determined using artificial intelligence or machine learning. For example, the user interfaces show how recommendation areas can be adjusted to allow users to select individual recommendations to apply or dismiss (FIG. 3D, showing an x or checkmark to dismiss or apply a single recommendation), or select groups of recommendations to apply or dismiss (FIG. 3C), or to apply or dismiss all recommendations (FIG. 3A, 3B) (for a single table or all tables). FIG. 3E shows a control 310 that a user can use to regenerate recommendations. This option can be presented when tables have been edited or tables or data sources have been added or removed from the data model.

FIG. 4A-4D are diagrams showing examples of user interfaces that indicate actions for data modeling and data adjustment determined performed using interactions with a chatbot based on artificial intelligence or machine learning.

FIG. 4A shows a conversation in which a chatbot interface assists the user in data discovery. The user asks for tables with certain information to be added, “Find tables for store retail info, include product sale information, product category details, customer information, time information, and geography information.” The computer system 110 uses semantic searching, e.g., vector similarity searching, to find tables or other data sources accessible to the user that have data objects (e.g., attributes or metrics) that are relevant to the items the user specified. The tables that are found to have data objects corresponding to those user-specified terms (e.g., found tables 405) are integrated so they will be described in the data model and relationships will be determined with respect to other tables.

FIG. 4B shows a interface for creating or editing metrics. An interface region 420 shows the formula for a metric called “Profit.” Common functions 410 that the user can select are also shown. The interface includes a chatbot interface 422 including a text entry field 424 for providing instructions or requests to the data modeling assistant chatbot.

FIG. 4C shows a chatbot interface 430 where the chatbot assists the user with various actions, including creating a metric 432 and creating an attribute 434. The techniques of FIG. 1J (metric creation) can be invoked to perform these actions. The same techniques can also be used to create attributes on behalf of a user. Suggested queries 436 show other prompts the user can select, representing additional actions the chatbot can perform.

FIG. 4D shows the capability of the chatbot interface to generate code or instructions that implement a user's request. In the example, the user request to add a column for month to the table names “product sales.” The computer system 110 uses the AI/ML models to generate Python code that will create the column as requested.

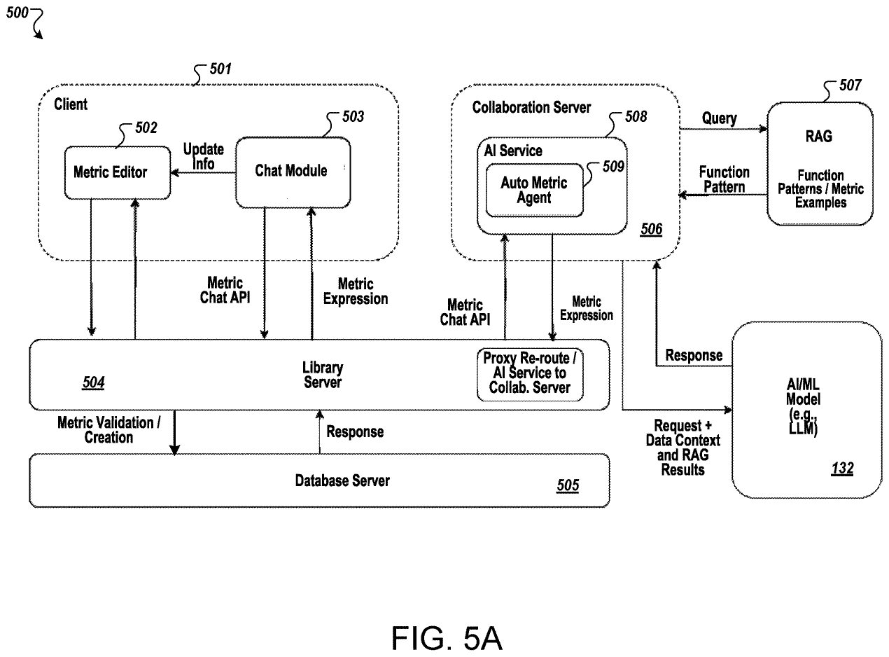

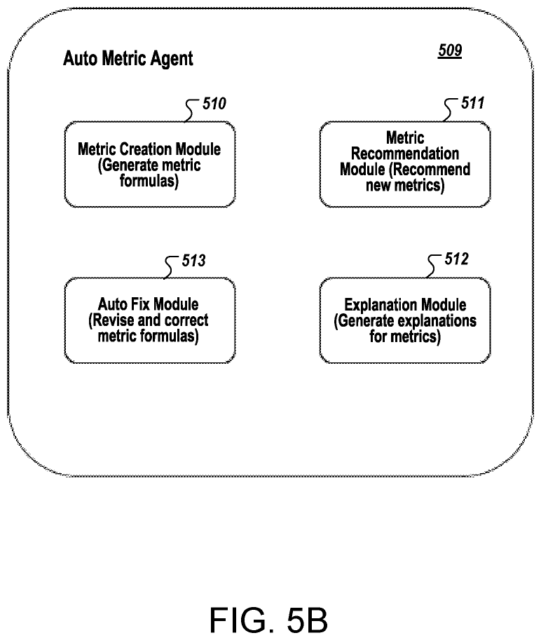

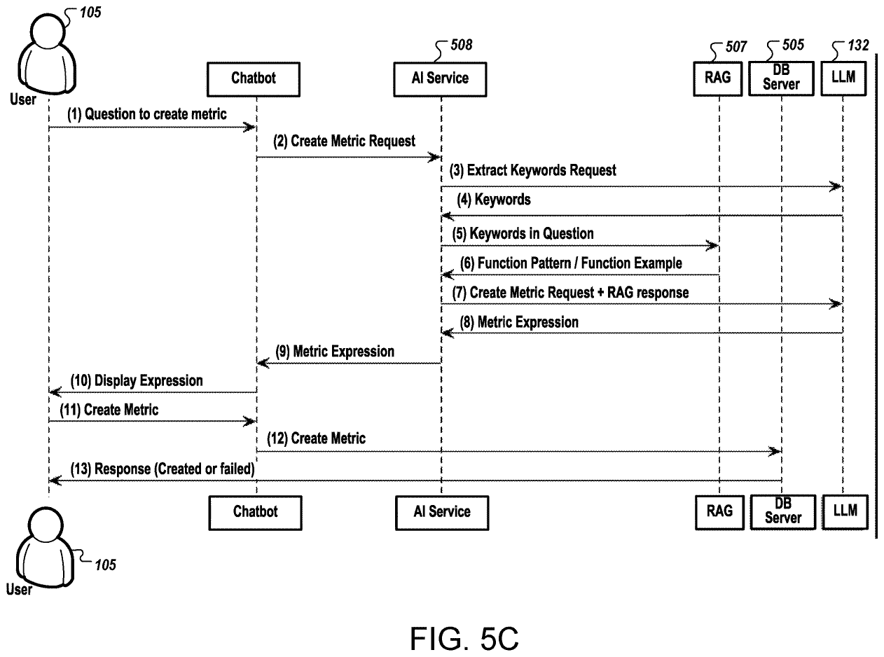

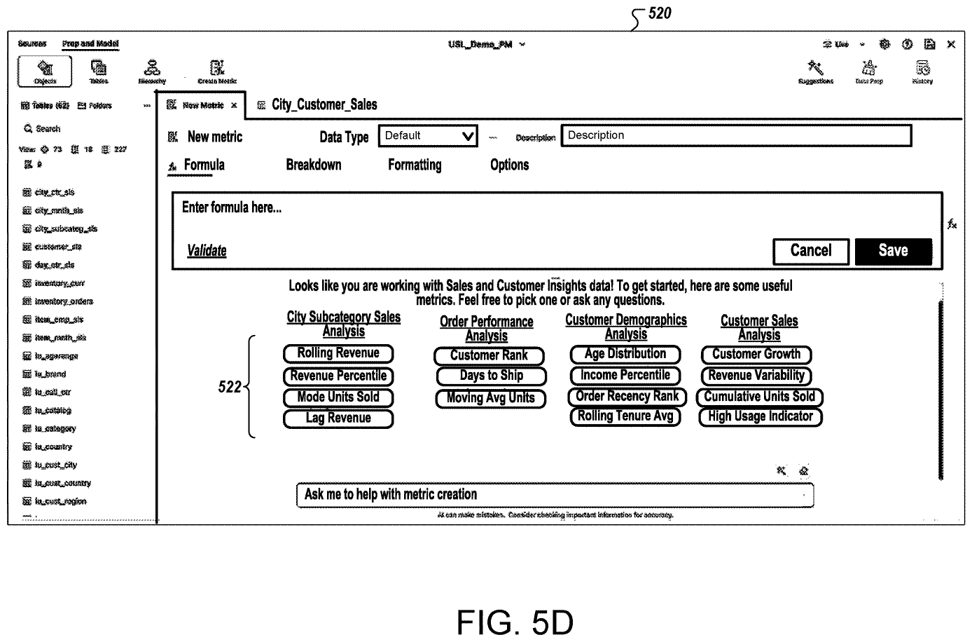

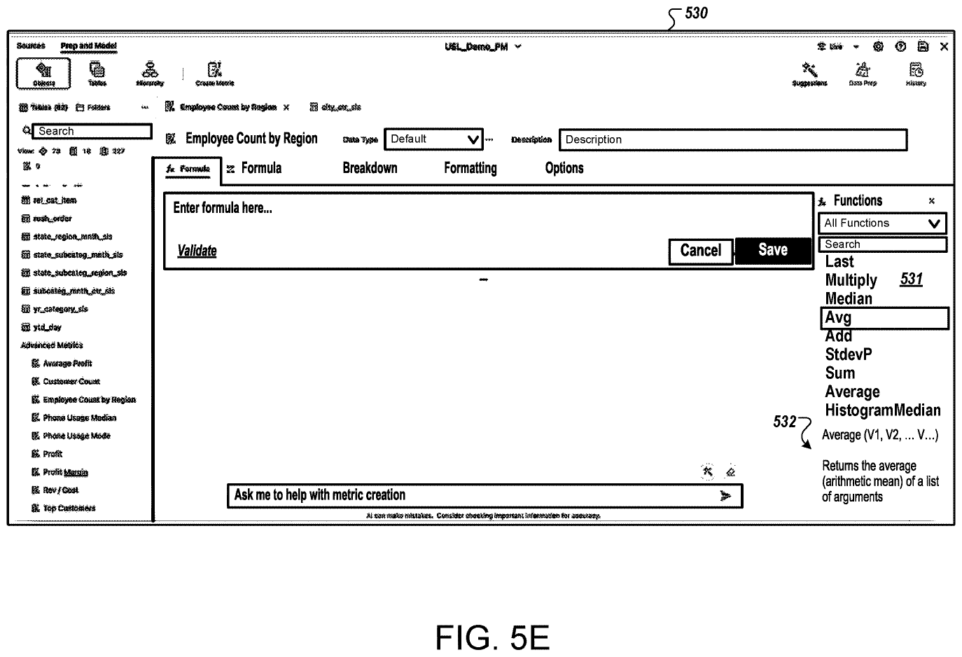

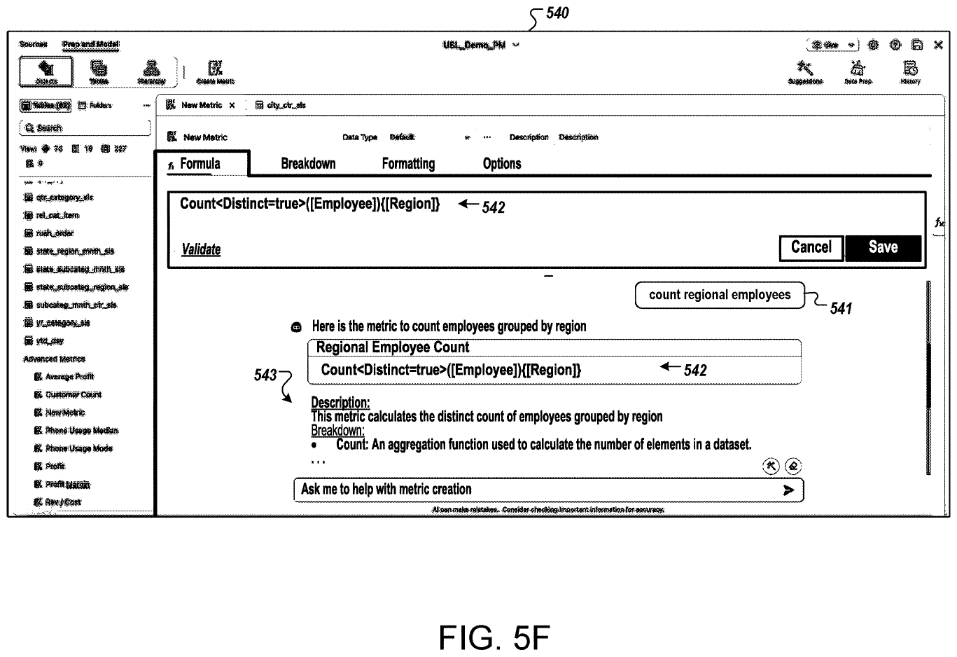

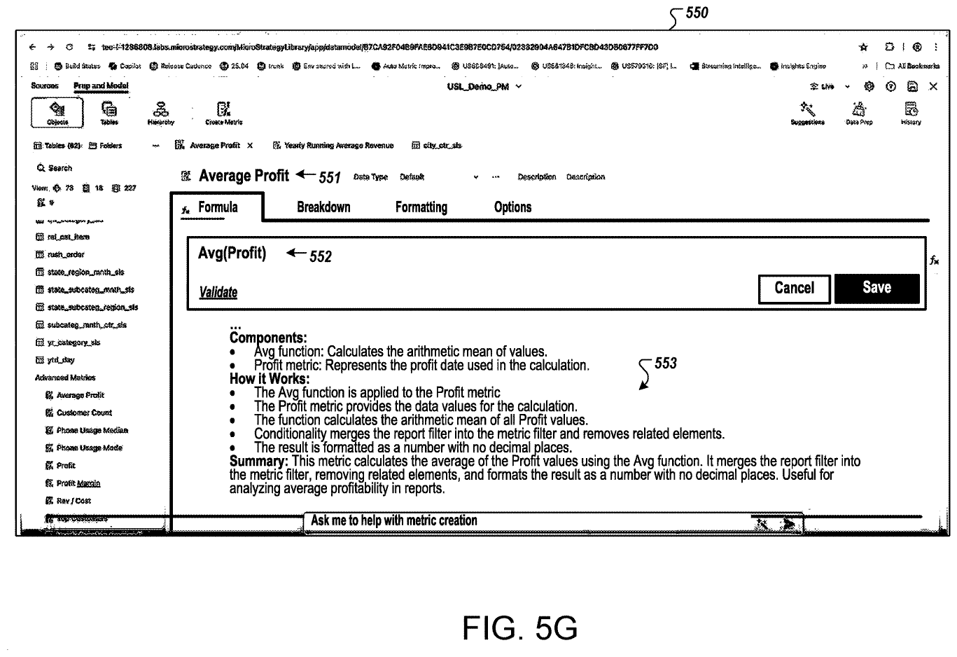

FIGS. 5A-5G are diagrams showing examples of techniques for creating metrics using AI/ML models, including by user interaction through a chatbot interface.

FIG. 5A is a block diagram that shows an example system 500 having interactions used to generate metrics for users (e.g., generate new metric definitions, for metrics to be added to a data model). The system 500 includes a client device 501 that presents a user interface with a chat module 503 (e.g., a chatbot interface for receiving user prompts and providing chatbot responses) and a metric editor 502 (e.g., a editing interface for a user to view and edit a metric formula). The client device 501 can be the client device 106 of FIG. 1A. The system 500 also includes a library server 504, a database server 505, and a collaboration server 506. Some or all of these functions can be performed by the computer system 110. For example, the library server 504 and the collaboration server 506 can be elements of the computer system 110, and the database server 505 can be an example of the data processing system 120. The system includes an AI/ML model 132, which can be provided by the AI/ML service provider 130. The system 500 also includes a RAG module 507, which provides a vector database with function patterns and/or metric examples. The RAG module 507 can be provided by the computer system 110 or another service provider (e.g., a cloud computing system, a remote data processing system, etc.).

In the example of FIG. 5A, a user provides a user prompt to the chat module 503. The prompt is then sent to the library server 504 over a metric chat API, using an API request for invoking creation of a metric using the AI/ML model 132. The library server 504 passes the user prompt to the collaboration server 506, where an AI service 508 including an auto metric agent 509 processes the prompt. The auto metric agent 509 can process the user prompt and begin a workflow for creating a new metric. This can include multiple steps and may include invoking multiple agents, each using an LLM or other AI/ML capability to perform a task.

In the process of creating a metric, the user prompt can be used as a query to the RAG module 507, to retrieve function patterns and/or metric examples. The vector database can store a function pattern or function template for each of the different functions that the database server 505 can apply (e.g., average, sum, maximum, minimum, etc.). The function patterns or function templates can each describe the syntax for using the function, the result of using the function, the data types used as input and output, and so on. The metric examples can be records that describe actual metrics from other data sets (including data sets of other users and other organizations), including their formulas, names, descriptions, and other data. By using semantic search (e.g., vector similarity search), the RAG module 507 can select the function pattern or function template that is most relevant or most similar semantically to the user prompt, which describes the type of metric that is desired. In some implementations, multiple function templates are selected, such as the top 3 that are closest to the user prompt in the vector space. In addition, retrieved metric examples show how other well-formed (e.g., syntactically correct) metrics that were useful to clients have been defined and described. The metric examples can provide useful guidance to the AI/ML model 132 in applying the selected function template, especially how they relate to common types of data objects (e.g., columns of data representing a date, a location, an address, etc.).

With the results from the RAG module 507, the auto metric agent 509 generates a request to the AI/ML model 132 to generate a metric formula for the new metric. The auto metric agent 509 can combine a number of items in the request to the AI/ML model 132, including (1) a system prompt or system instruction (to specify the task to be performed, such as to create a metric formula), (2) the user prompt (to specify the type of metric to be created), (3) data context, such as a data model or list of data objects and descriptions in the current data set(s) that are relevant (to specify the set of data objects that can be used as sources of data in the metric formula), and (4) results from the RAG module 507 (to indicate the most likely functions for operating on data and how to use them, potentially along with examples of prior metrics that were similar to the one being created). This information allows the AI/ML model 132 to generate a metric formula that uses the syntax of the database server 505 (e.g., the data processing system 120) and the known, valid names or identifiers of data objects in the current data model to create the metric formula.

The AI/ML model 132 provides its response with the generated formula to the auto metric agent 509, which can perform other actions. For example, the auto metric agent 509 can provide additional requests to the AI/ML model 132 to summarize or describe the metric defined by the created formula, or to generate a detailed breakdown describing the individual data objects and data processing operations that are applied in the formula. The auto metric agent 509 can also use the generated formula to attempt to calculate the metric using the database server 505. If the database server 505 can correctly interpret the syntax and resolve the references to data objects, then the generated metric can be considered validated and ready to provide to the user (e.g., in the metric editor 502) and/or to save to the current data model being created or edited.

If the database server 505 returns an error when attempting to use the generated formula, the auto metric agent 509 can take the error and the generated formula (along with the original user prompt, the data model, and the function pattern or function template) and send a request to the AI/ML model 132 to fix the error in the generated formula. This request can use a different predetermined system prompt or system instruction, that instructs the AI/ML model 132 to re-write or correct a formula in view of an error, rather than create a new formula. This can continue until the formula is able to run correctly or until a predetermined number of errors or formula fixing cycles is reached, after which the user is notified of the error.

FIG. 5B shows a diagram showing additional detail about the auto metric agent 509. The auto metric agent 509 can include multiple sub-agents, each of which represents processing of the AI/ML model 132 with a different system prompt or system instruction in order to perform a different task. In other words, each of the sub-agents 510-513 can send a different type of request to the AI/ML model 132 to obtain a different kind of output.

The metric creation module 510 is configured to generate metric formulas. The recommendation module 511 is configured to recommend new metrics to create. The recommendation module 511 is configured to request that the AI/ML model 132 generate suggested metrics to suggest to the user, e.g., metric names or metric titles for metrics that are not in the current data model but that are inferred to be relevant based on the data context. The explanation module 512 is configured to generate explanations for metrics, including a description of the metric as a whole and a breakdown of the components of a metric formula and their meaning individually. The auto fix module 513 is configured to revise and correct metric formulas when a error is detected. For example, the system can be configured to attempt to calculate values from a generate metric, and when an error occurs, to automatically invoke the auto fix module 513 to take the generated metric formula and request for the AI/ML model 132 to revise and correct the generated metric formula to avoid the error. The auto fix module 513 is configured to take or invalid partial metric formulas and complete them.

FIG. 5C shows a series of interactions that can be used to generate a metric. In step (1), the user 105 sends a question or user prompt to create a metric. This can be a natural language request that is detected to be requesting a metric (e.g., “create a metric for . . . ”) or can simply be a few words provided through an interface that is designated for metric creation (e.g., “average sales” in a text entry field on the metric creation user interface tab). In step (2) the chatbot forms a metric request that is sent to the AI service 508. This can include supplementing the user-supplied text with additional context and instruction, e.g., to specify that a metric should be created.

In step (3), the AI service 508 sends a request to the AI/ML model 132 to extract keywords from the metric request. This can help identify terms relevant to the data sets that are in the current data context. In step (4) the AI/ML model 132 returns the extracted keywords. In step (5), the AI service 508 sends the extracted keywords from the user prompt to the RAG module 507 to perform semantic search for similar items. In step (6) the RAG module 507 provides results of one or more function patterns or function templates to be used, as well as optionally one or more metric examples. For example, the metric examples can be examples of other metric formulas, and their descriptions, that relate to the same or similar types of information and the same or similar functions.

In step (7), the AI service 508 provides the metric creation request with the RAG results to the AI/ML model 132 to request a metric formula to be created. This request can include additional information, such as a data model or list of data objects available to be used in a metric formula. The request can include a system prompt or system instruction that defines the current task of the LLM to generate a metric formula. In step (8), the AI/ML model 132 provides the metric expression or metric formula that it generated. In step (9) the generated metric expression or metric formula is provided to the chatbot, which provides the metric expression to the user to view (step (10)).

In some implementations, the AI service 508 attempts to validate the metric formula before showing it to the user, or in response to a user action to save or create the new metric. If there are errors in the validation or creation of the metric based on the generated formula, the AI service 508 invokes the auto fix module 513 of the auto metric agent 509, which creates a request to the AI/ML model 132 to attempt to revise the metric formula. The resulting metric formula, if validated, can then be shown to the user.

If the user approves, the system attempts to create the metric and add it to the data model in step (11). In step (12), the chatbot requests for the new metric to be created, by interacting with the database server 505. The database server 505 then attempts to validate the metric formula by running it and/or performing other tests. In step (13), the database server 505 provides a response indicating whether the metric creation was successful or if the process failed.

FIG. 5D is an example of a user interface 520 for creating metrics. The user interface 520 includes suggested metrics 522 that the computer system 110 determined based on processing by an AI/ML model 132 with information about the current data context, e.g., a data model or list of the data objects (e.g., attributes, metrics, etc.) available and their names and descriptions. The suggested metrics 522 can be outputs that are generated by the metric recommendation module 511.

The computer system 110 can guide the AI/ML model 132 in generating the suggested metrics by, for example, selecting a set of the most relevant tables (e.g., current selected, most recently or frequently used, etc.), then instructing the AI/ML model 132 to create a set of metrics for each of the selected tables. In some implementations, the computer system 110 instructs the AI/ML model 132 to generate a predetermined number of metrics for each of a predetermined number of selected tables (e.g., suggest 4 metrics for each of 4 tables). The suggested metrics 522 that are generated can be provided as interactive user interface elements that, when interacted with by a user, trigger the metric creation workflow for the suggested metric. In some implementations, multiple steps are needed before metric creation is initiated, such as a user selecting a suggested metric 122 and then clicking another button to create the metric.

The computer system 110 can provide these metric suggestions in the form of proposed names for potential new metrics, e.g., descriptive names that with a phrase or a few words express in natural language the type of information to be provided (e.g., “sales by quarter,” “cost per employee,” “units sold,” etc.). The computer system 110 uses an AI/ML model and the current data context to generate the suggested metrics 122. The computer system 110 can guide the AI/ML model to propose metrics that are relevant to the current data context and for which the source data to generate the metric would be available. For example, the computer system 110 can send a request to the LLM to generate a list of names of proposed metrics that would be relevant for a group of data sets and would each be able to be derived from the values in the data sets. The request can be provided with a data model for the data sets (including potentially content of the current data model being created or edited) and/or with information describing the structure or metadata of the data sets (e.g., table names and descriptions, column names and descriptions, data types for columns, etc.). In response, the LLM can provide a list of proposed metrics that are inferred to be most related to or most likely for the data set(s) currently open or being operated on by the user.

The processing of the LLM to generate proposed metrics to suggest to the user can be enhanced using RAG. For example, the computer system 110 can use information about the current data context (e.g., the data model, or table and column names and descriptions) to generate a variety of query vector embeddings. The computer system 110 can then perform a semantic search using the vector database to retrieve metric examples that are relevant to the various attributes, metrics, columns, tables, and other items of the current data context. This search can produce results of various different types, which the computer system 110 can provide to the LLM with the request to generate new proposed metric names. For example, with the data model or other data object information together with the metric examples, the LLM can identify which of the metric examples involve types of data present in the current data sets and so would be good candidates to create. Similarly, the LLM can use patterns from the examples to fit the examples to the data that is present. For example, there may be a retrieved example of “average revenue,” where the current data set has no revenue metric but does have a sales metric, and so the LLM can suggest “average sales” as an appropriate metric for the current data set.

In some implementations, to enhance the retrieval and process of generating suggestions, the vector database can store metric examples with information that describes the data contexts of the metric examples. For example, a metric “average revenue” can be stored with information about the table (e.g., named “store performance”) or other associated tables, and other columns present (e.g., “year,” “country,” “customer,” “product,” etc.). As a result, the search process can generate vector embeddings of the current data context and compare to vector embeddings based at least in part on the respective data contexts where the metric examples occurred. As a result, the semantic search retrieval process can leverage the similarities of the current data context to the other data contexts to find metric examples from similar data contexts. If some metrics are more likely to occur with customer data, or with store location data, or with another type of data, this type of search that accounts for the similarities of the data context can help ensure that retrieved examples are relevant.

In some implementations, the computer system 110 generates different sets of suggested metrics for each of multiple different tasks or portions of the data set(s) in the data context. This can provide different sets of metrics for different topics or purposes. For example, the computer system 110 may use the LLM to generate a first set of suggested metrics for a first table of data, a second set of suggested metrics for a second table of data, and so on. As another example, the computer system 110 may use the LLM to generate different sets of suggested metrics for different topics or types of analysis. Given a data set with sales data and information about many different attributes and metrics, the LLM may provide a different set of suggested metrics for different topics such as customer sales trends, customer demographics, order performance, location trends, inventory trends, marketing performance, etc. In some implementations, the computer system 110 may instruct the LLM to (1) generate the topics (e.g., types or categories of analysis), by inferring which topics are most likely or most relevant from the data model or other information about the data set(s), then (2) generate a set of suggested metrics for each topic generated. In other implementations, the computer system 110 may provide the topics or retrieve a set of topics (e.g., from a vector database, based on similarity of data context) and instruct the LLM to generate a set of suggested metrics for each topic provided.

In some implementations, the computer system 110 uses the AI/ML models to generate the suggested metrics without the user having to specifically request them. For example, if a user clicks a user interface option to be shown a metric creation page or area, the computer system 110 can automatically generate and provide as set of suggested metrics for presentation. Each of the selected metrics can be provided as an interactive user interface element that, if a user interacts with it (e.g., clicking, tapping, etc.) triggers the system to use an AI/ML model to generate the corresponding metric formula, along with a description, explanation, and other content. To use processing power efficiently, the suggested metrics can be generated as simply metric names or short descriptions, without incurring the processing needed to generate the full metric definition (e.g., search for the proper functions, generation of the metric formula, etc.), until the user clicks the user interface element and initiates a request for that particular metric to be generated. In addition, the computer system 110 can be configured with a stored system prompt or system instruction that is configured to be used for the metric creation interface, so that the user does not need to provide a detailed prompt to request a metric. For example, the system prompt can include the instruction to generate a metric formula, with a corresponding explanation and description, based on the user prompt, which may be no more than the text of a suggested metric name or title, such as “total profit” or “average cost.” The system prompt, together with the user prompt (e.g., the selected metric name the user selects), are then provided to the LLM with (1) the data model for the data set(s) of the current data context and (2) function templates and/or metric examples retrieved from the vector database based on the user prompt. The LLM then generates the metric formula and the corresponding descriptive and explanatory content.

The computer system 110 can use the AI/ML models to detect various different scenarios. For example, the computer system 110 can instruct an LLM to determine likely types of analysis needed given the data model or other data set information. If the metrics that are present are items describing products, customers, and revenue, the LLM can detect that types of analysis such as overall performance analytics or customer demographics are relevant to the current data context. The computer system 110 instructs the LLM to suggest metrics for each of these types of analysis, and the request can be made as a separate interaction or the same interaction requesting the analysis types. Often the types of metrics needed are common or standard in an industry. The LLM may have information about these from its training, e.g., with the information incorporated into the training state of the LLM. In some implementations, reference material indicating the most common metrics for different scenarios or types of analysis can be provided to the LLM for reference. At each step of processing, the LLM has access to the data model or data set characteristics which allows the set of suggested metrics to be customized for the user's industry, location, or other parameters. This customization can often be performed automatically based on the content of the data set(s) in the data context, e.g., by the sets of attributes and metrics present.

When the LLM generates suggested queries, the LLM already has the data context (e.g., data model or other data set description). The instructions or system prompt can also instruct the LLM to limit the suggestions to those that use the particular data objects that are known to be available. Consequently, the suggestions are for metrics that can be actually created with actual data available in the relevant data sets. The instructions can similarly request for the functions applied to the data to be selected from a set of functions that are defined and known to be available in the target data processing system.

FIG. 5E shows another example user interface 530 for metric creation, including a list 531 of functions for creating a metric, along with a description 532 of a function selected by a user.

FIG. 5F shows a user interface 540 showing an example of a user prompt 541, “count regional employees,” that was submitted by a user, as well as the resulting metric formula 542 that was created and an description 543 of the metric and the components of the metric formula 542.

FIG. 5G shows a user interface 550 showing an example of the metric editor interface, showing information about an “average profit” metric 551, with a formula 552 of “Avg(Profit)” and a description 553 of the metric and the components.

In some implementations, the computer system 110 performs various steps to ensure that the AI/ML model 132 has good information to create a metric formula. As discussed above, the RAG module 507 can retrieve a function pattern or function template for the likely function(s) to be used in a metric. These function patterns can be provided for each of many types of operations (e.g., rank, sum, count, add, subtract, etc.). Each function pattern can specify the number of arguments or parameters that the function receives, and the type of data operated on (e.g., integer, percentage, etc.).

In addition, the function patterns can specify other semantic information about the types of data or data objects that can be used for the various parameters. For example, a function pattern may specify that an argument should take a parameter that represents a geographic location, but should receive a data object representing a specific type of region (e.g., state, country, etc.) but not a more fine-grained level (e.g., city, zip code). In this way, the function patterns can guide the creation of metrics beyond the mathematical operations that are applied. In some implementations, function patterns can be defined with conditionality. For example, a function pattern can be specified for use in generating revenue but only for Internet sales or for another context. In this case, there may be multiple different function patterns for defining a revenue metric in different ways in different contexts.

The function patterns can represent complex combinations of multiple criteria, including filtering and/or aggregation. As an example, a function pattern can specify multiple elements or conditions, such as to use the last value of month or year, but also to aggregate across another dimension such as geography.

In general, in the metric expression editor and in the metric formulas, there can be defined syntax for different criteria. For example, defining the level in an attribute hierarchy can be used with curly braces, and defining a criterion for filtering can be done with angled braces.

The automatic fixing of metric formulas can include features integrated with the user interface. For example, a user may begin to create a formula, but the user may use poor syntax, or mention an unknown data object. The computer system 110 can use the AI/ML model 132 to make a request in the background to identify, from among the available data objects, which would be a likely replacement that would be valid and also have the same or similar semantic meaning. The computer system 110 can cause a suggested completion or change to be shown automatically. In some implementations, a drop-down list is shown with multiple potential items. The suggestions can be automatically shifted and updated as the user types. This can be a type of autocomplete or autocorrection as the user types.

The computer system 110 can also configure the auto metric agent 509 to automatically add formatting information for metrics, and the metric format and data type can be automatically added to the metric definition or the data model. As an example, if the user asks for “profit margin,” as part of determining the formula and overall metric definition, the computer system 110 can indicate that the format of percentage should be used for the values of the metric. The computer system 110 can use the AI/ML model 132 to determine this, for example, by asking a specific question to specify the data format based on a metric formula (with the context of the data model), or by making the data format one of the requested outputs for the AI/ML model 132 to provide when generating the metric formula.

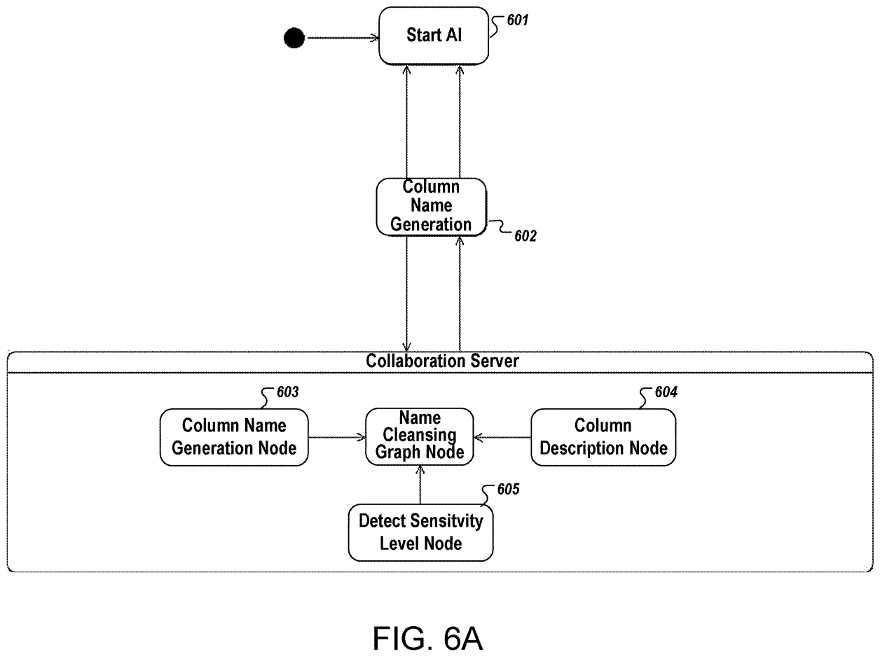

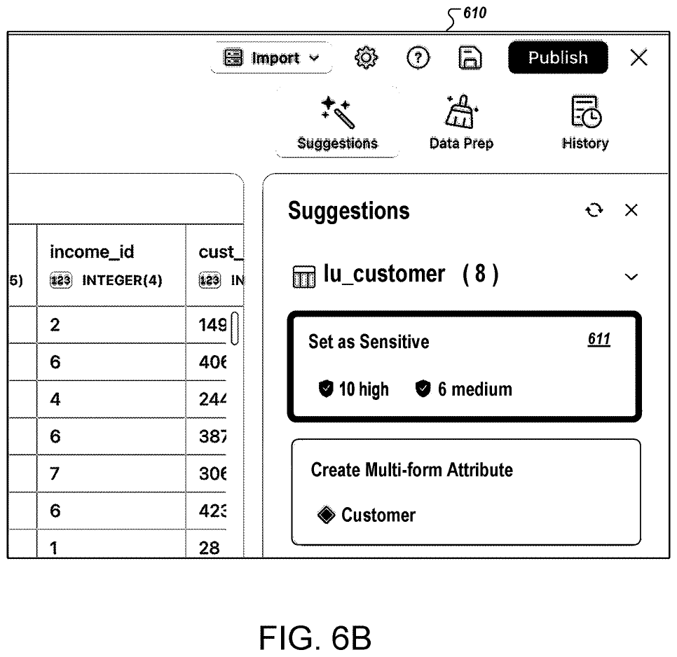

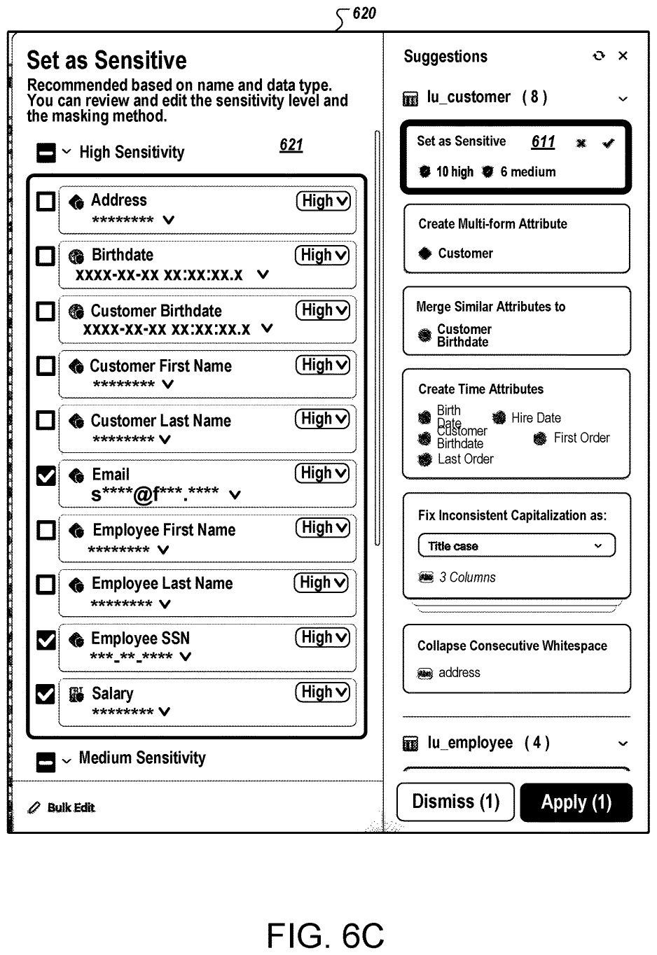

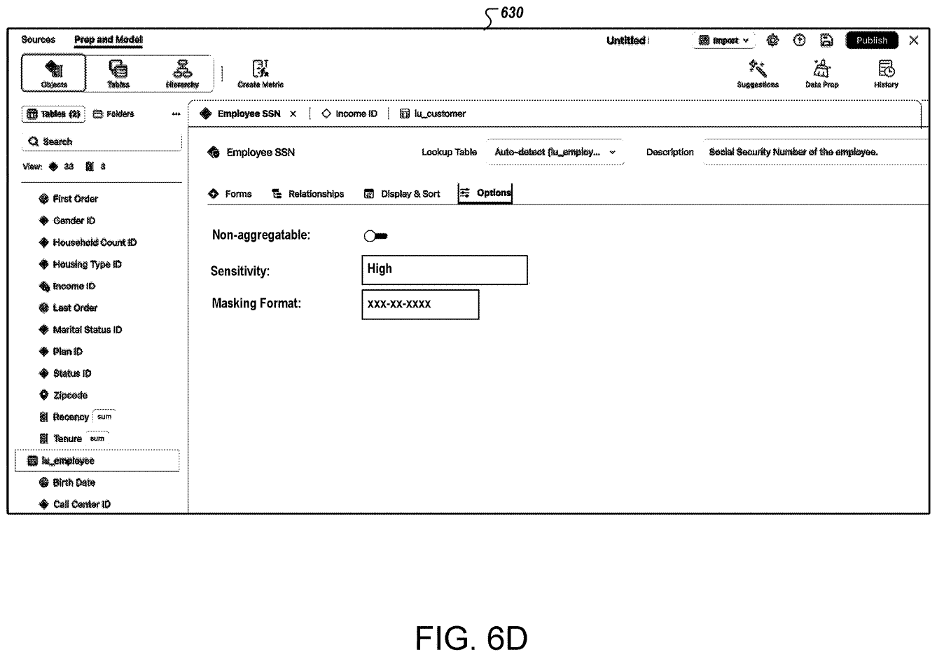

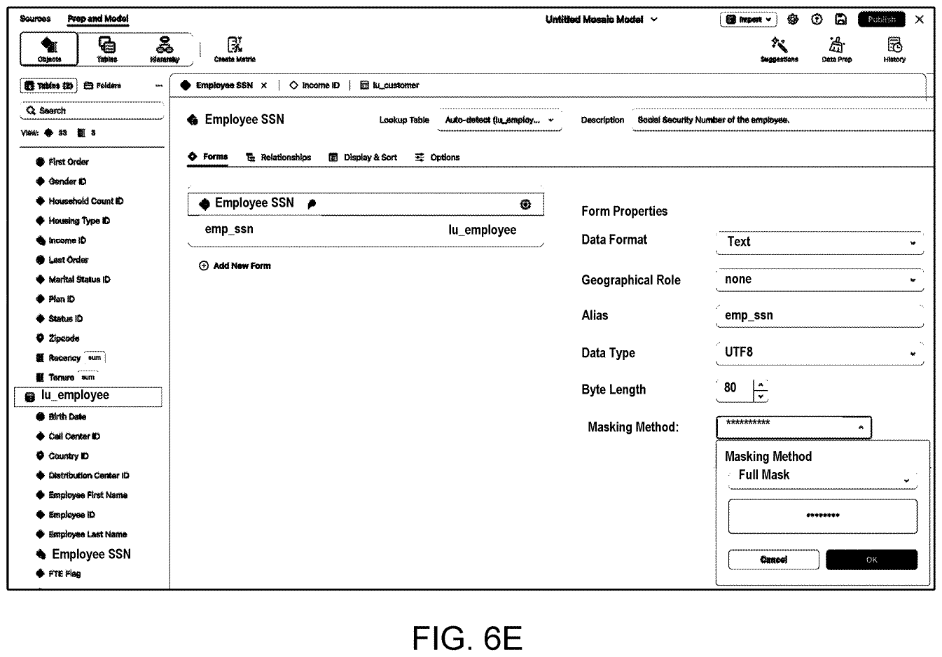

FIGS. 6A-6E are diagrams showing examples of techniques for detecting and protecting sensitive information.

In some implementations, the computer system 110 can be configured to incorporate information about the privacy or sensitivity of different data objects into a data model. The data object can be, for example, a column of data, an attribute, a metric calculated using a column or attribute, etc. Based on analysis of information about a data object, such as the name and description, the computer system 110 can use an AI/ML model to classify an object as one of multiple categories of sensitivity, e.g., high, medium, or low. Once the sensitivity level is detected, the computer system 110 can save the sensitivity setting for that data object in a data model, or provide a recommendation for the user to assign the sensitivity status. The computer system 110 can also apply a masking format to apply for the data object, such as to replace particular characters with a replacement character (e.g., replace all but the last four digits with asterisks, to replace all characters with the number sign, etc.). Then, when the data object is accessed in the future by a software application or by a chatbot system, the data processing system can use the information in the data model to detect that a sensitive value is involved, and the data processing system provides the masked version of the data to avoid providing the sensitive data. In at least some cases, including for chatbot processing, this can be applied even when the user has the appropriate permissions or access control level to be able to view the data, to avoid sensitive data being improperly shared or viewed.

For example, when data is imported or a data model is created, the computer system 110 can be configured to detect the level of sensitivity of each data object (e.g., each column of data or other data object). The computer system 110 can use a variety of semantic information for a data object, such as, the name, description, data type, data format, and other available information, to make a classification. In some implementation, the computer system 110 takes this information and provides it to an AI/ML model, such as an LLM, and instructs the LLM to classify the data object as one of multiple sensitivity classes. In some implementations, there are three or more classes, e.g., high, medium, and low sensitivity. As another example, the computer system 110 can use the information about a data object to look up information in a vector database that stores examples of data objects with known sensitivity levels. The computer system 110 can look up examples that are relevant or similar to a given data object (e.g., are close in the vector space), and then determine the sensitivity classification applied to the retrieved examples. In some implementations, the computer system 110 provides the retrieved examples from the vector database to the AI/ML model to aid in the AI/ML model assigning the sensitivity classification. In some implementations, the computer system 110 uses other processing such as examining the formatting of the data, the type of data (e.g., whether the data meets the format for a phone number (e.g., 10 digits, in groups of 3, 3, and 4), a social security number (e.g., 9 digits with dashes between, in groups of 3, 2, and 4), or other known data formats. In some implementations, the computer system 110 provides the data format information to the AI/ML model to assist it in determining the sensitivity classification.

Once a sensitivity classification is determined, for example, when a data object is detected to contain sensitive data, the computer system 110 applies a setting (e.g., a flag or other value) that marks the data object as sensitive. The setting can indicate one of the various different sensitivity levels (e.g., high, medium, or low sensitivity). The sensitivity setting in the data model can apply at the level of the data model and associated data sets, for all users and groups. This can be different from other techniques, such as user permissions and access control lists, that apply to specific users or user groups. The sensitivity setting in the data model, by contrast is not user dependent and can apply to all users, and so flows through to all chatbots or applications that uses the data model.

The presence of a sensitivity setting in a data model affects how the database backend processes requests and returns results. For example, when a request or query is sent, and the database backend determines that the data object is marked as sensitive in the data model, the database provides a masked pattern instead of the actual value. The particular masked pattern to use for each data object marked sensitive can also be specified in the data model. For example, if a request to a database from a chatbot system asked for a set of credit card numbers, the database system would detect that the data model marks the credit card number data object as a high-sensitivity data object. This triggers the database system to apply the masking pattern defined in the data model for this data object, which can be to replace all digits except the last four digits with an asterisk. In response to the query, the database system returns only the masked credit card numbers, which keeps the chatbot system and ultimately any chatbot responses from having the full values of the sensitive data object. Due to the flag in the data model, sensitive values are not provided to the AI/ML model, they are not shared outside of the database system in this case. Even if the user interacting with the chatbot has permissions to access the full credit card data, and access is not blocked by permissions or access control lists, the sensitivity setting nevertheless blocks the use of the values of the data object marked sensitive, at least by default.

For example, the computer system can use various techniques, including analysis by AI/ML models 132 and/or application of rules or policies, to automatically detect which portions of a data set (e.g., which columns of data, which metrics and attributes, etc.) represent sensitive data that should be protected. This can add privacy information as metadata for various data objects. The enforcement of restriction to access of sensitive data can be made upstream of any AI/ML processes, so that the data processing system 120 disallows passing sensitive values to the LLM. The data can still be used for analytics, such as by processing SQL statements and generating results in the data processing system 120. Just the same, the settings in the data model specify how masking is performed and control how data is exported. Enforcing the setting is also helpful with auditing so it is clear which users accessed which data and in what form.

By including sensitivity status and masking information in the data model, the control on the use and export of data can be performed at a high level that flows through to all other systems that use the data model. Often a data model is created first, before any user access control lists are determined or chatbots are configured. The settings in the data model will carry to each of these later. The data model can include a sensitivity setting and a mask format. By default, the masking is applied even for users that have permission or authorization to access the data. Different data objects can have different masking formats applied. For example, the data model can define the mask format for one data type to have all characters masked, for first name an administrator may choose to apply no masking but to mask a last name completely, and for a credit card to mask all but the last four digits.

The computer system 110 can use an LLM to detect the semantic meaning of a data object. In some implementations, there are at least two types of sensitivity, such as high sensitivity where one piece of information reveals a person's identity, and medium sensitivity, where two or more pieces of information together could indicate identity.

When recommending to make a data object sensitive, the computer system 110 can provide a drop-down menu that allows a user to select from among multiple different masking formats. These formats can be predefined for different data types (e.g., street address, phone number, etc.). There can also be default types set or defaults across data types. The masking formats can be for full or partial masking. In some cases, the computer system 110 can track the selections that users make for different types of data or in association with particular keywords, to determine the statistical likelihood of different masking formats for different data objects or data types. Then, the computer system 110 can use the statistics to recommend a masking format based on what other users have chosen for similar data or similar situations.

In the case that a user asks for sensitive data, such as in a chatbot question, by default the system will send masked values and not the actual values. The process of answering the user's question can include first translating the user's question to a SQL query using the AI/ML model, which then can be used to create an execution plan for execution at the data processing system 120. This results in concepts being mapped to specific data objects to be retrieved and provided.

If the question is found to map an element that the data model flags as a sensitive data object, e.g., a SSN attribute, the data processing system 120 detects this. The data processing system 120 runs the query and obtains the result data. Then, before providing to the result data to the chatbot system, the data processing system applies the masking format defined in the data model to replace the value with a masked value, e.g., placeholder characters. For example, the social security number is not provided and replacement values of XXXX or ****** or similar replacement are provided. As a result, the chatbot system, the AI/ML model 132 that generates the chatbot response, and the user that receives the chatbot response all are blocked from obtaining the values of the data object marked sensitive.

FIG. 6A shows an example block diagram showing processing for detecting sensitivity. The example shows that the detection of sensitivity can be performed in association with, or as a part of, a name cleansing or name generation process (e.g., column name and description generation 165 of FIG. 1B). For example, after a user starts an AI modeling process (601), such as selecting or uploading a data source, the name cleansing or name generation process can be performed (602). The computer system 110 with a collaboration server or other server, can perform processing such as (1) generating a column name with an AI/ML model 132 (603), (2) generating a column description with an AI/ML model 132 (604), and (3) detecting the sensitivity level for the column using an AI/ML model (605). Each of these processes 603-605 can process the column name (and column description if available) from a data set, but with a different system instruction or system prompt in order to perform a different task. The sensitivity detection (605) can also involve the AI/ML model 132 processing additional information such as information about the data type, data format, etc. of the values of the column. As discussed above, the processes for column name and description generation 165 can generate data role information for a column. These data roles can be provided as input to the AI/ML model 132 for detecting the sensitivity level, since they can indicate the semantic meaning of the column (e.g., as a name, an address, a phone number, etc.). The data role for the column can also be used to select the mask type to apply for masking sensitive data. The results of these process can be combined in the name cleansing graph node.

In some implementations, high-sensitivity data is data that, if breached or misused, could cause severe harm to individuals, organizations, or compliance standing. Examples of high-sensitivity data include personally identifiable information (PII), financial data, protected health information (PHI), authentication credentials, legal/confidential contracts, and biometric data.

In some implementations, medium-sensitivity data is data that could cause moderate harm if exposed but lacks direct identifiers or high-risk financial impact. Examples of medium-sensitivity data include indirect PII, business operations, employee data, aggregated data, proprietary data: internal research, and product roadmaps (non-public).

In some implementations, low-sensitivity data includes public or non-critical data with minimal risk if exposed. Examples of low-sensitivity data include public data, anonymized data, non-sensitive operational data, and environmental data.

FIG. 6B shows a user interface 610 showing an example of a recommendation 611 for a various data objects of a particular table, “lu_customer,” to be marked as sensitive. Based on processing of the computer system 110 using the AI/ML models 132, the computer system 110 has identified 10 data objects (e.g., 10 columns) as high sensitivity and has also identified 6 data objects as medium sensitivity. The recommendation can be provided with other suggestions, which a user can approve, dismiss, or edit.

FIG. 6C shows an example of a user interface 620 that shows the recommendation 611 in further detail. The user interface 620 includes a pane 621 that lists each data object identified as high sensitivity, and for each one, provides the name, sensitivity status (e.g., high), and shows a masking format appropriate for the data object. The interface provides a checkbox control for each data object that the user can use to select or deselect the data object to be marked as high sensitivity and to be masked. The entry for each data object also allows the user to select a different masking format or edit the masking format.

FIG. 6D shows another example user interface 630 where an administrator can view and change the sensitivity status of data objects. The user interface shows information about a particular data object, Employee SSN, that is marked with high sensitivity. The administrator can use the interface to change this status and/or to change the masking format to be used.

FIG. 6E shows another example user interface 640 that includes controls for an administrator to view and change properties about a data object in the data model, including to change sensitivity status, and the masking format used.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
during a session of user interaction with a graphical user interface, accessing, by the one or more computers, a data model for one or more data sets or data sources used in a session of user interaction with a graphical user interface, wherein the data model (i) indicates data objects that are defined for the one or more data sets or data models and (ii) includes names or descriptions for the respective data objects that are defined for the one or more data sets or data sources;
generating, by the one or more computers, a request for one or more artificial intelligence and/or machine learning (AI/ML) models to identify one or more additional data objects that are not specified in the data model and that measure data of the one or more data sets or data sources, wherein the request is configured to cause the output to be generated based on content of the data model;
obtaining, by the one or more computers, output that the one or more AI/ML models generated in response to the request, wherein the output indicates one or more additional data objects that are not specified in the data model and are derivable from the data objects that are specified in the data model; and
based on the output generated by the one or more AI/ML models, providing, by the one or more computers and during the session, user interface data for presentation in the graphical user interface, wherein the user interface data is configured to cause display of (i) data identifying a particular additional data object indicated by the output of the one or more AI/ML models and (ii) a control corresponding to the particular additional data object that is selectable by the user to initiate creation of the particular additional data object.

2. The method of claim 1, comprising:
after providing the user interface data, receiving, by the one or more computers, user input data indicating user interaction with the interactive control corresponding to the particular additional data object; and
in response to receiving the user input data:
creating, by the one or more computers, a definition for the particular additional data object that applies a function to one or more data objects specified in the data model; and
updating, by the one or more computers, the data model to include the particular additional data object, wherein the particular additional data object is created to include the application of one or more functions to one or more of the data objects in the data model.

3. The method of claim 2, wherein creating the definition for the particular additional data object comprises:
accessing data indicating a set of data manipulation functions that are recognized by a database system;
selecting one or more of the functions;
selecting one or more data objects specified in the data model; and
generating the definition to specify application of the selected one or more functions to the selected one or more data objects.

4. The method of claim 3, wherein accessing the data indicating the set of data manipulation functions comprises accessing a vector database storing function templates for the respective data manipulation functions in association with corresponding vector embeddings; and
wherein selecting one or more of the functions comprises selecting one or more of the function templates based on similarity or distance between a query vector embedding for the particular additional data object and the vector embeddings for the function templates.

5. The method of claim 3, comprising using the one or more AI/ML models to select the one or more data objects based on (i) the output of the one or more AI/ML models that indicates the particular additional data object and (ii) the content of the data model.

6. The method of claim 1, wherein the output of the one or more AI/ML models comprises a natural language name or a natural language description for the particular additional data object that is not specified in the data model.

7. The method of claim 1, comprising:
identifying a type or category of data analysis performed using the types of data objects specified in the data model; and
identifying multiple additional data objects corresponding to the identified type or category of data analysis that are not specified in the data model;
wherein the generated user interface data is configured to cause display of (i) an indication of the identified type or category of data analysis and (ii) an interactive control for each of the multiple additional data objects, each of the interactive controls being configured to initiate creation of the corresponding additional data object in response to user interaction.

8. A system comprising:
one or more computers; and
one or more computer-readable media storing instructions that are operable, when executed by the one or more computers, to cause the one or more computers to perform operations comprising:
during a session of user interaction with a graphical user interface, accessing, by the one or more computers, a data model for one or more data sets or data sources used in a session of user interaction with a graphical user interface, wherein the data model (i) indicates data objects that are defined for the one or more data sets or data models and (ii) includes names or descriptions for the respective data objects that are defined for the one or more data sets or data sources;
generating, by the one or more computers, a request for one or more artificial intelligence and/or machine learning (AI/ML) models to identify one or more additional data objects that are not specified in the data model and that measure data of the one or more data sets or data sources, wherein the request is configured to cause the output to be generated based on content of the data model;
obtaining, by the one or more computers, output that the one or more AI/ML models generated in response to the request, wherein the output indicates one or more additional data objects that are not specified in the data model and are derivable from the data objects that are specified in the data model; and
based on the output generated by the one or more AI/ML models, providing, by the one or more computers and during the session, user interface data for presentation in the graphical user interface, wherein the user interface data is configured to cause display of (i) data identifying a particular additional data object indicated by the output of the one or more AI/ML models and (ii) a control corresponding to the particular additional data object that is selectable by the user to initiate creation of the particular additional data object.

9. The system of claim 8, wherein the operations comprise:
after providing the user interface data, receiving, by the one or more computers, user input data indicating user interaction with the interactive control corresponding to the particular additional data object; and
in response to receiving the user input data:
creating, by the one or more computers, a definition for the particular additional data object that applies a function to one or more data objects specified in the data model; and
updating, by the one or more computers, the data model to include the particular additional data object, wherein the particular additional data object is created to include the application of one or more functions to one or more of the data objects in the data model.

10. The system of claim 9, wherein creating the definition for the particular additional data object comprises:
accessing data indicating a set of data manipulation functions that are recognized by a database system;
selecting one or more of the functions;
selecting one or more data objects specified in the data model; and
generating the definition to specify application of the selected one or more functions to the selected one or more data objects.

11. The system of claim 10, wherein accessing the data indicating the set of data manipulation functions comprises accessing a vector database storing function templates for the respective data manipulation functions in association with corresponding vector embeddings; and
wherein selecting one or more of the functions comprises selecting one or more of the function templates based on similarity or distance between a query vector embedding for the particular additional data object and the vector embeddings for the function templates.

12. The system of claim 11, wherein the operations comprise using the one or more AI/ML models to select the one or more data objects based on (i) the output of the one or more AI/ML models that indicates the particular additional data object and (ii) the content of the data model.

13. The system of claim 8, wherein the output of the one or more AI/ML models comprises a natural language name or a natural language description for the particular additional data object that is not specified in the data model.

14. The system of claim 8, wherein the operations comprise:
identifying a type or category of data analysis performed using the types of data objects specified in the data model; and
identifying multiple additional data objects corresponding to the identified type or category of data analysis that are not specified in the data model;
wherein the generated user interface data is configured to cause display of (i) an indication of the identified type or category of data analysis and (ii) an interactive control for each of the multiple additional data objects, each of the interactive controls being configured to initiate creation of the corresponding additional data object in response to user interaction.

15. One or more non-transitory computer-readable media storing instructions that are operable, when executed by one or more computers, to cause the one or more computers to perform operations comprising:
during a session of user interaction with a graphical user interface, accessing, by the one or more computers, a data model for one or more data sets or data sources used in a session of user interaction with a graphical user interface, wherein the data model (i) indicates data objects that are defined for the one or more data sets or data models and (ii) includes names or descriptions for the respective data objects that are defined for the one or more data sets or data sources;
generating, by the one or more computers, a request for one or more artificial intelligence and/or machine learning (AI/ML) models to identify one or more additional data objects that are not specified in the data model and that measure data of the one or more data sets or data sources, wherein the request is configured to cause the output to be generated based on content of the data model;
obtaining, by the one or more computers, output that the one or more AI/ML models generated in response to the request, wherein the output indicates one or more additional data objects that are not specified in the data model and are derivable from the data objects that are specified in the data model; and
based on the output generated by the one or more AI/ML models, providing, by the one or more computers and during the session, user interface data for presentation in the graphical user interface, wherein the user interface data is configured to cause display of (i) data identifying a particular additional data object indicated by the output of the one or more AI/ML models and (ii) a control corresponding to the particular additional data object that is selectable by the user to initiate creation of the particular additional data object.

16. The one or more non-transitory computer-readable media of claim 15, wherein the operations comprise:
after providing the user interface data, receiving, by the one or more computers, user input data indicating user interaction with the interactive control corresponding to the particular additional data object; and
in response to receiving the user input data:
creating, by the one or more computers, a definition for the particular additional data object that applies a function to one or more data objects specified in the data model; and
updating, by the one or more computers, the data model to include the particular additional data object, wherein the particular additional data object is created to include the application of one or more functions to one or more of the data objects in the data model.

17. The one or more non-transitory computer-readable media of claim 16, wherein creating the definition for the particular additional data object comprises:
accessing data indicating a set of data manipulation functions that are recognized by a database system;
selecting one or more of the functions;
selecting one or more data objects specified in the data model; and
generating the definition to specify application of the selected one or more functions to the selected one or more data objects.

18. The one or more non-transitory computer-readable media of claim 17, wherein accessing the data indicating the set of data manipulation functions comprises accessing a vector database storing function templates for the respective data manipulation functions in association with corresponding vector embeddings; and
wherein selecting one or more of the functions comprises selecting one or more of the function templates based on similarity or distance between a query vector embedding for the particular additional data object and the vector embeddings for the function templates.

19. The one or more non-transitory computer-readable media of claim 18 wherein the operations comprise using the one or more AI/ML models to select the one or more data objects based on (i) the output of the one or more AI/ML models that indicates the particular additional data object and (ii) the content of the data model.

20. The one or more non-transitory computer-readable media of claim 15, wherein the output of the one or more AI/ML models comprises a natural language name or a natural language description for the particular additional data object that is not specified in the data model.
